(19) United States
(12) Patent Application Publication
(10) Pub. No.: US 2022/0275524 A1
(43) Pub. Date: Sep. 1, 2022

(54) ELECTROCHEMICAL PRDUCTION OF POLYMERS

(71) Applicants: Hui Huang Hoe, Toronto (CA); Hui Ming Hoe, Pontian, Johor (MY)

(72) Inventors: Hui Huang Hoe, Toronto (CA); Hui Ming Hoe, Pontian, Johor (MY)

(21) Appl. No.: 17/431,948

(22) PCT Filed: Mar. 8, 2020
(86) PCT No.: PCT/MY2020/050012

§ 371 Date: Aug. 18, 2021

Related U.S. Application Data
(60) Provisional application No. 62/815,574, filed on Mar. 8, 2019.

(51) Int. Cl. C25B 11/034; C25B 3/29; C25B 15/08; C25B 9/65; C25B 9/30; C25B 15/02

(52) U.S. Cl. CPC C25B 11/034; C25B 3/29; C25B 15/02; C25B 9/65; C25B 9/30; C25B 15/087

(57) ABSTRACT

A novel polymers production process, often with fuels/chemicals as by-products. The invention consists of device, addition polymerization, condensation polymerization, process with piping, control and procedure. The device is a mechanical design to continuously remove solid deposit, conductive or not, on electrode surface. Besides overcoming the limitation of electrochemical polymer production where the products blocks the electrode from further operation, the device provides cheaper operation for electrometallurgy to harvest the valuable metals formed on electrode. The novel process allows retrofitting conventional polymer production process by replacing conventional reactor with electrochemical reactor, for low-cost rapid implementation. The novel reactions consist of addition reaction to produce addition polymers; and intermolecular reaction to produce classes of condensation polymers. The clusters of invention enable valuable polymers and chemicals to be produced at low cost for milder conditions and cheaper equipment, while allowing utilization of alternative feedstock especially chemical wastes, for further environmental and economic benefits.

### TECHNICAL FIELD

The technical field generally relates to production methods of polymers and chemicals compounds. Specifically, it comprises of electrochemical device design, addition polymerization, condensation polymerization and concerted chemical process, specific process implementation, process control method and operation procedure.

### BACKGROUND

The conventional 1-8 Polymer production consists of feeding the 1-6 Reactants to be mixed and sent into 1-2 Conventional Reactor where reactions happen with the application of high 1-11 Heat and 1-12 Pressure, as outlined in FIG. 1. The 1-8 Polymer forms as solid suspension and would be separated out of the liquid phase, for washing and further 1-4 Processing, while the residual reagents would be recovered for any valuable by-product. For instance, the continuous production of polylactide from lactic acid [1], which involves use of 1-13 Catalyst for polymerization in combination with removal of water or a solvent carrier. On the other hand, the polyethylene production [2] involves the use of 1-13 Catalyst, comprised of aluminium and transition metal compounds, to produce the 1-8 Polymer in a polymerization reactor, followed by polymer and solvent recovery system.

The design flaw of conventional 1-8 Polymer production, however, is that it requires the use of high 1-11 Heat and 1-12 Pressure, while often involves the use of hazardous reagents such as 6-3 Phosgene and expensive 1-13 Catalysts. For instance, the 1-8 Polymer production process [3] uses heating to drive the condensation polymerization between aromatic dicarboxylic acid, diacetate of 2,2-bis(4-hydroxyphenyl)propane (also known as “6-2 Bisphenol A”) and acetate of p-hydroxybenzoic acid. Nevertheless, this can be improved because the reaction of polymerization is fundamentally not energy-intensive. In terms of general mechanism of polymerization reaction kinetics outlined in FIG. 2, the rate of reaction is mostly limited by the kinetic bottle neck for 2-1 Initiation, that led to such high 1-11 Heat and 1-12 Pressure, while the rest of the reaction steps involve 2-2 Propagation step and 2-3 Termination step that happens rapidly for the fundamentally low energy requirement.

Alternatively, polymerization reaction can be driven by the use of 3-1 Electricity instead of 1-11 Heat. Such alternative, an electrochemical reaction, involves connecting electrical supply to electrodes dipped in an 1-7 Electrolyte as shown by FIG. 3. The 1-7 Electrolyte is usually a conducting liquid mixture of 1-6 Reactants where 6-6 Conducting ions is present but can be conducting 30-6 Membrane soaked with liquid mixture of 1-6 Reactants. The electrode consists of a conducting material where electrochemical reaction happen on the surface; where the electrode connected to positive terminal of power supply is called 3-2 Anode which is where oxidation reactions happen, and the electrode connected to the negative terminal of 3-1 Electricity supply is called 3-3 Cathode which is where reduction reactions happen. While not essential for reaction to happen, a third electrode, called 3-4 Reference Electrode, is often included to provide a 3-4 Reference Electrode voltage measurement.

When solid products result from electrochemical reaction, it tends to stick on the surface of electrode as 3-5 Solid Deposit, which often would requires 9-8 Solid Removal to maintain the performance of the electrochemical cell. 9-8 Solid Removal from electrode is of interest because it has application for electrochemical metallurgy and battery where metals of interest are formed as 3-5 Solid Deposit on the electrode and need to be recovered/isolated for further 1-4 Processing. Conventionally for metal products, the 3-5 Solid Deposit could be removed manually, while some robotic arms system [4] has also been designed to strip the metallic 3-5 Solid Deposit plated on 3-3 Cathode, by mimicking human arm movement, especially in mining industry such as the electrowinning plant. The 9-8 Solid Removal is also stripped mechanically in batches of deposited sheets, organized in a production line, in metal recovery processes, such as recovery of zinc [5].

However, such electrochemical polymerization has been limited to a niche of conductive 1-8 Polymers like the polypyrroles and polythiophenes. For instance, polypyrroles, or its derivatives, has been produced electrochemically [6] as deposits from monomers in the presence of a 6-6 Conducting ions such as 68-3 Dissolved Salt, connected to electrical supply. A similar analogue is the electrochemical production of polythiophene, or its substituted derivatives [7], under non-aqueous organic solvent and applied electrochemical potential, especially in a more cost-effective and energy-efficient manner. Fundamentally, the 1-8 Polymer to produced electrochemically is limited to a few types of 1-8 Polymers that have unsaturated bonds to provide conductivity as in Table 1, such as aromatic rings and double bonds or even triple bonds:

TABLE 1
The limited types of conductive 1-8 Polymers containing unsaturated
bonds produced by electrochemical method due to the limitation of
non-conductive product blocking the electrode

| 1-8 Polymers | Molecular structure |
|---|---|
| Polypyrrole [6] | 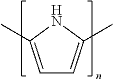 |
| Polythiophene [7] | 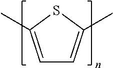 |

This is because the similar batch electrode stripping method used for conductive metal deposits, would not work if the 3-5 Solid Deposit formed (on 3-2 Anode or 3-3 Cathode depending on reaction) is non-conductive, since non-conductive 3-5 Solid Deposit would block the electrode surface and the electrochemical reaction halts due to lack of conductivity. As a result, the alternative electrochemical production of non-conductive 1-8 Polymer has not received attention, yet the majority of present-day 1-8 Polymers such as polyethylene are non-conductive. Fortunately, such fundamental limitation is being overcome by a novel simple yet elegant design feature of 7-1 Device that removes the 1-8 Polymer formed, continuously from the electrode, as demonstrated by FIG. 4. The novel 7-1 Device opens up the door to produce non-conductive 1-8 Polymers by electrochemical method, and gives rise to a potential business model that combines 1-8 Polymer production with 5-2 Chemical wastes valorization, as demonstrated by FIG. 5. This is due to the electrochemical polymerization allows the use of 5-3 Commodity Chemicals from some types of 5-2 Chemical wastes that are otherwise unreactive, to participate in reaction to be converted into valuable 1-8 Polymers and secondary 5-5 Feedstock Chemicals such as fuels, which is a novel idea instead of the cost to dispose of the 5-2 Chemical wastes. A more complete, yet still not exhaustive list of the 5-3 Commodity Chemicals would be covered in subsequent sections. To name a few, possible 5-2 Chemical wastes and 5-3 Commodity Chemicals include but are not limited to:

1. Waste Sludge/Solvent (Toxic):
Ethylene glycol
Propylene glycol

2. Petrochemical Waste (Toxic)
Halohydrin

3. Common Waste/Feedstock:
6-1 Urea

4. Biomass:
Ethanol

The electrochemical methods also offer a variety of advantages compared to the traditional limitations of conventional 1-8 Polymer production, as illustrated by an example in FIG. 6, including:
Milder 1-11 Heat and 1-12 Pressure which reduces cost (capital cost for these equipment and operating cost for the energy input)
Less dependence of 1-13 Catalyst which is often costly and with some environmental impacts
Integration with existing 5-4 Renewable Energy instead of using fossils fuels to drive reaction
Compatibility with downstream polymer 1-4 Processing since the products are the same, which allows fast and easy implementation since a conventional plant can be purchased and just have the 1-2 Conventional Reactor changed to 35-1 Electrochemical Reactor, instead of redesigning/rebuilding the entire system
The interest of 9-8 Solid Removal from metallurgy industry offers opportunity of income from 6-4 License

More importantly, the use of electrochemical method reduces the need to use reactive yet hazardous/toxic 5-3 Commodity Chemicals that has negative environmental impacts, such as replacing the costly yet toxic 6-3 Phosgene used conventionally in 6-7 Polycarbonates production, and the replacement of the corrosive 6-8 Hydrochloric acid to 6-9 Ammonia which is less hostile but fetch higher selling price.

### SUMMARY

As outlined by FIG. 7, the invention of electrochemical 1-8 Polymer production involves major elements: 7-1 Device, 7-2 Chemistry involving 7-3 Addition Polymer and 7-4 Condensation Polymer, 7-5 Process, 7-8 Procedure, 7-6 Piping and 7-7 Control.

The 7-1 Device involves a novel design of 9-8 Solid Removal device that can continuously remove 3-5 Solid Deposit formed onto electrode, regardless of conductivity. It involves the use of circular/cyclic motion of electrode surface in contact of a device to remove 3-5 Solid Deposit on continuous process basis, without having to remove the electrode. While many other arrangements are possible, the major 4 variants are 9-1 Cylinder Electrode, 9-2 Conveyor Belt Electrode, 9-3 Rotating Disk Electrode and 9-4 Spiral/Screw Electrode. It also involves the use of the 7-1 Devices, including jack-up feature, 9-7 Motion Transmission, 9-13 Support and Solid Transport 9-9 Solid Transport.

The 7-3 Addition Polymer results from an electrochemical addition reaction, in which no by-product is formed. For example, some 7-3 Addition Polymers include 1-8 Polymers where the backbones are generally carbon atoms (usually those polyvinyl 1-8 Polymers such as polyethylene, polystyrene and polyvinyl chloride). In some embodiments, the polymerization reaction happens by intramolecular elimination to form alkene, which subsequently undergo addition reaction in situ (right in the reagent) to form the polymeric products. It has variants of homopolymer where only one type of starting feedstock in used, or copolymer where different starting feedstock can be mixed together to make 1-8 Polymer with more complex structure.

The 7-4 Condensation Polymer results from an electrochemical condensation reaction. For example, some 7-4 Condensation Polymers include 1-8 Polymers where the backbones contain heteroatom such as oxygen atom (polyether and 33-8 Polyester) or nitrogen atom (33-9 Polyamides as in protein and nylon). It involves intermolecular elimination where the monomer molecules end up joining together. It comprises mainly of condensation where simple elimination happens, and transesterification where more complex condensation and/or exchange reactions happen. It could also involve ring-opening of cyclic monomer molecules to form a long chain 1-8 Polymer.

The process outlines the general electrochemical production process 34-1 Concept in industrial setting and the 34-5 Block Flow Diagram. While auxiliary polymer process equipment can be designed to fit the 35-1 Electrochemical Reactor, the process could instead involve 34-3 Retrofitting existing conventional 1-8 Polymer production process by designing the electrochemical 7-1 Device to fit the existing auxiliary 1-8 Polymer process equipment and replace existing 1-2 Conventional Reactor unit. In some cases, the chemical 1-5 Recovery unit can be replaced by simpler version or even involving 34-2 Recovery elimination, if the chemical by-product becomes less hazardous.

The 7-6 Piping involves the specific industrial process implementation, including 40-1 Process Flow Diagram and Auxiliary Units, 40-2 Piping Types, 40-3 Pumps/Compressor, 40-4 Heater/Cooler, 40-5 Utility, 40-6 Valves to facilitate the industrial implementation of the process. It involves the process flow where the units are connected. It also builds beyond the process section by further detailing the specific implementation, such as the reservoir tanks.

The 7-7 Control consists of the indicators and controllers, as well as the 7-7 Control strategy used to keep the process in continuous operation. It comprises a combination of 48-2 Feedforward, 48-3 Feedback, 48-4 Ratio, 48-5 Split Range, 48-6 Override Select, 48-7 Indicator/Alarm process control method applied to keep the process reliable against disturbances. In some implementation, the 7-7 Control is designed such that any disturbance would eventually be transferred to the tank levels, which has huge tolerance.

The 7-8 Procedure provides the operation techniques to 59-2 Deployment the 7-1 Devices rapidly and reliably. It involves the modular elements where 59-1 Stacking of each 35-1 Electrochemical Reactor is involved and the distribution of feedstock. Other than 59-2 Deployment of 35-1 Electrochemical Reactor, it provides procedural explanation of 34-3 Retrofitting, 59-3 Maintenance and 34-4 Waste Management.

Finally, the industrial production process involves the concerted use of the above elements in combination.

### BRIEF DESCRIPTION OF DRAWINGS

FIG. 1 Conventional Polymer production process with Conventional Reactor as the key component

FIG. 2 Representative explanation of why the conventional chemical process requires high Heat and Pressure to create radicals to initiate the reaction

FIG. 3 Illustration of bench-scale electrochemical polymerization, or any general electrochemical reaction where solid deposit is resulted

FIG. 4 Mechanism of continuous solid removal

FIG. 5 General chemical business model of elerGreen Industry

FIG. 6 Demonstration of advantages offered by the novel electrochemical process

FIG. 7 Breakdown of the features of inventions of elerGreen Process

FIG. 8 Illustration of Reading Engineering Drawing using the Notation and Symbols

FIG. 9 Breakdown of the variants of the novel electrochemical Device design

FIG. 10 Basic Working Principles of Solid Removal (Cylinder Electrode)

FIG. 11 Unit cell of the Electrochemical Reactor (Cylinder Electrode)

FIG. 12 Basic Working Principles of Solid Removal (Conveyor Belt Electrode)

FIG. 13 Unit cell of the Electrochemical Reactor (Conveyor Belt Electrode)

FIG. 14 Basic Working Principles of Solid Removal (Rotating Disk Electrode)

FIG. 15 Unit cell of the Electrochemical Reactor (Rotating Disk Electrode)

FIG. 16 Basic Working Principles of Solid Removal (Spiral/Screw Electrode (Spiral/Screw Electrode)

FIG. 17 Unit cell of the actual Electrochemical Reactor (Spiral/Screw Electrode)

FIG. 18 Breakdown of Device

FIG. 19 Motion generation

FIG. 20 Motion transmission

FIG. 21 Solid Removal and Solid Transport

FIG. 22 Reaction Vessel

FIG. 23 Support

FIG. 24 Gas Removal device

FIG. 25 Stacking Solid Removal device

FIG. 26 Conducting brush

FIG. 27 Waxing

FIG. 28 Variants of drainage/channel for Solid Transport Addition and/or Condensation

FIG. 29 Breakdown of the electrochemical production of Addition Polymer

FIG. 30 Variants of Conducting Ions

FIG. 31 Variants of Cosolvent

FIG. 32 Variants of Additives

FIG. 33 Breakdown of the major possibilities of electrochemical production of Condensation Polymer

FIG. 34 Breakdown of concerted process

FIG. 35 General variant of the novel electrochemical polymer production process, where the conventional reactor is replaced by Electrochemical Reactor, where the by-products would still be recovered using similar recovery unit

FIG. 36 A variant of the novel electrochemical polymer production process, where the recovery unit is not needed when the by-products are easier to deal with

FIG. 37 Retrofitting feature

FIG. 38 Waste Management

FIG. 39 General Block flow Diagram

FIG. 40 Breakdown of Piping

FIG. 41 General Process Flow Diagram for Industrial Implementation

FIG. 42 Conventional Reactor Path

FIG. 43 Electrochemical Reactor Path

FIG. 44 Solvent Extraction path

FIG. 45 Sorption path

FIG. 46 By-product as Low Key

FIG. 47 By-product as High Key

FIG. 48 Breakdown of Process Control

FIG. 49 Detailed Piping & Instrumentation Diagram (P&ID) for the Electrochemical polymer Production Process

FIG. 50 Legend for the P&ID

FIG. 51 Cascade Control Example

FIG. 52 Feedforward Example

FIG. 53 Feedback Example

FIG. 54 Ratio Control Example

FIG. 55 Split Range Control Example

FIG. 56 Illustration of Split Range Control interlock

FIG. 57 Override Select Control Example

FIG. 58 Indicator and Alarm Example

FIG. 59 Breakdown of Operating Procedure

FIG. 60 Stacking of electrodes

FIG. 61 Stacking of cells (2×1)

FIG. 62 Stacking of cells (2×2)

FIG. 63 Stacking of cells (2×n)

FIG. 64 Example Deployment of cells in Stacking

FIG. 65 Stacking of cells (2×n), outward facing

FIG. 66 Stacking of cells (n×n), hanging electrode

FIG. 67 Deployment procedure of cell

FIG. 68 Experimental Setup with gas flow rate measurement

FIG. 69 Experimental Setup without gas flow rate measurement

FIG. 70 Sample Observation

FIG. 71 Identification of products

FIG. 72 Conversion against cumulative charge

FIG. 73 Mole reacted against cumulative charge

FIG. 74 Current against Applied Voltage

FIG. 75 Gas Flow Rate against Current

### DETAILED DESCRIPTIONS

### 1. Chemical Terminology

The electrochemical polymerization reaction can be represented by the following general equation as Equation 1:

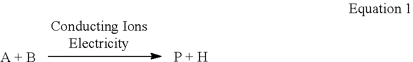

Before proceeding to describe the invention in further detail, some symbols to be used in later section is outlined as terminology in Table 2.

TABLE 2
The specific terrninology/symbols and the corresponding
representation in the description

| Symbol | Meaning |
|---|---|
| 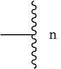 | Any Substitute group: Halides; Carbon backbone, —OH, Amines, etc |
| —Rₙ | Any carbon backbone: |
| | Aliphatic (Alkyl) or Aromatic |
| —Q— | Any group except carbon backbone: |
| | Carbonate, Amine, Ether, Ester, etc |
| Conducting | Any species that can provide mobile |
| Ions | ions for conduction: |
| | Salt (Sodium chloride/table salt), organic |
| | salt (sodium palmitate/common soap), |
| | ionizable molecule (Hydrochloric acid), |
| | or ion exchange membrane |
| n | Number of repeating units, |
| | can be from 1 (monomer) to very big numbers |

First, the substitute group is represented with a chemical bond and a wavy curve with number, where the number simply is the index number of the substitute group.

The carbon backbone, be it aliphatic (alkyl) or aromatic (aryl), is represented with Rn and any nearby chemical bond that applies, n is simply the index number of the carbon backbone group.

The substitute group besides carbon backbone is often the active site of reaction, and would be represented with Q and any nearby chemical bond that applies.

For simplicity, conducting ions refer to any species that can provide mobile ions for conduction, including salt (Sodium chloride/table salt), organic salt (sodium palmitate/common soap), ionizable molecule (Hydrochloric acid), or ion exchange membrane. It is used in the electrochemical system to provide electrical conductivity to facilitate electrochemical reaction. For industrial implementation the conducting ions is commonly used in the variants of 68-3 Dissolved Salt, which can be 30-5 Inorganic such as sodium chloride (table salt) or 30-4 Organic salt (sodium palmitate), depending on polarity of the system.

Lastly, the number n would be used in many chemical equations as subscript of a bracket, which simply means the number of repeating units in the 1-8 Polymer. It can range from 1 (monomer) to a big number up to ten of thousands or even more.

### 2. Label of Drawings

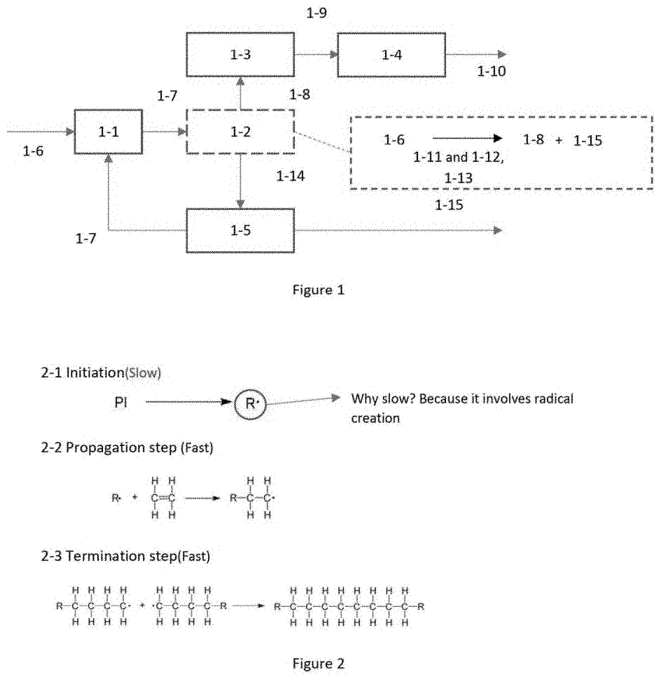

The labels in the drawings are designated according to their order of first appearance in the drawings.
1. FIG. 1 Conventional Polymer production process with Conventional Reactor as the key component

1-1 Preparation

1-2 Conventional Reactor

1-3 Solid Separation

1-4 Processing

1-5 Recovery

1-6 Reactants

1-7 Electrolyte

1-8 Polymer

1-9 Clean polymer

1-10 Polymer product

1-11 Heat

1-12 Pressure

1-13 Catalyst

1-14 Spent electrolyte

1-15 By-product
2. FIG. 2 Representative explanation of why the conventional chemical process requires high Heat and Pressure to create radicals to initiate the reaction

2-1 Initiation

2-2 Propagation step

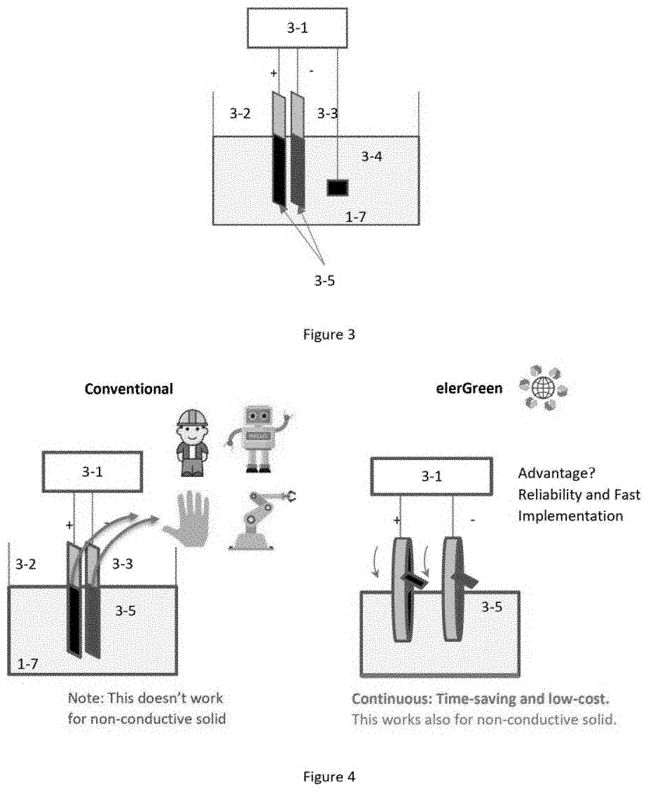

2-3 Termination step
3. FIG. 3 Illustration of bench-scale electrochemical polymerization, or any general electrochemical reaction where solid deposit is resulted

3-1 Electricity

3-2 Anode

3-3 Cathode

3-4 Reference Electrode

3-5 Solid Deposit
4. FIG. 4 Mechanism of continuous solid removal

4-1 Moving electrode

4-2 Removal Device
5. FIG. 5 General chemical business model of elerGreen Industry

5-1 elerGreen Process

5-2 Chemical wastes

5-3 Commodity Chemicals

5-4 Renewable Energy

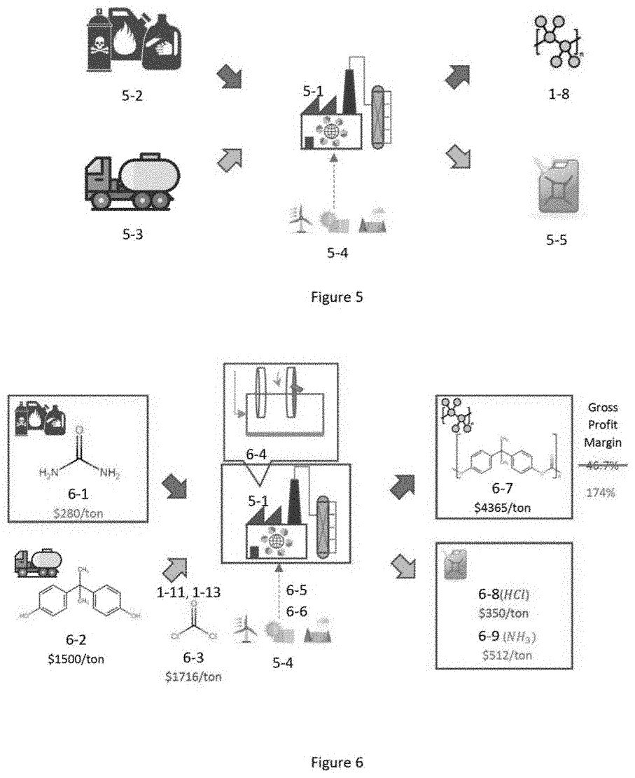

5-5 Feedstock Chemicals
6. FIG. 6 Demonstration of advantages offered by the novel electrochemical process

6-1 Urea

6-2 Bisphenol A

6-3 Phosgene

6-4 License

6-5 Applied Voltage

6-6 Conducting ions

6-7 Polycarbonates

6-8 Hydrochloric acid

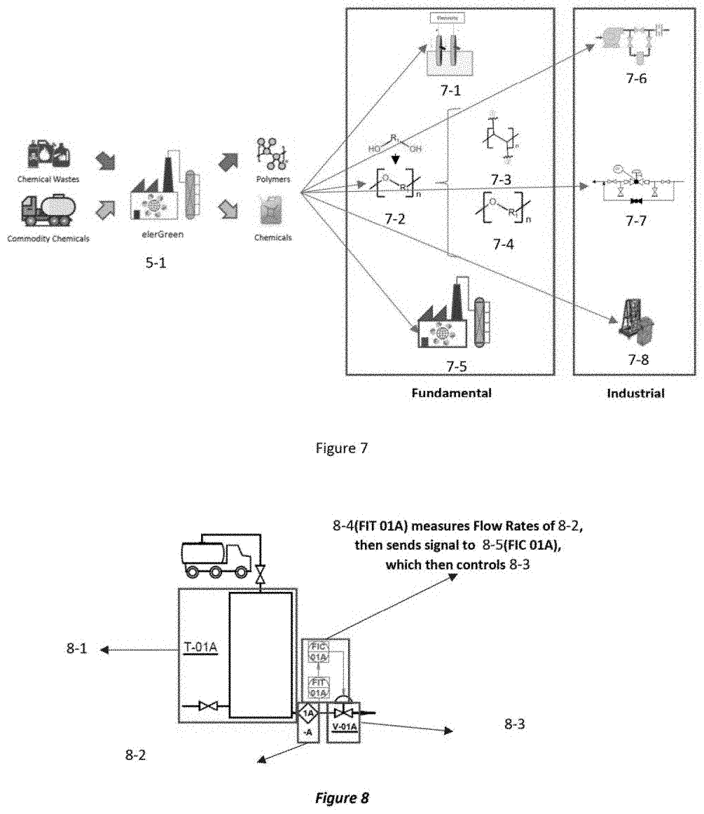

6-9 Ammonia
7. FIG. 7 Breakdown of the features of inventions

7-1 Device

7-2 Chemistry

7-3 Addition Polymer

7-4 Condensation Polymer

7-5 Process

7-6 Piping

7-7 Control

7-8 Procedure
8. FIG. 8 Illustration of Reading Engineering Drawing using the Notation and Symbols

8-1 Feed Tank A

8-2 Stream 1A

8-3 Control valve V-01A

8-4 Flow rate indicator Transmitter 01A

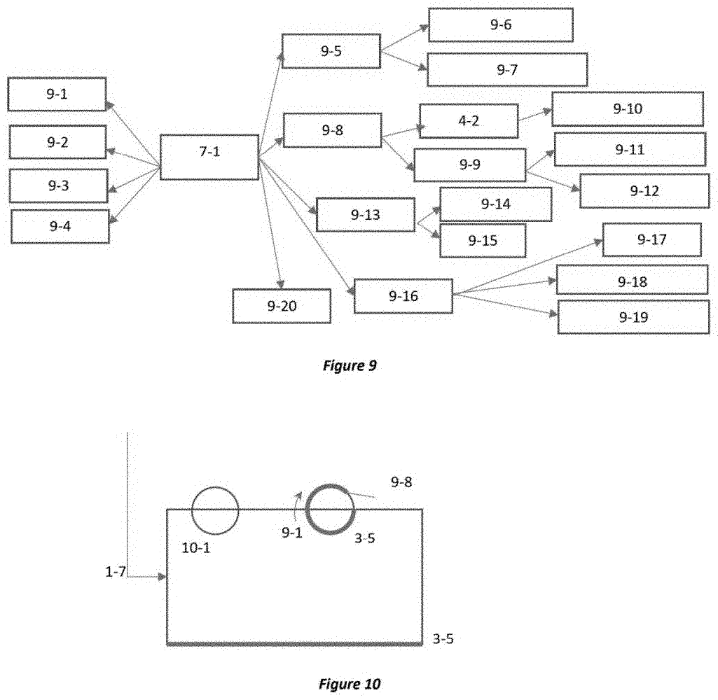

8-5 Flow Rate Indicator Controller 01A
9 FIG. 9 Breakdown of the variants of the novel electrochemical Device design

9-1 Cylinder Electrode

9-2 Conveyor Belt Electrode

9-3 Rotating Disk Electrode

9-4 Spiral/Screw Electrode

9-5 Mechanical

9-6 Motion Generation

9-7 Motion Transmission

9-8 Solid Removal

9-9 Solid Transport

9-10 Multiple Blades

9-11 Conveyor

9-12 Channel

9-13 Support

9-14 Movable

9-15 Built-In

9-16 Accessories

9-17 Gas Removal

9-18 Conducting Brush

9-19 Waxing

9-20 Vessel
10. FIG. 10 Basic Working Principles of Solid Removal (Cylinder Electrode)

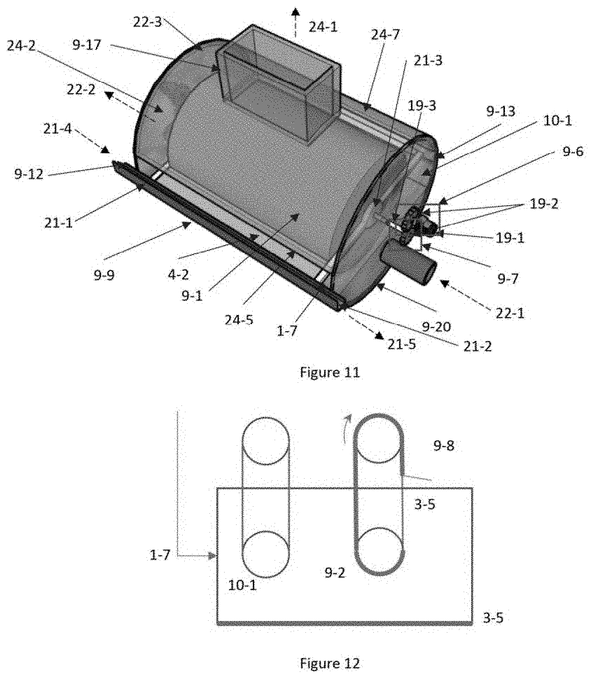

10-1 Counter Electrode
11. FIG. 11 Unit cell of the Electrochemical Reactor (Cylinder Electrode)
12. FIG. 12 Basic Working Principles of Solid Removal (Conveyor Belt Electrode)

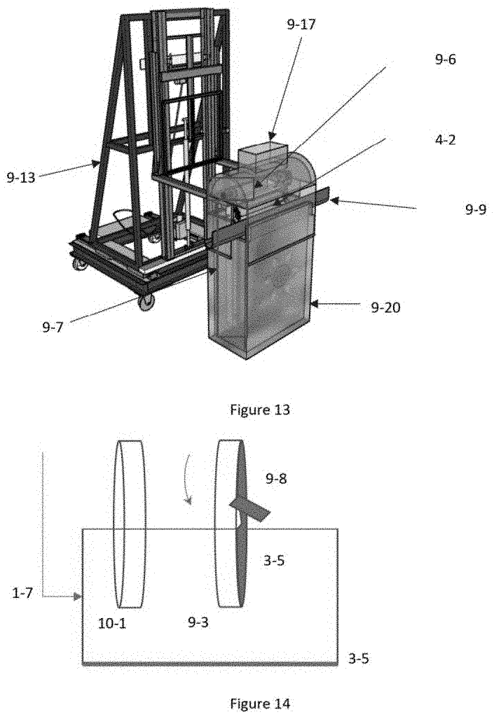

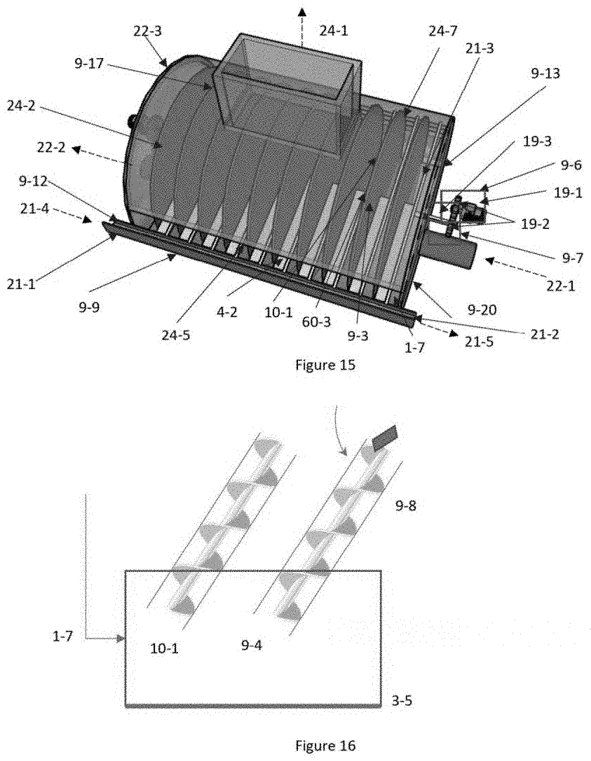

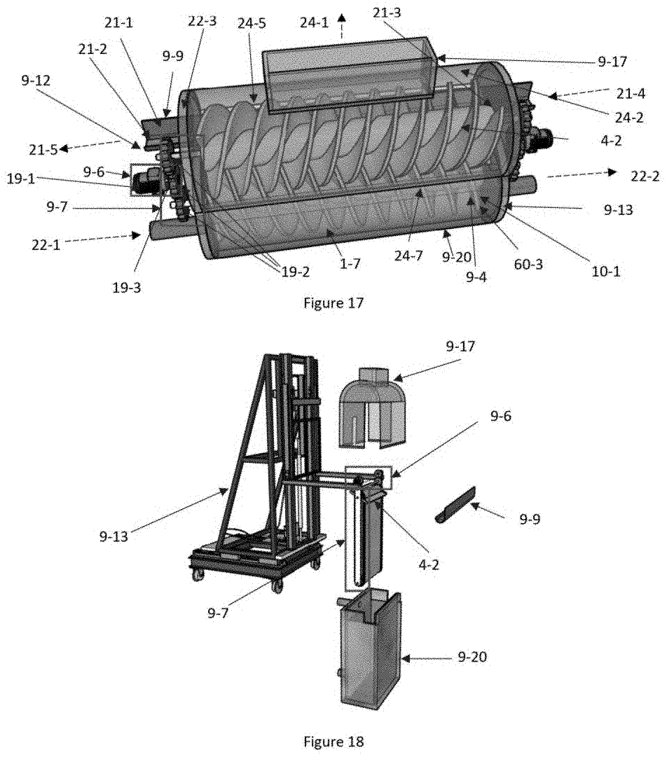

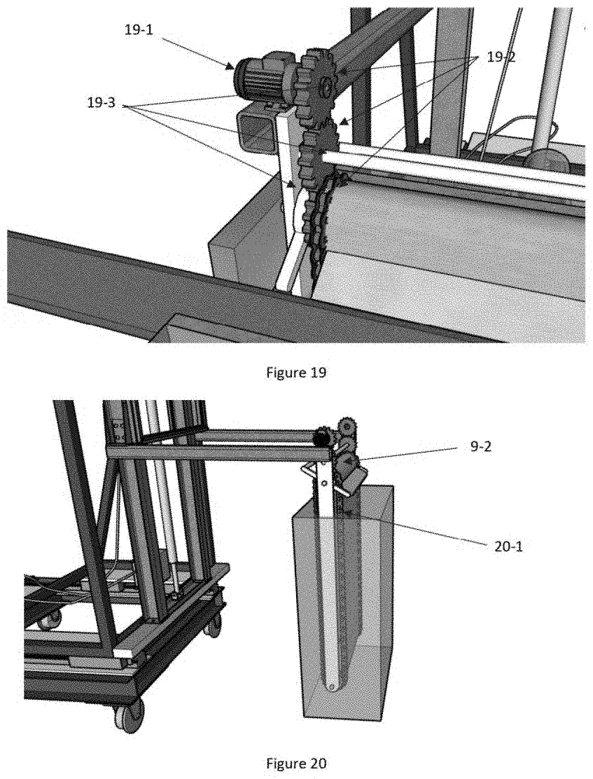

12-1 Pulley
13. FIG. 13 Unit cell of the Electrochemical Reactor (Conveyor Belt Electrode)
14. FIG. 14 Basic Working Principles of Solid Removal (Rotating Disk Electrode)
15. FIG. 15 Unit cell of the Electrochemical Reactor (Rotating Disk Electrode)
16. FIG. 16 Basic Working Principles of Solid Removal (Spiral/Screw Electrode (Spiral/Screw Electrode)
17. FIG. 17 Unit cell of the actual Electrochemical Reactor (Spiral/Screw Electrode)
18. FIG. 18 Breakdown of Device
19. FIG. 19 Motion generation

19-1 Motor/engine

19-2 Gears

19-3 Shaft
20. FIG. 20 Motion transmission

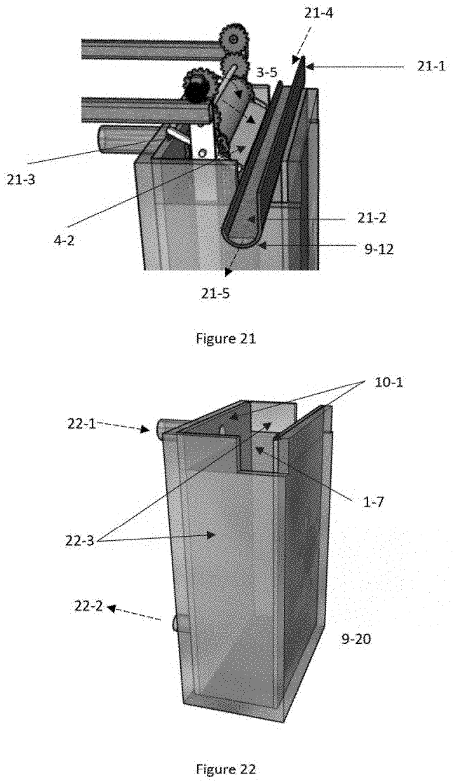

20-1 Chain drive
21. FIG. 21 Solid Removal and Solid Transport

21-1 Flap

21-2 Washing fluid

21-3 Blade adjustment

21-4 Washing fluid inlet

21-5 Washing fluid outlet
22. FIG. 22 Reaction Vessel

22-1 Electrolyte inlet

22-2 Electrolyte outlet

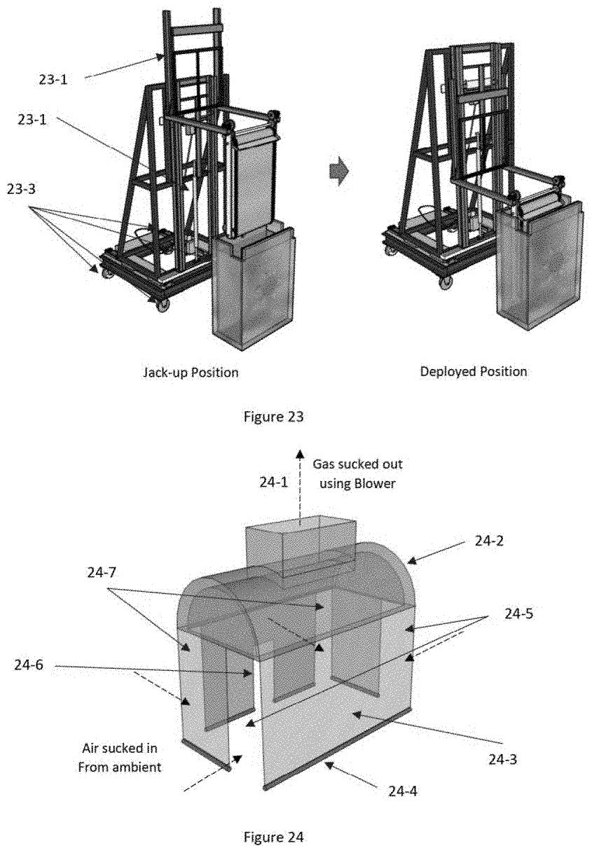

22-3 Side Windows
23. FIG. 23 Support

23-1 Hydraulic jack

23-2 Arm

23-3 Wheels

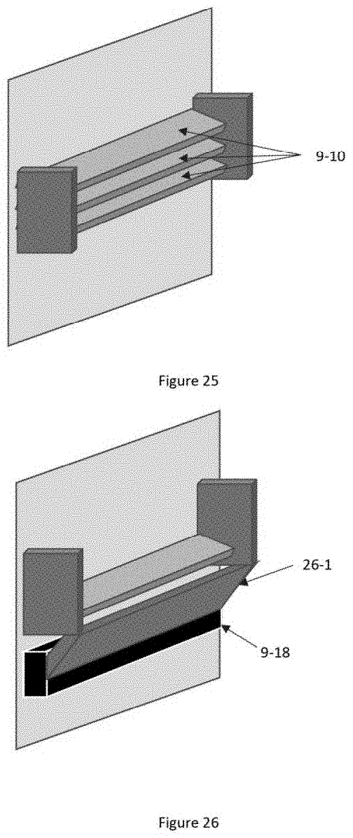

23-4 Frame Body
24. FIG. 24 Gas Removal device

24-1 Ventilation outlet

24-2 Cap

24-3 Cover

24-4 Weight

24-5 Sleeves (washing piping)

24-6 Sleeves (tank pipes)

24-7 Sleeves (electrode frames)
25. FIG. 25 Stacking Solid Removal device
26. FIG. 26 Conducting brush

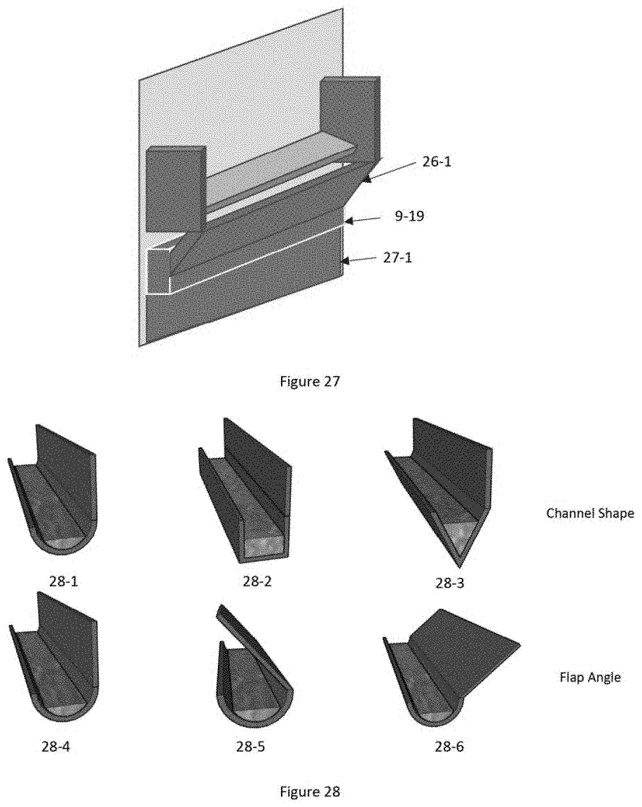

26-1 Accessory support
27. FIG. 27 Waxing

27-1 Wax Layer
28. FIG. 28 Variants of drainage/channel for Solid Transport

28-1 Arc (Default)

28-2 Rectangular 9-12 Channel

28-3 Triangular 9-12 Channel

28-4 Perpendicular Flap (Default)

28-5 Acute Flap

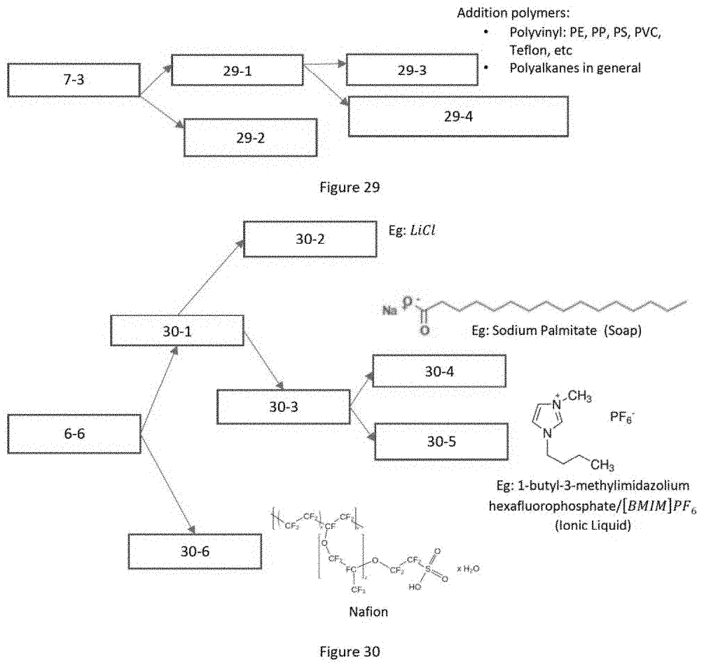

28-6 Obtuse Flap
29. FIG. 29 Breakdown of the electrochemical production of Addition Polymer

29-1 Homopolymer

29-2 Copolymer

29-3 Alcohol group

29-4 Variants
30. FIG. 30 Variants of Conducting Ions

30-1 Dissolved ions

30-2 Metallic

30-3 Non-metallic

30-4 Organic

30-5 Inorganic

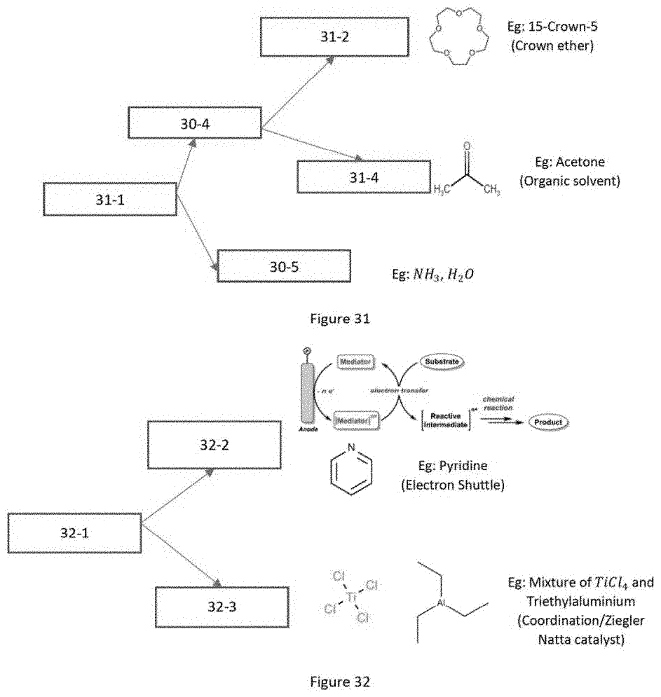

30-6 Membrane
31. FIG. 31 Variants of Cosolvent

31-1 Cosolvent

31-2 Designer Molecule

31-3 Crown ether

31-4 Solvent
32. FIG. 32 Variants of Additives

32-1 Additives

32-2 Redox

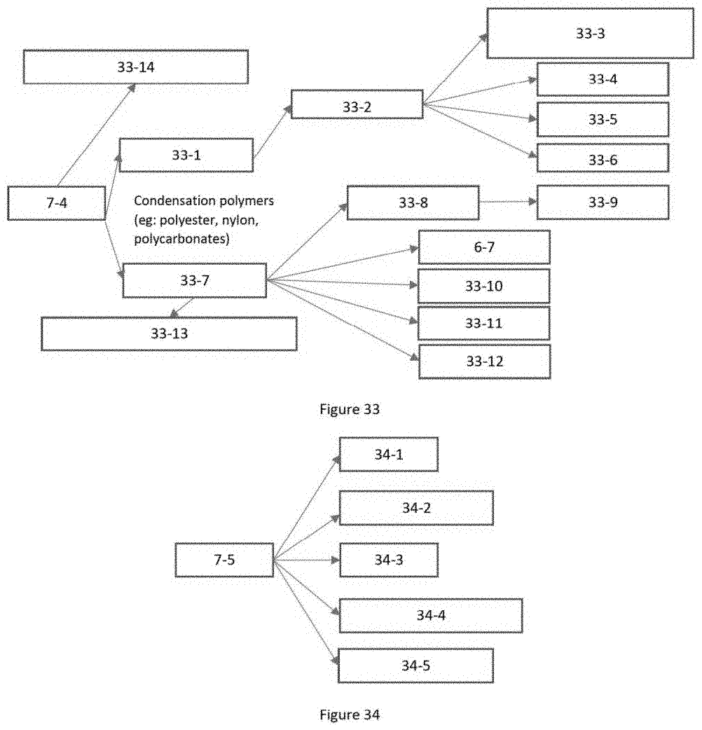

32-3 Others
33. FIG. 33 Breakdown of the major possibilities of electrochemical production of Condensation Polymer

33-1 Condensation

33-2 Polyether

33-3 Monoalcohol: Furan and phenol resins

33-4 Cellulose

33-5 Polysulfide

33-6 Polyamine

33-7 Transesterification

33-8 Polyester

33-9 Polyamide

33-10 Polyanhydride

33-11 Polyimide

33-12 Polyurethane

33-13 Ring opening

33-14 Heteroatoms: Polysiloxanes Polysulfone, Polyphosphate, polynitrate

33-15 Polysiloxanes

33-16 Polysulfone
34. FIG. 34 Breakdown of concerted process

34-1 Concept

34-2 Recovery elimination

34-3 Retrofitting

34-4 Waste Management

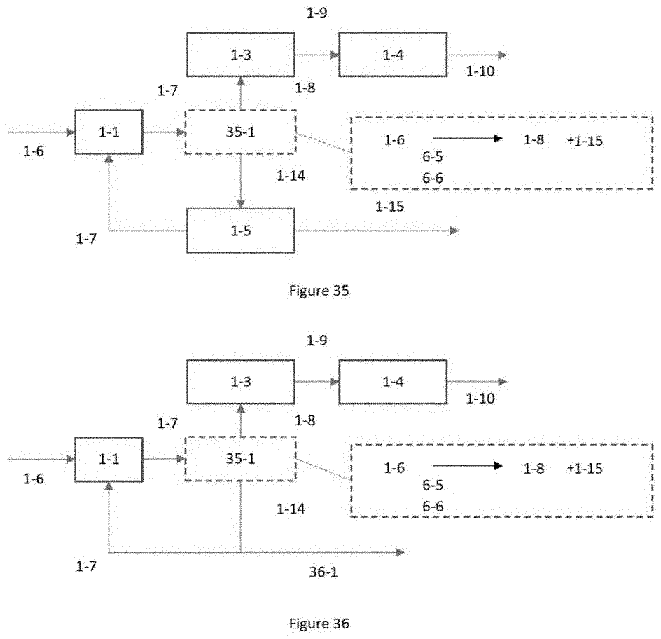

34-5 Block Flow Diagram
35. FIG. 35 General variant of the novel electrochemical polymer production process, where the conventional reactor is replaced by Electrochemical Reactor, where the by-products would still be recovered using similar recovery unit

35-1 Electrochemical Reactor
36. FIG. 36 A variant of the novel electrochemical polymer production process, where the recovery unit is not needed when the by-products are easier to deal with

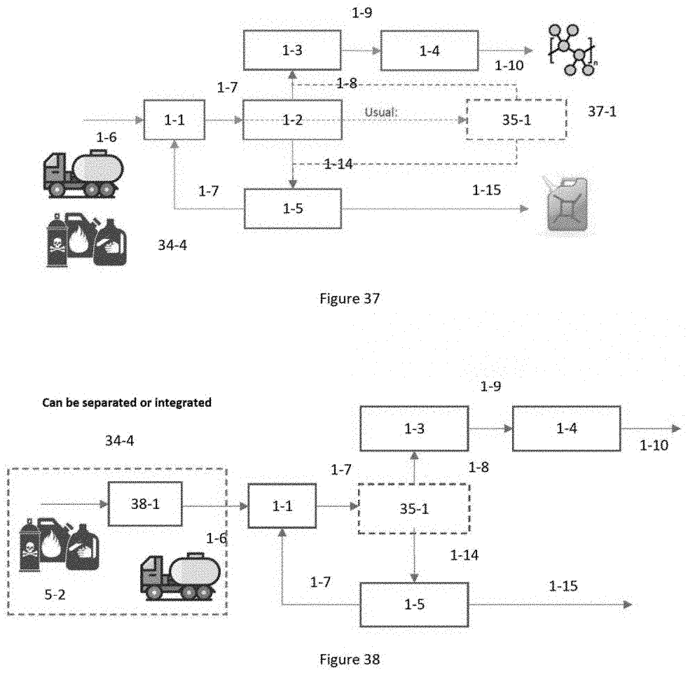

36-1 Discharge
37, FIG. 37 Retrofitting feature

37-1 Bypass

34-4 Waste Management
38. FIG. 38 FIG. 38 Waste Management

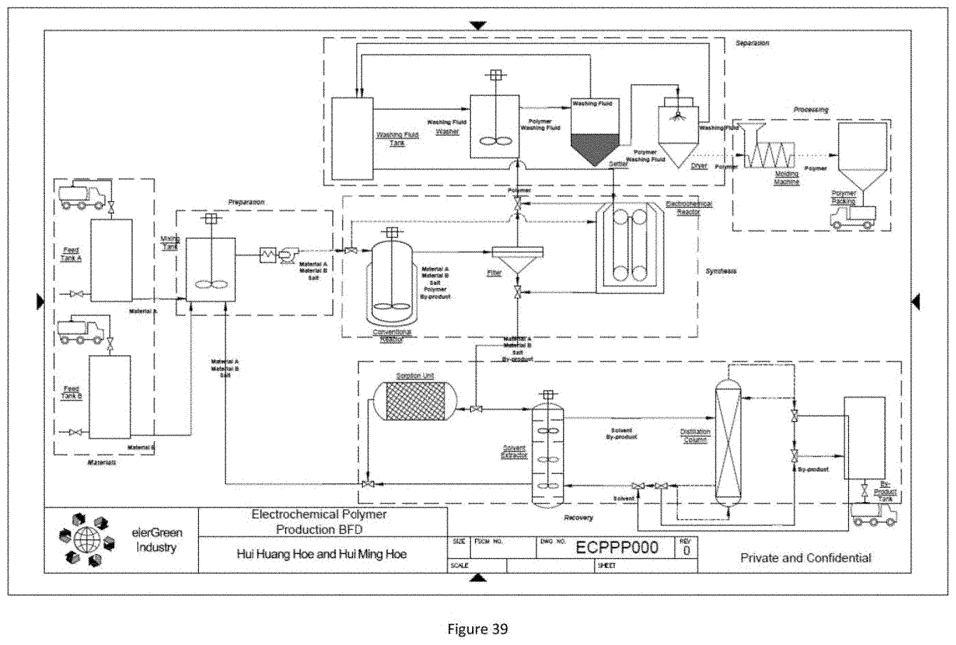

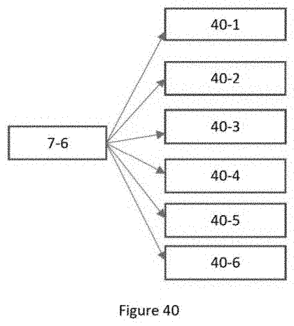

38-1 Waste Extraction
39. FIG. 39 General Block flow Diagram
40. FIG. 40 Breakdown of Piping

40-1 Process Flow Diagram and Auxiliary Units

40-2 Piping Types

40-3 Pumps/Compressor

40-4 Heater/Cooler

40-5 Utility

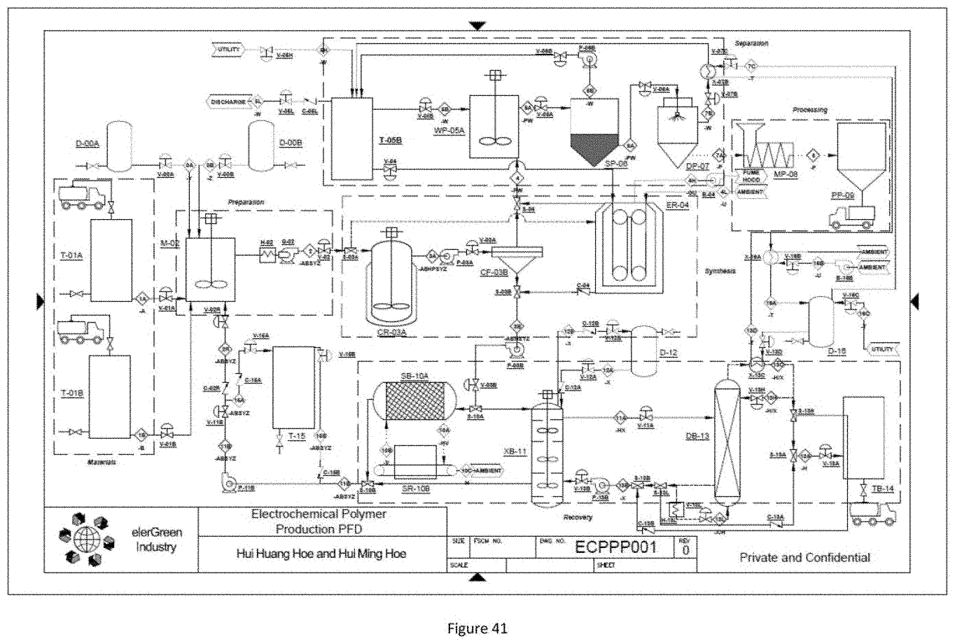

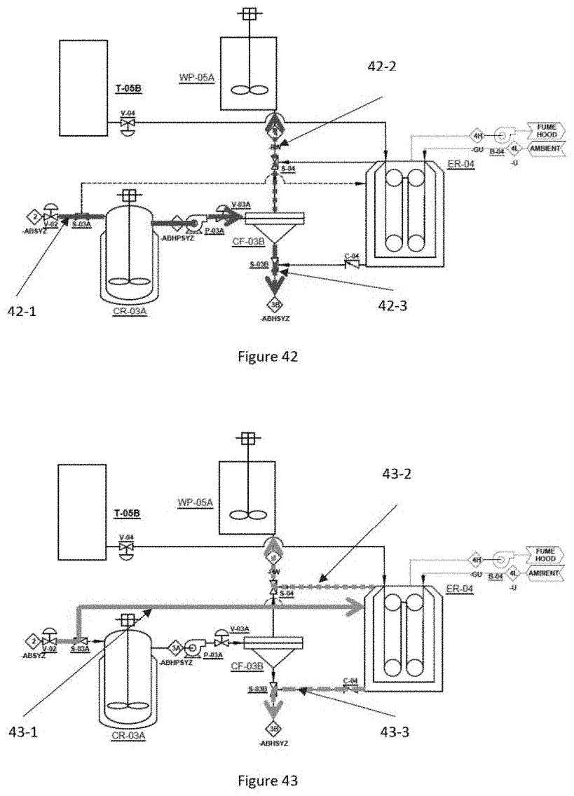

40-6 Valves
41. FIG. 41 General Process Flow Diagram for Industrial Implementation
42. FIG. 42 Conventional Reactor Path

42-1 Conventional Reaction Stream

42-2 Conventional Solid Stream

42-3 Conventional Mixture Stream
43. FIG. 43 Electrochemical Reactor Path

43-1 Electrochemical Reaction Stream

43-2 Electrochemical Solid Stream

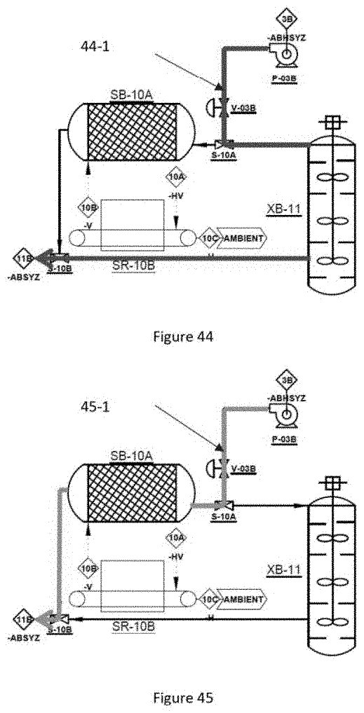

43-3 Electrochemical Mixture Stream
44. FIG. 44 Solvent Extraction path

44-1 Solvent Extraction Stream
45. FIG. 45 Sorption path

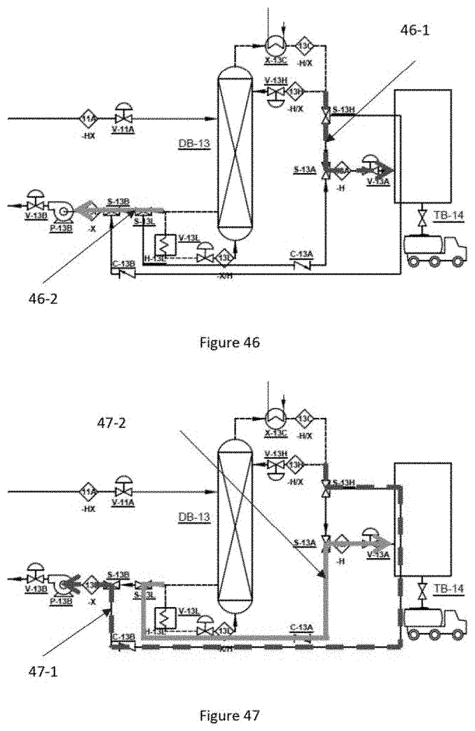

45-1 Sorption Stream
46. FIG. 46 By-product as Low Key

46-1 Top-to-tank Stream

46-2 Bottom-to-solvent Stream
47. FIG. 47 By-product as High Key

47-1 Top-to-solvent Stream

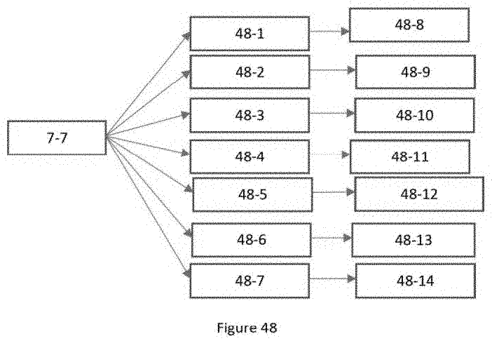

47-2 Bottom-to-tank Stream
48. FIG. 48 Breakdown of Process Control

48-1 Cascade

48-2 Feedforward

48-3 Feedback

48-4 Ratio

48-5 Split Range

48-6 Override Select

48-7 Indicator/Alarm

48-8 Prompt Response

48-9 Precision

48-10 Reliability

48-11 Multiples

48-12 Different Response Needed

48-13 Flexibility and Safety

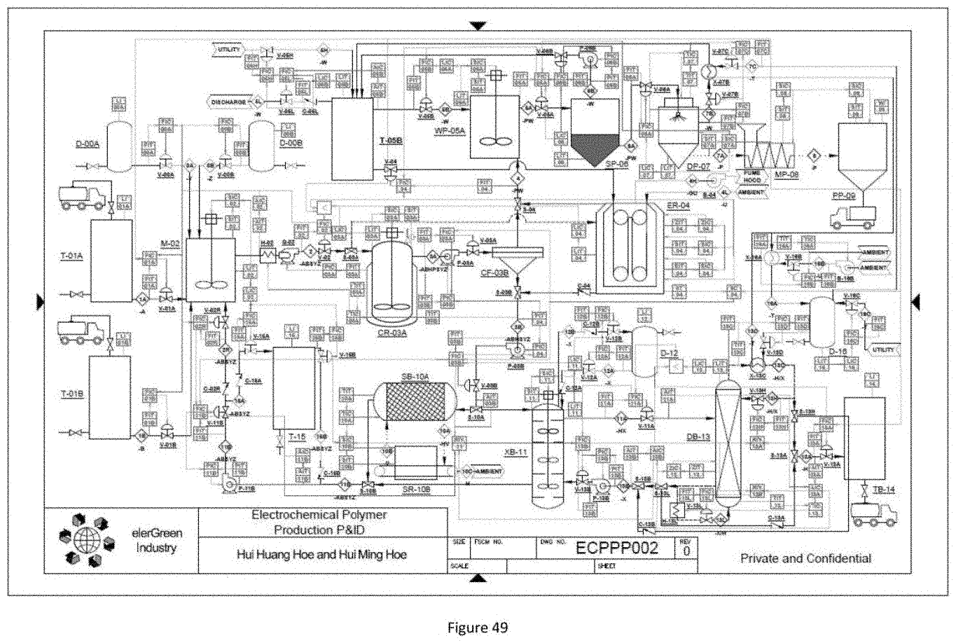

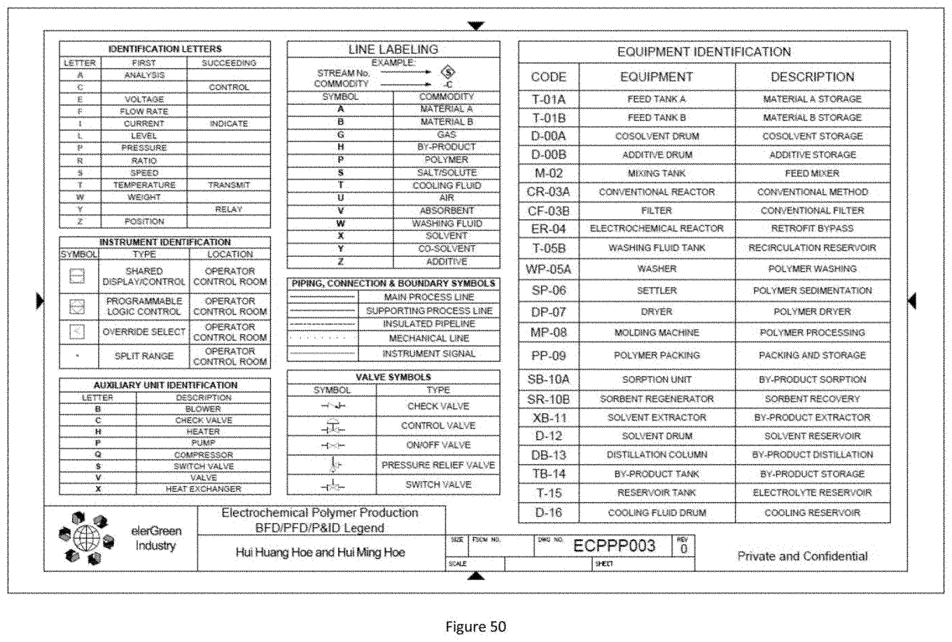

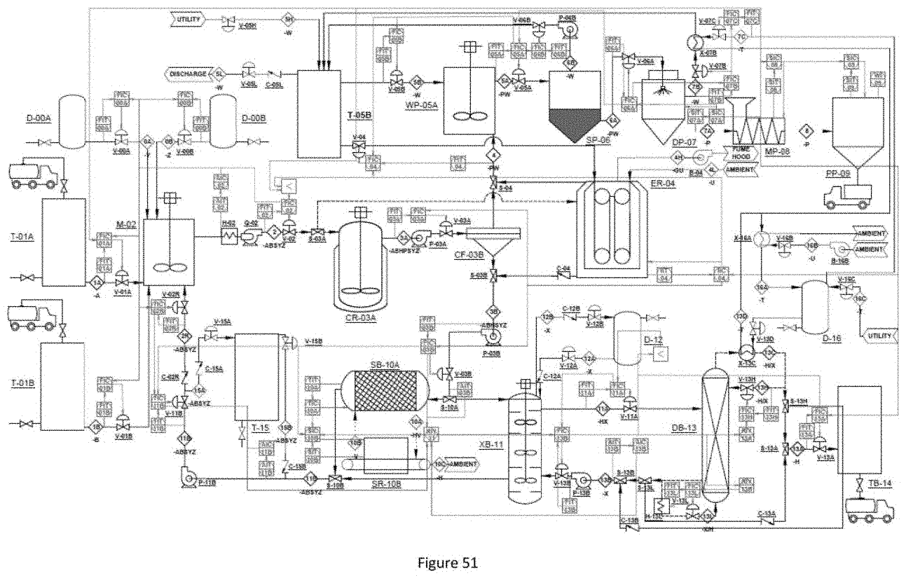

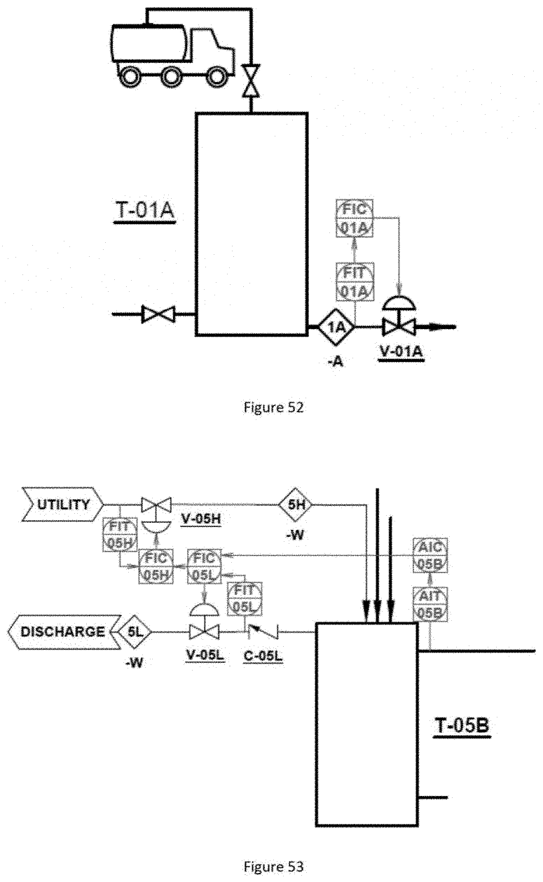

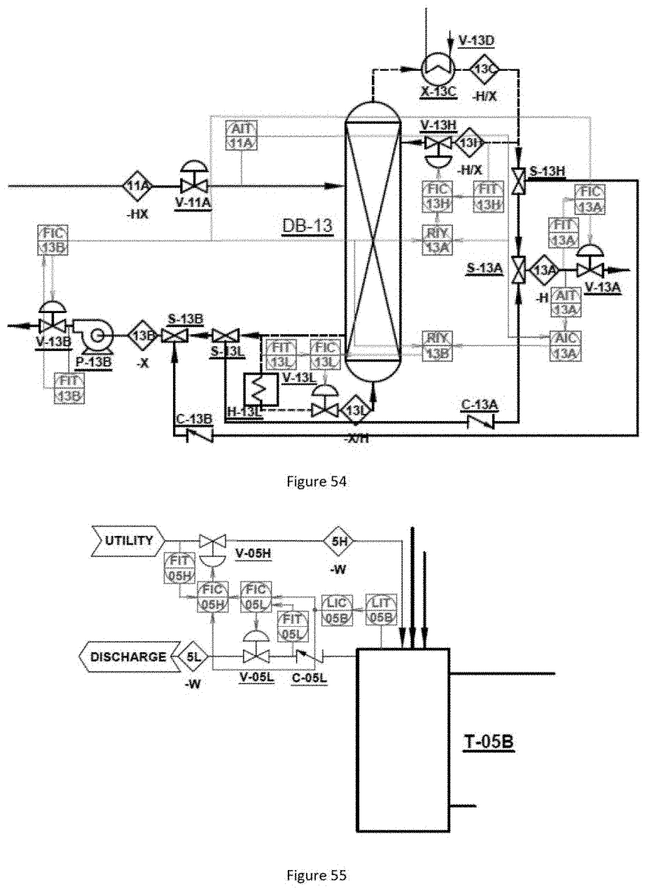

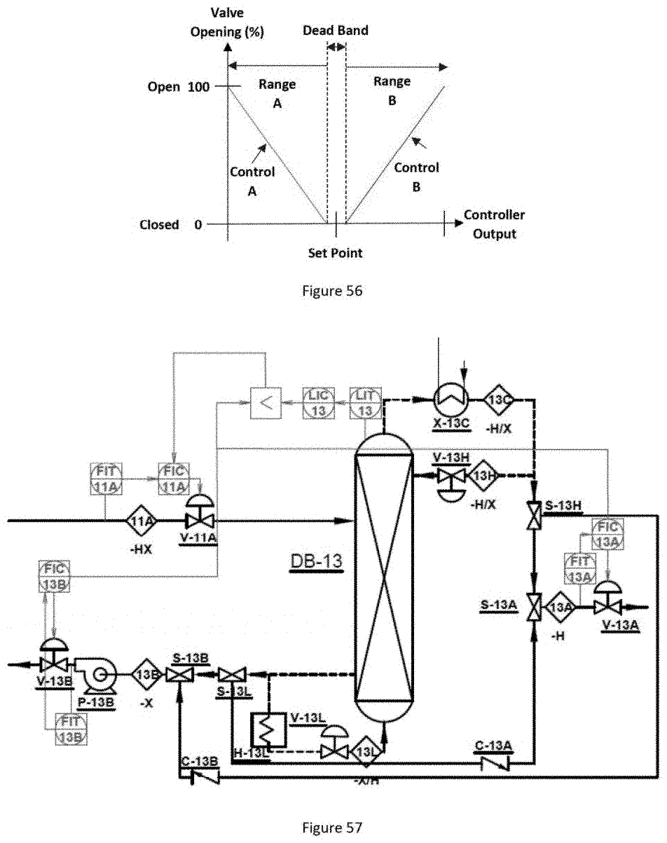

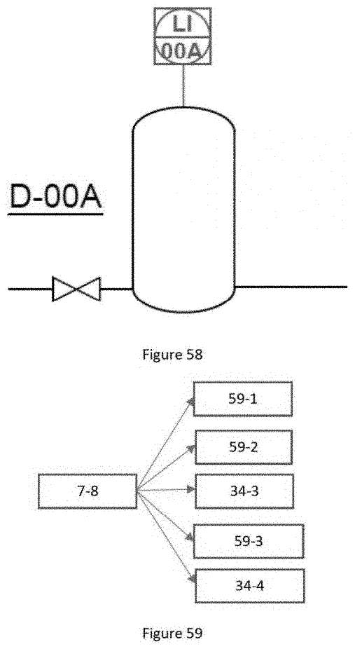

48-14 Reservoir for Disturbance
49. FIG. 49 Detailed Piping & Instrumentation Diagram (P&ID) for the Electrochemical polymer Production Process
50. FIG. 50 Legend for the P&ID
51. FIG. 51 Cascade Control Example
52. FIG. 52 Feedforward Example
S3. Figure S3 Feedback Example
54. FIG. 54 Ratio Control Example
55. FIG. 55 Split Range Control Example
56. FIG. 56 Illustration of Split Range Control interlock
57. FIG. 57 Override Select Control Example
58. FIG. 58 Indicator and Alarm Example
59. FIG. 59 Breakdown of Operating Procedure

59-1 Stacking

59-2 Deployment

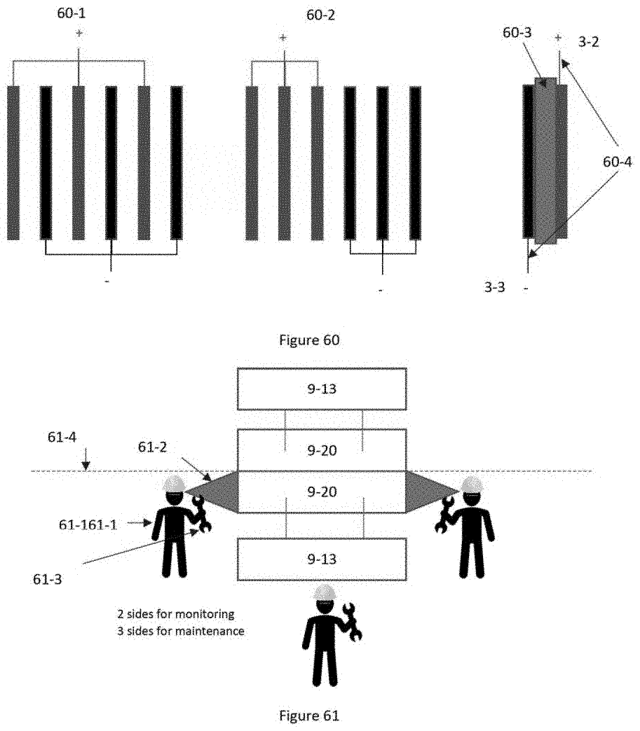

59-3 Maintenance
60. FIG. 60 Stacking of electrodes

60-1 Alternating

60-2 Aggregate

60-3 Insulator

60-4 Wire/Electrical connection
61. FIG. 61 Stacking of cells (2×1)

61-1 Personnel

61-2 Monitoring side

61-3 Maintenance side

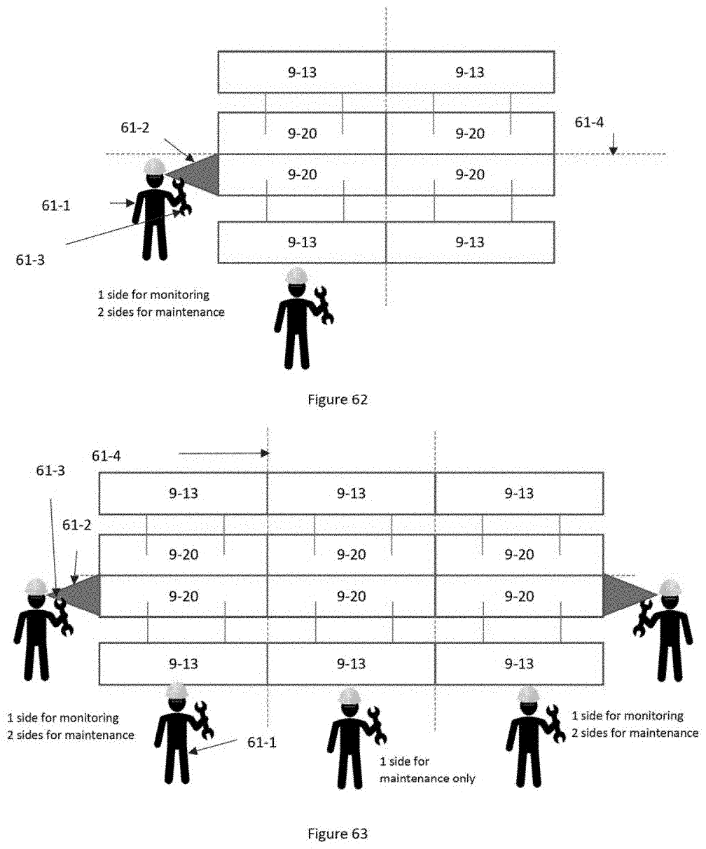

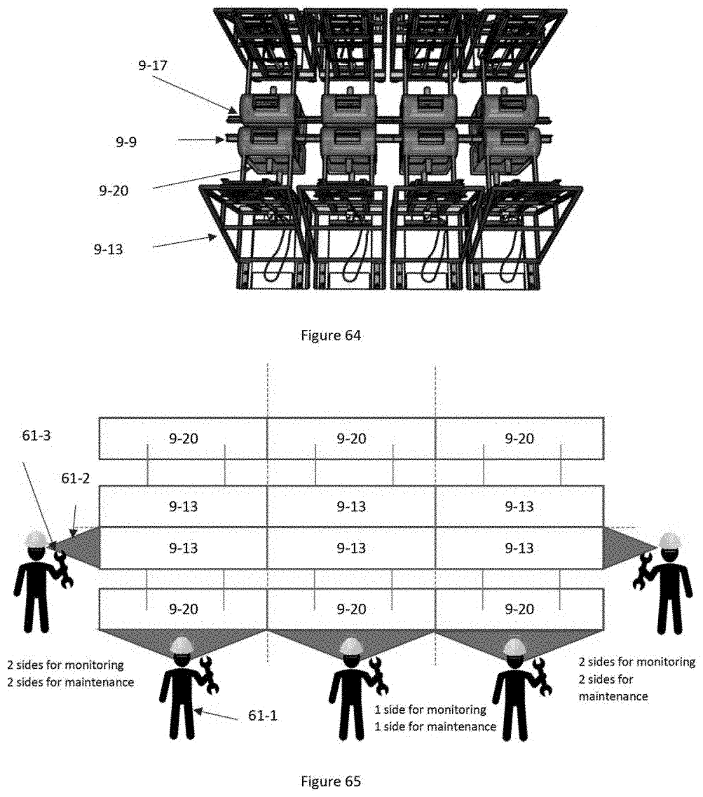

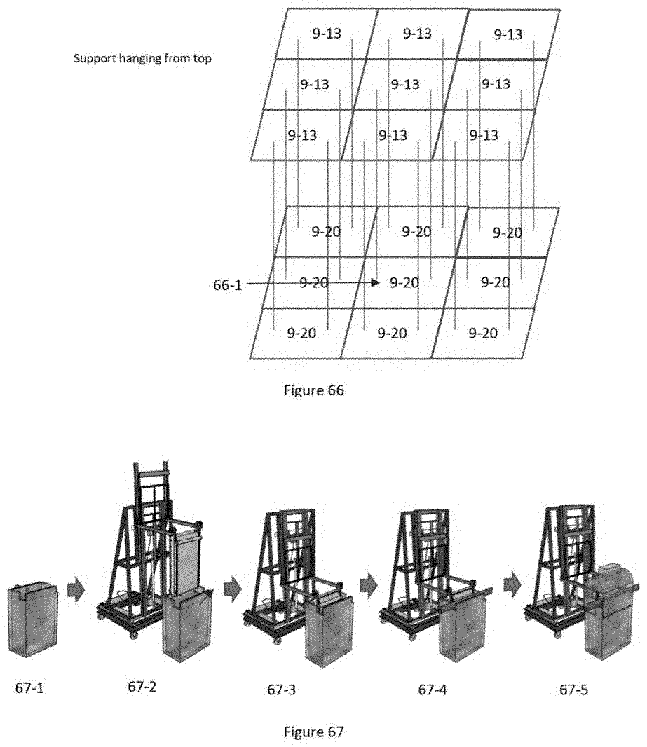

61-4 Stacking side
62. FIG. 62 Stacking of cells (2×2)
63. FIG. 63 Stacking of cells (2×n)
64. FIG. 64 Example Deployment of cells in Stacking
65. FIG. 65 Stacking of cells (2×n), outward facing
66. FIG. 66 Stacking of cells (n×n), hanging electrode

66-1 Surrounded unit
67. FIG. 67 Deployment procedure of cell

67-1 Deploy Reactor Vessel

67-2 Deploy Electrode Support

67-3 Adjust Electrode Position

67-4 Deploy Solid Transport

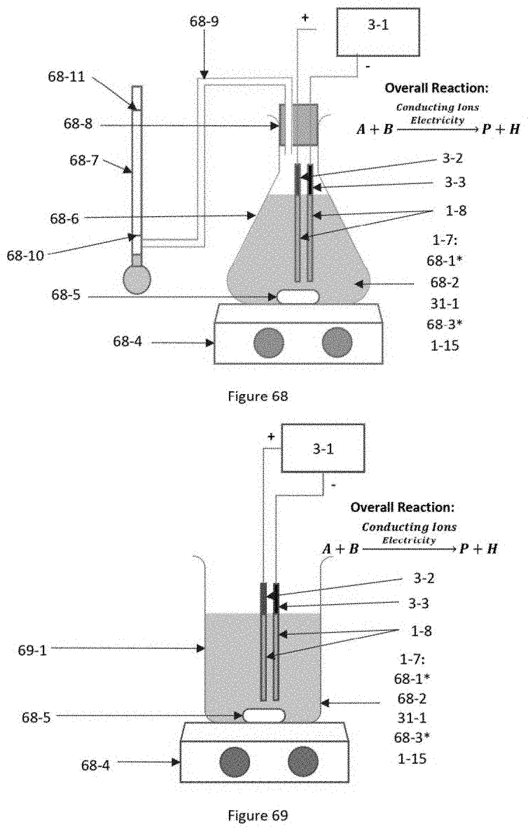

67-5 Install Gas Removal
68. FIG. 68 Experimental Setup with gas flow rate measurement

68-1 Material A

68-2 Material B

68-3 Dissolved Salt

68-4 Hot plate with stirrer

68-5 Magnetic stir bar

68-6 Conical flask

68-7 Bubble flowmeter

68-8 Stopper

68-9 Tubing

68-10 First mark

68-11 Subsequent mark
69. FIG. 69 Experimental Setup without gas flow rate measurement

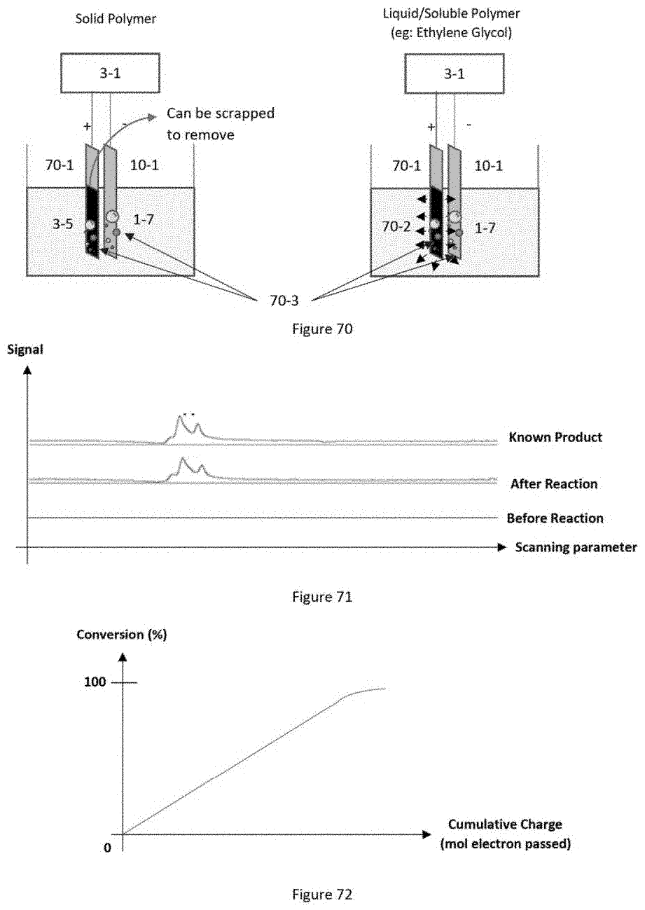

69-1 Beaker
70. FIG. 70 Sample Observation

70-1 Working Electrode

70-2 Liquid polymer

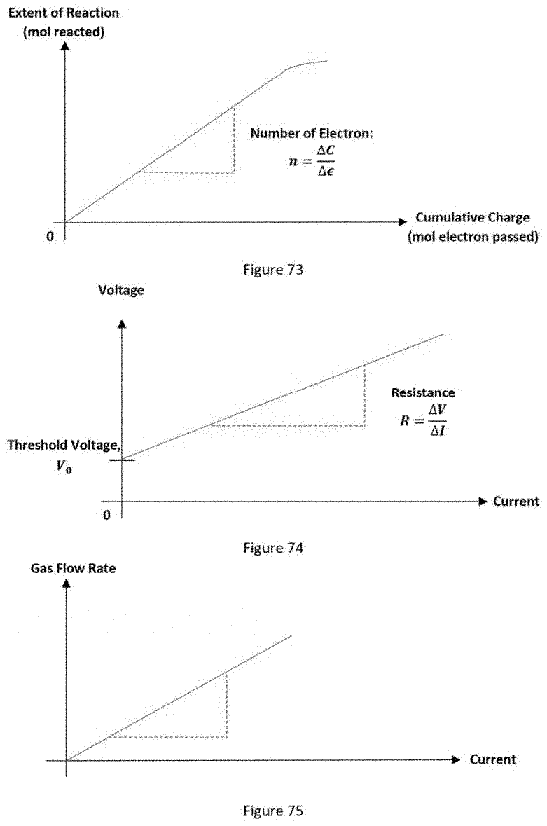

70-3 Gas bubbles
71. FIG. 71 Identification of products
72. FIG. 72 Conversion against cumulative charge
73. FIG. 73 Mole reacted against cumulative charge
74. FIG. 74 Current against Applied Voltage
75. FIG. 75 Gas Flow Rate against Current

### 3. Engineering Drawing Symbols

Symbols are also used for engineering drawings especially Process Flow Diagram (PFD) as well as Piping and Instrumentation Diagram (P&ID). First of all, the pieces of equipment are represented with codes in Table 3:

TABLE 3
List of Equipment in Process Flow Diagram

| Code | Equipment | Description |
|---|---|---|
| T-01A | Feed Tank A | Material A Storage |
| T-01B | Feed Tank B | Material B Storage |
| D-00A | Cosolvent Drum | Cosolvent Storage |
| D-00B | Additive Drum | Additive Storage |
| M-02 | Mixing Tank | Feed Mixer |
| CR-03A | Conventional Reactor | Conventional Method |
| CF-03B | Filter | Conventional Filter |
| ER-04 | Electrochemical Reactor | Retrofit Bypass |
| T-05B | Washing Fluid Tank | Recirculation Reservoir |
| WP-05A | Washer | Polymer Washing |
| SP-06 | Settler | Polymer Sedimentation |
| DP-07 | Dryer | Polymer Dryer |
| MP-08 | Molding Machine | Polymer Processing |
| PP-09 | Polymer Packing | Packing and Storage |
| SB-10A | Sorption Unit | By-Product Sorption |
| SR-10B | Sorbent Regenerator | Sorbent Recovery |
| XB-11 | Solvent Extractor | By-Product Extractor |
| D-12 | Solvent Drum | Solvent Reservoir |
| DB-13 | Distillation Column | By-Product Distillation |
| TB-14 | By-Product Tank | By-Product Storage |
| T-15 | Reservoir Tank | Electrolyte Reservoir |
| D-16 | Cooling Fluid Drum | Cooling Reservoir |

The auxiliary units, that is the smaller pieces of equipment to facilitate the 7-5 Process, are also identified with codes in Table 4:

TABLE 4
Identification of Auxiliary Units
AUXILIARY UNIT IDENTIFICATION

| LETTER | DESCRIPTION |
|---|---|
| B | BLOWER |
| C | CHECK VALVE |
| H | HEATER |
| P | PUMP |
| Q | COMPRESSOR |
| S | SWITCH VALVE |
| V | VALVE |
| X | HEAT EXCHANGER |

Because there are different types of 40-6 Valves being used in the 7-5 Process, the 40-6 Valves are distinguished with different symbols as follows in Table 5:

TABLE 5
Symbols of different types of valves
VALVE SYMBOLS

| SYMBOL | TYPE |
|---|---|
| 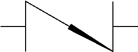 | CHECK VALVE |
| 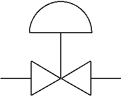 | CONTROL VALVE |
| 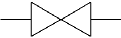 | ON/OFF VALVE |
| 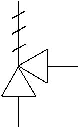 | PRESSURE RELIEF VALVE |
| 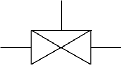 | SWITCH VALVE |

To provide better understanding of the 7-5 Process, the streams of interest are identified with their respective number and composition as the following Table 6:

TABLE 6
Stream Numbering and Composition
LINE LABELING

| EXAMPLE: | | |
|---|---|---|
| STREAM No | [symbol] | [symbol] |
| COMMODITY | [symbol] | −C |

| | |
|---|---|
| SYMBOL | COMMODITY |
| A | MATERIAL A |
| B | MATERIAL B |
| G | GAS |
| H | BY-PRODUCT |
| P | POLYMER |
| S | SALT/SOLUTE |
| T | COOLING FLUID |
| U | AIR |
| V | ABSORBENT |
| W | WASHING FLUID |
| X | SOLVENT |
| Y | CO-SOLVENT |
| Z | ADDITIVE |

There are also different lines types to represent different 40-2 Piping Types as following Table 7:

TABLE 7
Representation of 40-2 Piping Types with different lines
PIPING, CONNECTION & BOUNDARY SYMBOLS

| | |
|---|---|
| [symbol] | MAIN PROCESS LINE |
| [symbol] | SUPPORTING PROCESS LINE |
| [symbol] | INSULATED PIPELINE |
| [symbol] | MECHANICAL LINE |
| [symbol] | INSTRUMENT SIGNAL |

For P&ID, the process 7-7 Control elements are represented as per following Table 8:

TABLE 8
Process 7-7 Control element identification
INSTRUMENT IDENTIFICATION

| SYMBOL | TYPE | LOCATION |
|---|---|---|
| [symbol] | SHARED | OPERATOR |
| | DISPLAY/CONTROL | CONTROL ROOM |
| [symbol] | PROGRAMMABE | OPERATOR |
| | LOGIC CONTROL | CONTROL ROOM |
| [symbol] | OVERRIDE SELECT | OPERATOR |
| | | CONTROL ROOM |
| • | SPLIT RANGE | OPERATOR |
| | | CONTROL ROOM |

While the specific parameters of interest and the handling of the parameter are designated by codes of following Table 9:

TABLE 9
Letter codes for process 7-7 Control elements
IDENTIFICATION LETTERS

| LETTER | FIRST | SUCCEEDING |
|---|---|---|
| A | ANALYSIS | |
| C | | CONTROL |
| E | VOLTAGE | |
| F | FLOW RATE | |
| I | CURRENT | INDICATE |
| L | LEVEL | |
| P | PRESSURE | |
| R | RATIO | |
| S | SPEED | |
| T | TEMPERATURE | TRANSMIT |
| W | WEIGHT | |
| Y | | RELAY |
| Z | POSITION | |

Handling of parameters include control, indicate, transmit, and relay. Control means the parameter is assigned a set point value of interest, while the controller makes sure the actual measurement is close to the set point value within certain margin, by controlling a piece of equipment that would affect the measurement. Indicate means displaying the value of 7-5 Process parameter, either via on site meter, control panel in operator room, or both. Transmit means the parameter value of interest would be sent to a subsequent process control element indicated by direction of arrow. Finally, relay, for the purpose of the 7-5 Process of interest, means to send 7-5 Process parameter of interest to a subsequent process control element, in a similar way as Transmit, the only difference is that Relay is used for a calculated variable such as ratio between 2 flow rates, instead of the actual flow rate measurement value that represents a physical quantity.

An example to read to engineering drawing is illustrated in FIG. 8. The 8-1 Feed Tank A, for 68-1 Material A storage, is designated T-01A. 8-2 Stream 1A, consisting mainly of 68-1 Material A, exits T-01A. At 8-2 Stream 1A, there is an inline control valve designated 8-3 Control valve V-01A. There is also a 8-4 Flow rate Indicator Transmitter 01A, FIT 01A, to measure the flow rate, indicate the measurement on site while transmitting the measurement as signal to control system. 8-4 Flow rate Indicator Transmitter 01A, FIT 01A sends signal, as indicated by the direction of arrow, to 8-5 Flow Rate Indicator Controller 01A, FIC 01A, where the control set point of flow rate is indicated and controlled. 8-5 Flow Rate Indicator Controller 01A, FIC 01A subsequently controls (as indicated by the direction of arrow) 8-3 Control valve V-01A to reach the desired set point value of flow rate, that is, making sure the 8-4 Flow rate Indicator Transmitter 01A, FIT 01A is close to the set point value of 8-5 Flow Rate Indicator Controller 01A, FIC 01A within certain acceptable margin, where the margin depends on the controller software setup as well as hardware especially measurement accuracy and the control valve sensitivity. From instrument identification, both 8-4 Flow rate Indicator Transmitter 01A, FIT 01A and 8-5 Flow Rate Indicator Controller 01A, FIC 01A have shared display/control, meaning they respectively show the measurement value at both on site meter and control panel at operator control room.

Continuous 9-8 Solid Removal 7-1 Device on Electrode

The 7-1 Device comes in several variants namely, 9-1 Cylinder Electrode, 9-2 Conveyor Belt Electrode, 9-3 Rotating Disk Electrode, 9-4 Spiral/Screw Electrode, as outlined in FIG. 9. They all have some features in common including 9-5 Mechanical, 9-6 Motion Generation, 9-7 Motion Transmission, 9-8 Solid Removal, 9-9 Solid Transport, 9-13 Support, 9-20 Vessel and 9-16 Accessories especially 9-17 Gas Removal. These similar general parts and mechanism would be further detailed in the said variants.

An electrochemical reaction cell consists of 3-1 Electricity supply connected to electrodes dipped in an 1-7 Electrolyte. The 1-7 Electrolyte is usually a conducting liquid mixture containing 6-6 Conducting ions but can be conducting 30-6 Membrane soaked with liquid. The electrode consists of a conducting material where electrochemical reaction happen on the surface; where the electrode connected to positive terminal of 3-1 Electricity power supply is called 3-2 Anode which is where oxidation reactions happen, and the electrode connected to the negative terminal of 3-1 Electricity supply is called 3-3 Cathode which is where reduction reactions happen. While not essential for reaction to happen, a third electrode, called 3-4 Reference Electrode, is often included to provide a 3-4 Reference Electrode voltage measurement.

When solid products result from electrochemical reaction, it tends to stick on the surface of electrode as 3-5 Solid Deposit, which often would require 9-8 Solid Removal to maintain the performance of the electrochemical cell. 9-8 Solid Removal from electrode is of interest because it has application for electrochemical metallurgy and battery where metals of interest are formed as 3-5 Solid Deposit on the electrode and need to be recovered/isolated for further 1-4 Processing.

On the other hand, if the 3-5 Solid Deposit formed (on 3-2 Anode or 3-3 Cathode depending on reaction) is non-conductive, it blocks the electrode and the electrochemical reaction halts due to lack of conductivity. This warrants the need to remove the non-conductive 3-5 Solid Deposit rapidly as it is being produced, preferably in continuous fashion.

To address this challenge, the novel 7-1 Device setup is designed to continuously remove the 3-5 Solid Deposit by relative motion between electrode and a 4-2 Removal Device, for example, a blade to remove the 3-5 Solid Deposit from the electrode. The 9-8 Solid Removal can happen in the top (gas/air) phase or bottom (liquid/1-7 Electrolyte) phase. In the gas phase, there is substantially lower friction, and no need to filter the 3-5 Solid Deposit away from liquid/1-7 Electrolyte. On the other hand, the relative motion between electrode and the 4-2 Removal Device in the liquid/1-7 Electrolyte phase also serves to stir the 1-7 Electrolyte for mixing, removing the need for stirrer in the 1-7 Electrolyte/liquid phase. Note also that the 1-7 Electrolyte tank does not have to be rectangular in shape, for instance it can be cylindrical especially when the electrodes are 9-1 Cylinder Electrode, to save 35-1 Electrochemical Reactor/reagent volume (and hence cost).

The 7-1 Device can be multiple repeating units, in 3-2 Anode-3-2 Anode-3-3 Cathode-3-3 Cathode (cluster stack), or in 3-2 Anode-3-3 Cathode-3-2 Anode-3-3 Cathode (alternating stack) order, to scale up the production output.

While the arrangement can come in many forms, the major arrangements of interest are: 9-1 Cylinder Electrode, 9-2 Conveyor Belt Electrode, and 9-3 Rotating Disk Electrode.

The invention offers the following advantages:
Shallower 9-20 Vessel because no longer need to allow 3-5 Solid Deposit to settle, resulting in lower cost from lower 35-1 Electrochemical Reactor size and reagent volume
Faster and cheaper 1-3 Solid Separation: Less friction to remove the 3-5 Solid Deposit in air/gas phase than in the viscous 1-7 Electrolyte phase, while removing the need for 3-5 Solid Deposit to be filtered from liquid phase; or the facilitation of mixing in the liquid/1-7 Electrolyte phase and eliminating the need for a stirrer.
Continuous process removing the need to shut down the 35-1 Electrochemical Reactor for 3-5 Solid Deposit separation
Simple design without much of the complex 19-2 Gears setup and 9-5 Mechanical arrangements which would be costly/difficult to manufacture

9-1 Cylinder Electrode

9-1 Cylinder Electrode is the simplest variant of the design as shown in FIG. 10, which consists of a conductive cylinder material as the electrode. The 9-1 Cylinder Electrode is positioned horizontally and partially dipped into the 1-7 Electrolyte.

The electrochemical reaction would happen in the liquid/1-7 Electrolyte phase when 3-1 Electricity is applied, and the rotation of the 9-1 Cylinder Electrode would move the 3-5 Solid Deposit up into the gas/air phase where a 4-2 Removal Device is used to remove the 3-5 Solid Deposit from the surface, for example, by friction brought about by the relative movement of the 9-1 Cylinder Electrode surface and the 4-2 Removal Device.

In some embodiments, the 7-1 Device comprises a rigid material, for example, a plate made of the rigid material that can be slanted down to outside of the electrochemical cell. This allows the 3-5 Solid Deposit to gradually slide down the plate to outside of the cell for downstream 1-4 Processing. As an alternative, the 4-2 Removal Device can also be merged into single unit with 9-9 Solid Transport as a 9-11 Conveyor belt with rigid sharp edges or an abrasive surface, positioned against and in contact with the surface of electrode, where the 3-5 Solid Deposit removed would be moved outside of the electrochemical cell in automated, continuous fashion. For example, the rigid edges may be perpendicular to the tangential surface of the electrode.

Another advantage is that the 3-5 Solid Deposit removed is largely dry without much liquid (though some liquid may stick on it but not much and can be washed easily), which accelerates the 1-3 Solid Separation time and removes the need to filter the 3-5 Solid Deposit from liquid phase.

There may or may not be residual 3-5 Solid Deposit dropping into the tank and would be filtered out if needed. However, the 9-8 Solid Removal in the air/gas phase already removes the majority of the 3-5 Solid Deposit and thus greatly reduces the throughput needed for backup filtering. As an alternative, filter is often not needed and the 3-5 Solid Deposit is only recovered during 59-3 Maintenance.

9-2 Conveyor Belt Electrode

9-2 Conveyor Belt Electrode is another variant as shown in FIG. 12, well-suited for industrial scale adaptation. The working principle of 9-8 Solid Removal is a cyclic movement very similar to the 9-1 Cylinder Electrode, but it instead applies 9-11 Conveyor belt setup with 12-1 Pulley, which offers some more features:
1) Bigger area in the liquid phase, dipping well into the 1-7 Electrolyte to electrochemical reaction output, and allows a more compact reagent tank. For example, the lower 12-1 Pulley and a large portion of the 9-2 Conveyor Belt Electrode can be submerged in the liquid/1-7 Electrolyte phase.
2) Bigger area in the gas/air phase, allowing the 7-1 Device to be more reliable, with less worry of the liquid/1-7 Electrolyte leakage to the 19-2 Gears and shaft for 9-2 Conveyor Belt Electrode movement, and the electrical wiring setup of electrode.
3) Greater height in the gas/liquid phase allocates more space for more reliable design of the 7-1 Device for removing the 3-5 Solid Deposits, such as a 9-11 Conveyor belt for delivery of scrubbed 3-5 Solid Deposit

It can also be driven by 12-1 Pulley which is merely a very narrow version of 9-11 Conveyor belt.

9-3 Rotating Disk Electrode

9-3 Rotating Disk Electrode is another variant of the 7-1 Device as shown in FIG. 14, where a conducting rigid disk, partially immersed in the 1-7 Electrolyte/liquid phase, serves as the electrode. The 9-3 Rotating Disk Electrode rotates by shaft action with a 4-2 Removal Device placed against and in contact with the surface to remove 3-5 Solid Deposit on electrode surface.

It offers the following features:
1) Large surface area
2) Easy to construct and manufacture
3) Compact design

Again, note that the 9-20 Vessel can be cylindrical to reduce the 35-1 Electrochemical Reactor space. The 9-3 Rotating Disk Electrode can also be made spiral instead of parallel disk as alternative that allows the products to be screwed to outside of 35-1 Electrochemical Reactor continuously.

Note that in any cases, even though it is a good idea to have the same shape of 10-1 Counter Electrode with electrode for easy manufacturing and setup. For the 7-1 Device to work the conductivity just has to be established, and the 10-1 Counter Electrode does not have to be the same shape as the electrode.

9-4 Spiral/Screw Electrode

9-4 Spiral/Screw Electrode is another variant of the 7-1 Device as shown in FIG. 16, where a conducting rigid screw, partially immersed in the 1-7 Electrolyte/liquid phase, serves as the electrode. The screw rotates by shaft action with a 4-2 Removal Device placed against and in contact with the surface to remove 3-5 Solid Deposit on electrode surface.

It offers the following features:
1) Large surface area
2) Compact design
3) Efficient 1-7 Electrolyte movement and 9-8 Solid Removal

Again, note that the 9-20 Vessel can be cylindrical to reduce the 35-1 Electrochemical Reactor space. The 4-2 Removal Device can also be a screw or spiral-shaped, to fit the surface of the 9-4 Spiral/Screw Electrode, to maximize the contact surface for more efficient 9-8 Solid Removal.

Note that in any cases, even though it is a good idea to have the same shape of 10-1 Counter Electrode with electrode for easy manufacturing and setup. For the 7-1 Device to work the conductivity just has to be established, and the 10-1 Counter Electrode does not have to be the same shape as the electrode.

General Mechanism

General and 9-2 Conveyor Belt Electrode

The general mechanism is best explained first using the 9-2 Conveyor Belt Electrode as in FIG. 13 and FIG. 18.

9-5 Mechanical comprises 9-6 Motion Generation and 9-7 Motion Transmission. 9-6 Motion Generation involves the transformation of energy source, usually but not limited to 19-1 Motor/engine such as chemical energy for engine or electrical energy for motor, into mechanical energy for motion. In some embodiments, 9-6 Motion Generation also involves connection to 9-7 Motion Transmission by connection of 19-2 Gears and 19-3 Shaft to 19-1 Motor/engine.

9-7 Motion Transmission involves distributing, or directing, the 9-5 Mechanical motion to the designated place, for this case to generate electrode motion. Sometimes, the distribution is separated to 2 or more stages: primary and secondary. As illustrated by FIG. 19, Primary 9-7 Motion Transmission functions to transmit the 9-5 Mechanical movement from 9-6 Motion Generation source, usually an 19-1 Motor/engine, to an interim 9-5 Mechanical part, including but not limited to 19-3 Shaft, 19-2 Gears, 12-1 Pulley, or 20-1 Chain drive. In some implementations, 20-1 Chain drive is used for reliability of device because it has minimal susceptibility to slipping for maximal scrubbing strength.

As illustrated by FIG. 20, secondary 9-7 Motion Transmission functions to transmit 9-5 Mechanical motion, from the said interim 9-5 Mechanical part, to the electrode. It is usually performed by means including but not limited to 19-3 Shaft, 19-2 Gears, 12-1 Pulley, or 20-1 Chain drive.

For uniform 9-5 Mechanical energy distribution, multiple primary and secondary distribution can be employed in parallel. For instance, the 9-2 Conveyor Belt Electrode can come in double primary distribution, on top and bottom. On the other hand, the 9-2 Conveyor Belt Electrode could have between double to quadruple secondary distribution: double on top and bottom (9-2 Conveyor Belt Electrode), and for case of double 20-1 Chain drive, quadruple: top and bottom (9-2 Conveyor Belt Electrode), left and right (20-1 Chain drive).

As illustrated by FIG. 21, 9-8 Solid Removal comprises removing the 3-5 Solid Deposit from the electrode, and 9-9 Solid Transport of the removed 3-5 Solid Deposit away from the 35-1 Electrochemical Reactor. Electrode stripping could be performed in numerous ways, including but not limited to: 9-5 Mechanical abrasion (by means of 4-2 Removal Device), ultrasound, or fluid jets. There is also 21-3 Blade adjustment device to adjust the blade angle, usually but not limited to a spring system. In some implementation, especially the 9-2 Conveyor Belt Electrode and 9-1 Cylinder Electrode, extra 4-2 Removal Device can be deployed at the inner side of the electrode, to increase product output by increasing the surface area. This however comes at the price of more complexity and reduced reliability of operation thus should be assessed on case-by-case basis. In some implementations, 9-10 Multiple Blades are stacked as illustrated in FIG. 25 to increase scrubbing power and 9-8 Solid Removal efficiency.

9-9 Solid Transport could be performed in several ways, including but not limited to: 9-11 Conveyor belt or fluid motion in 9-12 Channel. For 9-11 Conveyor belt, 3-5 Solid Deposit scrubbed from electrode are continuously carried away from the 35-1 Electrochemical Reactor space via 9-11 Conveyor belt motion. For fluid motion in 9-12 Channel, 3-5 Solid Deposit scrubbed from electrode are continuously carried away by fluid flowing in an open 9-12 Channel. The fluid is usually but not limited to a liquid, and commonly water is chosen for the low cost. The fluid itself, especially liquid, would also act as 21-2 Washing fluid to ease subsequent washing stage. As shown in FIG. 28, the open 9-12 Channel may also come with a protruded 21-1 Flap to prevent 3-5 Solid Deposit from spilling out of the 9-12 Channel.

There are some variants to the default design of the 9-12 Channel. The open 9-12 Channel, while often made of 7-6 Piping cut in vertical cross section to form 28-1 Arc (Default), can also be made up into 28-2 Rectangular 9-12 Channel shapes, or 28-3 Triangular 9-12 Channel shapes, or even arbitrary shapes as long as it forms a ridge for fluid to flow. The 21-1 Flap by default is 28-4 Perpendicular Flap (Default) for ease of fabrication, but can also be slanted as 28-5 Acute Flap or 28-6 Obtuse Flapper to match the trajectory of spillage.

There is also the basic 9-20 Vessel at the part at the bottom, as shown in FIG. 22. There is 10-1 Counter Electrode attached to the reaction 9-20 Vessel. In some implementations, the 10-1 Counter Electrode Is joined to the 9-20 Vessel for ease of fabrication. The 9-20 Vessel holding 1-7 Electrolyte liquid has 22-1 Electrolyte inlet and 22-2 Electrolyte outlet. In some implementations, to reduce energy cost from pumping, the 22-1 Electrolyte inlet and 22-2 Electrolyte outlet are arranged according to gravity, such that 1-7 Electrolyte enters from the top and exits at the bottom.

FIG. 23 illustrates the 9-13 Support for 9-2 Conveyor Belt Electrode which is a 9-14 Movable variant. The 9-13 Support consists of a 23-4 Frame Body to hold the electrode system in place. The bottom of the 23-4 Frame Body is usually equipped with 23-3 Wheels or rails for convenient disassembly from the tank for installation and 59-3 Maintenance. The 23-2 Arm of the 23-4 Frame Body has features of adjustable heights, usually but not limited to 23-1 Hydraulic jack. The adjustable height provides means to retract the electrode system from the 9-20 Vessel, without having to drain 1-7 Electrolyte from the 9-20 Vessel. This provides convenient and fast 59-3 Maintenance process, shall the electrode requires service and 59-3 Maintenance, since it is slow and tedious to empty the 9-20 Vessel to be opened, with potential implications to other unit operations.

On the 23-2 Arm is attached a 19-1 Motor/engine to provide 9-5 Mechanical energy to drive the 9-6 Motion Generation. Other than electrical motor, it can also be an engine (combustion) or any other means to provide 9-5 Mechanical movement.

The 7-1 Device also comprises of 9-16 Accessories especially 9-17 Gas Removal as illustrated in FIG. 24. 9-17 Gas Removal is implemented for cases when undesirable gas, usually flammable or toxic, evolved in sufficient amount. An example is the water splitting reaction from electrolysis, which produces flammable hydrogen gas. In some cases, toxic 6-9 Ammonia gas as 1-15 By-product in liquid form, may vaporize into fumes. 9-17 Gas Removal consists of closed or open variants. Closed 9-17 Gas Removal is simply to make the 7-1 Device space gas-tight and direct the gas into designated stream, such as condenser or burner. Open 9-17 Gas Removal is a setup similar to fumehood, that uses chimney effect to suck gases. Open 9-17 Gas Removal is used when the gas doesn't need to be isolated while closed 9-17 Gas Removal is used when the gas needs to be isolated. In some implementation, 9-17 Gas Removal could be omitted if the gas evolution is minimal.

The other 9-16 Accessories include 9-18 Conducting Brush and 9-19 Waxing. It has also been a challenge to maintain electrical contact when the electrode is constantly in motion. However, electrical contact is established by a conductive solid in contact with the electrode. In some implementation, it Is through the 4-2 Removal Device of 9-8 Solid Removal. In some implementation, additional electrical contact other than the 4-2 Removal Device are provided as illustrated in FIG. 26, such as a 9-18 Conducting Brush, usually but not necessarily be made of carbon in graphite form, is attached via 26-1 Accessory support. In some implementation, the electrode is continuously coated with a thin layer of slippery material such as 9-19 Waxing attached via similar 26-1 Accessory support, as illustrated in FIG. 27, to ease electrode stripping with a 27-1 Wax Layer. In some implementations, the 9-19 Waxing is done using a piece of wax solid in friction with the electrode surface. In some other implementations, the 9-19 Waxing is done using a more sophisticated 9-19 Waxing dispenser.

9-1 Cylinder Electrode

For 9-1 Cylinder Electrode variant, the recommended 7-1 Device setup is shown in FIG. 11. It has a cylindrical 9-20 Vessel, where the 1-7 Electrolyte is held. The 1-7 Electrolyte enters from 22-1 Electrolyte inlet and then exits from 22-2 Electrolyte outlet. To reduce resistance, the 10-1 Counter Electrode is a conductive cylindrical surface attached to the inner wall of the 9-20 Vessel. For convenience of operation, the sides of the 9-20 Vessel, while serving as 9-15 Built-in variant of 9-13 Support and frame, can be made transparent to allow 2 of 22-3 Side Windows to monitor any change in the 9-20 Vessel.

The 9-5 Mechanical comprises 9-6 Motion Generation and 9-7 Motion Transmission. 9-6 Motion Generation for this case involved 19-1 Motor/engine to drive 2 of 19-2 Gears and 2 of 19-3 Shaft systems to drive the 9-1 Cylinder Electrode,

9-8 Solid Removal comprises removing the 3-5 Solid Deposit from the 9-1 Cylinder Electrode, using the 4-2 Removal Device. There is a 21-3 Blade adjustment to adjust the angle of the blade to control the scrubbing action.

The 9-9 Solid Transport involve an open 9-12 Channel containing a stream of 21-2 Washing fluid flowing between the 2 ends of the 9-12 Channel: 21-4 Washing fluid inlet and 21-5 Washing fluid outlet. There is a 21-1 Flap to prevent spills of the 3-5 Solid Deposit as it is scrubbed off the electrode.

9-17 Gas Removal involves a 24-2 Cap with 24-1 Ventilation outlet connected to fumehood. There are sleeves left to suck the ambient air into, namely the 24-5 Sleeves (washing piping) and 24-7 Sleeves (electrode frames).

9-3 Rotating Disk Electrode

For 9-3 Rotating Disk Electrode variant, the recommended 7-1 Device setup is shown in FIG. 15. It has a cylindrical 9-20 Vessel similar to 9-1 Cylinder Electrode variant, where the 1-7 Electrolyte is held. The 1-7 Electrolyte enters from 22-1 Electrolyte inlet and then exits from 22-2 Electrolyte outlet. To reduce resistance, the 10-1 Counter Electrode is a conductive disk surface sandwiched to the other side of the 9-3 Rotating Disk Electrode, separated by a piece of 60-3 insulator. In some implementation, the 10-1 Counter Electrode can also be made of conductive material attached to the inner wall of the 9-20 Vessel for ease of manufacturing, albeit with some increased resistance and hence lower energy efficiency. For convenience of operation, the sides of the 9-20 Vessel, while serving as 9-15 Built-in variant of 9-13 Support and frame, can be made transparent to allow 2 of 22-3 Side Windows to monitor any change in the 9-20 Vessel.

The 9-5 Mechanical comprises 9-6 Motion Generation and 9-7 Motion Transmission. 9-6 Motion Generation for this case involved 19-1 Motor/engine to drive 2 of 19-2 Gears and 2 of 19-3 Shaft systems to drive the 9-3 Rotating Disk Electrode. 9-8 Solid Removal comprises removing the 3-5 Solid Deposit from the 9-3 Rotating Disk Electrode. There is a 21-3 Blade adjustment to adjust the angle of the blade to control the scrubbing action.

The 9-9 Solid Transport involve an open 9-12 Channel containing a stream of 21-2 Washing fluid flowing between the 2 ends of the 9-12 Channel: 21-4 Washing fluid inlet and 21-5 Washing fluid outlet. There is a 21-1 Flap to prevent spills of the 3-5 Solid Deposit as it is scrubbed off the electrode. 9-17 Gas Removal involves a 24-2 Cap with 24-1 Ventilation outlet connected to fumehood. There are sleeves left to suck the ambient air into, namely the 24-5 Sleeves (washing piping) and 24-7 Sleeves (electrode frames).

9-4 Spiral/Screw Electrode

For spiral/screw electrode variant, the recommended 7-1 Device setup is shown in FIG. 17. It has a partial cylindrical 9-20 Vessel, where the 1-7 Electrolyte is held. The 1-7 Electrolyte enters from 22-1 Electrolyte inlet and then exits from 22-2 Electrolyte outlet. To reduce resistance, the 10-1 Counter Electrode is a conductive disk surface sandwiched to the other side of the 9-4 Spiral/Screw Electrode, separated by a piece of 60-3 Insulator. In some implementation, the 10-1 Counter Electrode can also be made of conductive material attached to the inner wall of the 9-20 Vessel for ease of manufacturing, albeit with some increased resistance and hence lower energy efficiency. For convenience of operation, the sides of the 9-20 Vessel, while serving as 9-15 Built-in variant of 9-13 Support and frame, can be made transparent to allow 2 of 22-3 Side Windows to monitor any change in the 9-20 Vessel.

The 9-5 Mechanical comprises 9-6 Motion Generation and 9-7 Motion Transmission. 9-6 Motion Generation for this case involved 19-1 Motor/engine to drive 2 of 19-2 Gears and 2 of 19-3 Shaft systems to drive the 9-4 Spiral/Screw Electrode. 9-8 Solid Removal comprises removing the 3-S Solid Deposit from the 9-4 Spiral/Screw Electrode, using 4-2 Removal Device. In the figure it was a screw rotating together, either same or opposite rotation direction, in contact with the 9-4 Spiral/Screw Electrode, to scrub off

the 3-5 Solid Deposit by abrasion. In some implementations, it can be stationary blades fixated to the 9-20 Vessel, or 9-13 Support.

There is a 21-3 Blade adjustment to adjust the angle of the blade to control the scrubbing action.

The 9-9 Solid Transport involve an open 9-12 Channel containing a stream of 21-2 Washing fluid flowing between the 2 ends of the 9-12 Channel: 21-4 Washing fluid inlet and 21-5 Washing fluid outlet. There is a 21-1 Flap to prevent spills of the 3-5 Solid Deposit as it is scrubbed off the electrode.

9-17 Gas Removal involves a 24-2 Cap with 24-1 Ventilation outlet connected to fumehood. There are sleeves left to suck the ambient air into, namely the 24-5 Sleeves (washing piping) and 24-7 Sleeves (electrode frames).

Electrochemical Production of 7-3 Addition Polymer

As the first part of 7-2 Chemistry, 7-3 Addition Polymer is a class of 1-8 Polymer formed by addition reaction, in which no 1-15 By-product is produced. Some exemplary 7-3 Addition Polymer comprises carbon backbone without heteroatoms, such as:
Polyvinyl: Polyethylene (PE), Polypropylene (PP), Polystyrene (PS), Polyvinyl Chloride (PVC), etc
Polyalkanes in general, such as polybutadiene (rubber)

As outlined in FIG. 29, the electrochemical production of 7-3 Addition Polymer can be classified into 29-1 Homopolymer and 29-2 Copolymer. In some embodiments, 29-1 Homopolymer results from elimination-addition polymerization from starting 29-3 Alcohol group as illustrated in Equation 2, or other 29-4 Variants such as sulfides and amines.

### Elimination-Addition Polymerization

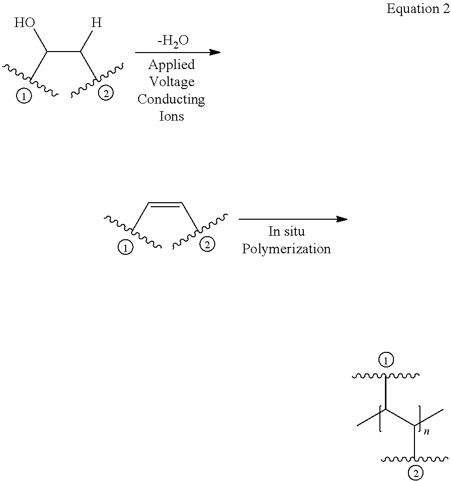

Note that the polymerization can also be initiated from the second step, if unsaturated compounds, which includes unsaturated hydrocarbons such as alkenes or alkynes are used as the starting materials.

29-2 Copolymer, on the other hand, can be produced when different starting groups are mixed together. It can be different 29-3 Alcohol groups, or even between functional groups such as alcohol and sulfides, when these different species are present in the same system of 1-7 Electrolyte during the electrochemical reaction.

As outlined by FIG. 30, the 6-6 Conducting ions can come from either a 30-6 Membrane or 30-1 Dissolved ions. The 30-6 Membranes include but not limited to 1-7 Electrolyte membrane for electrolyzer and fuel cells, such as the proto exchange 30-6 Membrane (commonly used for acidic and neutral aqueous system), or polymer ion exchange 30-6 Membranes (commonly used for alkaline aqueous system). An example of such 30-6 Membrane is the Nafion membrane, a class of proton exchange 30-6 Membrane commonly used for hydrogen fuel cell. The 30-1 Dissolved ions can be come from 30-2 Metallic ions such as Lithium ions of lithium chloride, LiCLor 30-3 Non-metallic ions. The 30-3 Non-metallic ions are usually categorized into 30-4 Organic and 30-5 Inorganic variants. The 30-4 Organic variants include surfactants such as stearate ions of sodium stearate (commonly used for soap) or some deep eutectic salt or Ionic liquid, such as choline chloride as common component of eutectic 31-4 Solvent, or 1-butyl-3-methylimidazolium hexafluorophosphate ([BMIM]PF6 as common ionic liquid.

Depending on the situation, 31-1 Cosolvent may be needed, with variants outlined in FIG. 31. 31-1 Cosolvent can include 30-4 Organic and 30-5 Inorganic variants. The 30-4 Organic variants are either 31-2 Designer Molecule, especially 31-3 Crown ether used to dissolve metallic ions into organic phase (such as 15-Crown-5 to dissolve sodium ions in organic phase), or just common 31-4 Solvent such as acetone that has miscibility or solubility in both organic and polar phase. 30-5 Inorganic variants include 6-9 Ammonia and water as common solvent that is also sometimes produced as 1-15 By-product in the reaction.

The 32-1 Additives consists of 1-13 Catalyst outlined in FIG. 32, classified into 32-2 Redox and 32-3 Others. It can include 32-2 Redox catalyst especially electron shuttle, that works by facilitating electron transfer of either oxidizing and reducing reaction steps, such as triarylamines and pyridines. 32-3 Others include catalyst that works by interfering with non-redox reaction steps of the reaction, include coordination 1-13 Catalyst such as a mixture of titanium tetrachloride (TiCl₄) and triethylaluminium (Al(C₂H₅)₃) that facilitating propagation step by providing a place for monomer molecule to assemble via coordination bond with transition metal. While the 32-1 Additives is usually a homogenous catalyst in fluid form, it can also consist of solid catalysts suspension in some implementations.

29-3 Alcohol Group

The major variant is alcohol as starting material, which results in a case of dehydration-polymerization where water is formed as 1-15 By-product as shown by Equation 3.

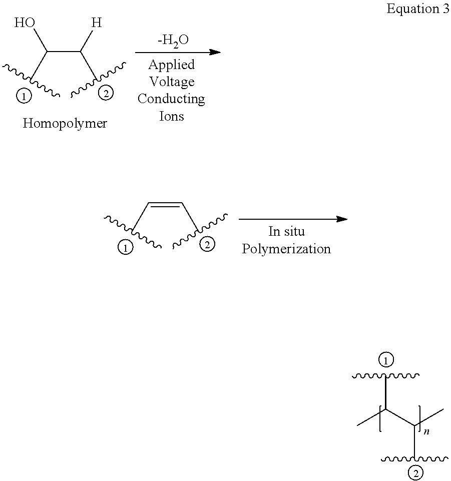

The examples include the following common 1-8 Polymer illustrated in Table 10:

TABLE 10
Common examples and starting materials

| 1 | 2 | Products |
|---|---|---|
| H | H | Polyethylene (PE) |
| H | CH3 | Polypropylene (PP) |
| H | Phenyl Group | Polystyrene (PS) |
| H | OH | Polyvinyl Alcohol (PVOH) |
| H | Cl | Polymyl Chloride (PVC) |
| H | Nitrile | Polyacrylonitrile (PAN) |
| H | COOH | Polyacrsdate (PAK) |
| H | Vinyl | Polybutadiene (synthetic rubber |

29-4 Variants: Sulfides

Similar to 29-3 Alcohol group reaction, sulfides can also react electrochemically to form 7-3 Addition Polymer, but with the formation of hydrogen sulfide as 1-15 By-product as shown by Equation 4 and Equation 5:

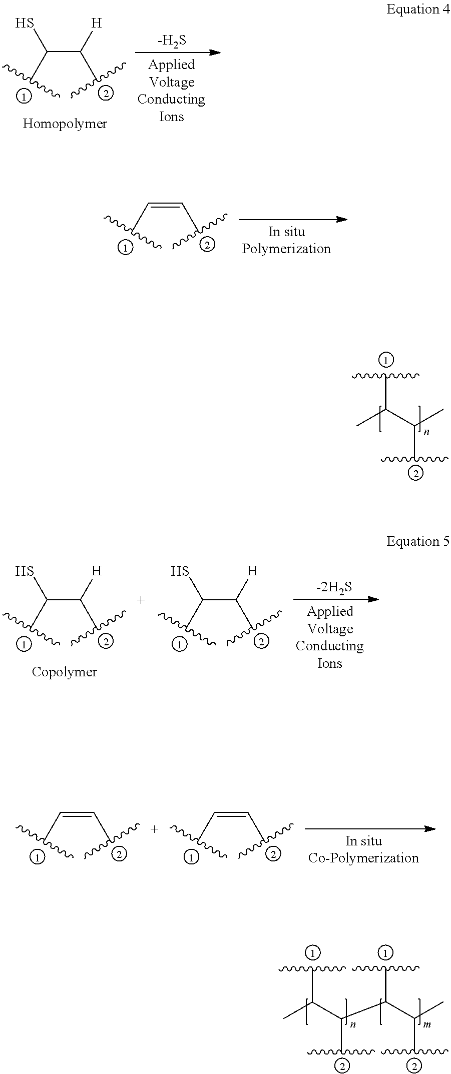

29-4 Variants: Amines

Similar to alcohol and sulfide reaction, amines can also react electrochemically to form 7-3 Addition Polymer, with the formation of amines as 1-15 By-product as shown in Equation 6 and Equation 7:

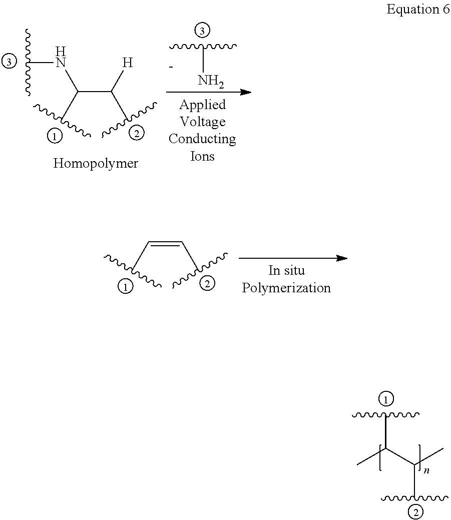

Note that if the substitute group 3 above is a hydrogen atom, 6-9 Ammonia instead of amine would be formed.

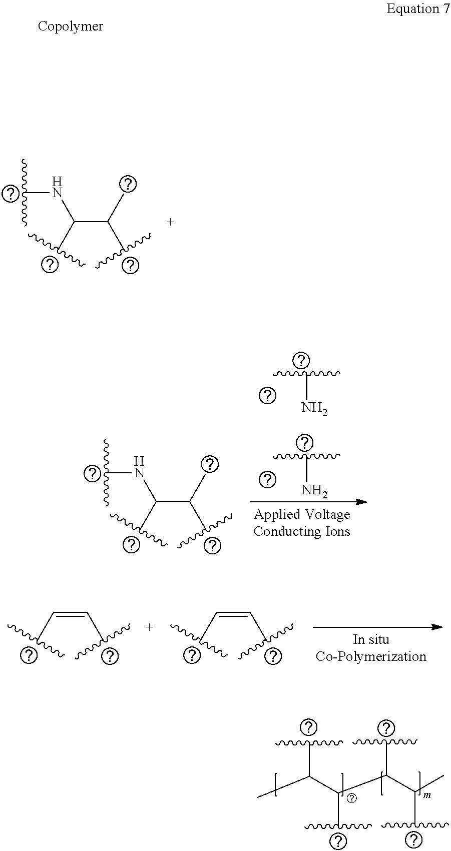

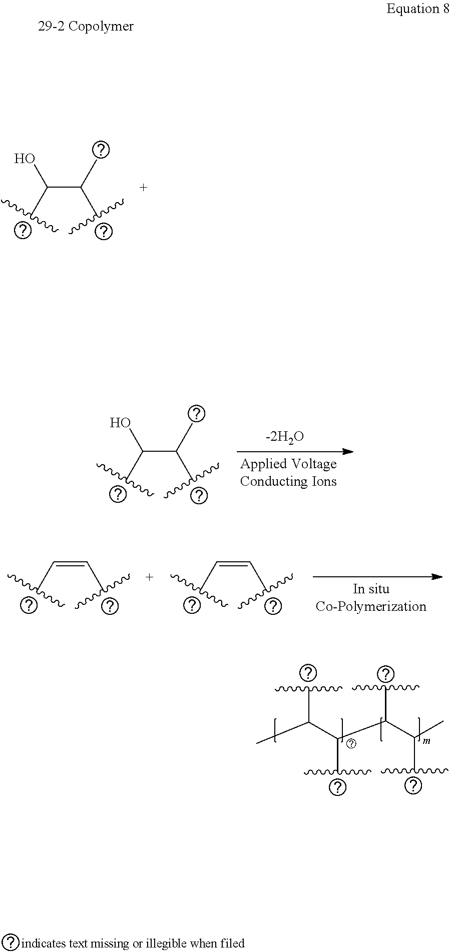

As mentioned previously, 29-2 Copolymer can be formed if different types of starting alcohols are present in the 1-7 Electrolyte system as shown in Equation 8. Different types of starting group, such as alcohol with sulfide or amine, would also result in similar 29-2 Copolymer end-product.

Some examples of 29-2 Copolymer are included in Table 11:

TABLE 11
Common copolymer examples and starting materials

| 1 | 2 | 3 | 4 | Products |
|---|---|---|---|---|
| H | H | H | Cl | vinyl chloride-ethylene plastic (VCE) |
| H | H | H | COOH | Ethylene-acrylic acid plastic (EAA) |
| H | Cl | H | OC═OCH3 | Polyvinyl chloride acetate (PVCA/VCVAC) |
| H | H | H | OH | Ethylene-yinyl alcohol plastic (EVOH) |

Note also that the 29-2 Copolymer can form if there are 3 or more types of starting chemicals, for instance the common Acrylonitrile butadiene styrene (ABS) resin, a type of valuable and widely used engineering plastic as per Table 12:

TABLE 12
Sample starting material for
complex 29-2 Copolymer of ABS resin

| 1 | 2 | 3 | 4 | 5 | 6 | Products |
|---|---|---|---|---|---|---|
| H | Phenyl | H | H | H | Nitrile | Acrylonitrile butatilene |
| | | | | | | styrene (ABS) |

Note that the 29-2 Copolymer order of each unit can be arbitrary.

The following Table 13 is the more specific reactions of addition polymerization:

TABLE 13
Specific reactions of addition polymerization

| Substituents | | 1-6 Reactants | |
|---|---|---|---|
| of branch | 1-8 Polymer P | 68-1 Material A | 68-2 Material B |
| Alkyl | 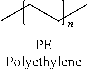 | 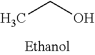 | — |
| | | 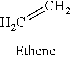 | |
| | 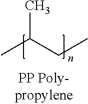 | 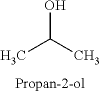 | — |
| | | 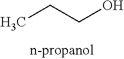 | |
| | | 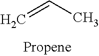 | |
| | 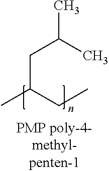 | 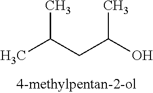 | — |
| | | 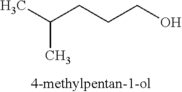 | |
| | | 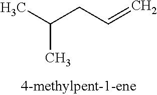 | |
| | 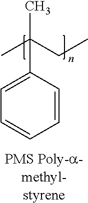 | 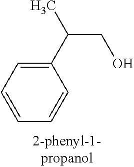 | — |
| | | 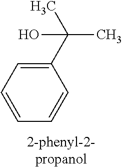 | |
| | | 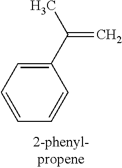 | |
| | 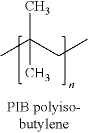 | 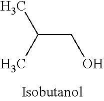 | — |
| | | 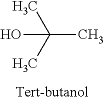 | |
| | | 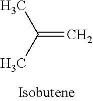 | |
| Thermo- plastic elastomers (TPE) | 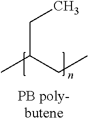 | 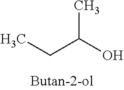 | — |
| | | 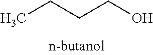 | |
| | | 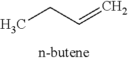 | |
| | 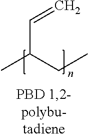 | 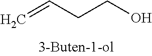 | — |
| | | 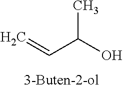 | |
| | | 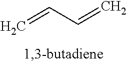 | |
| Aryl | 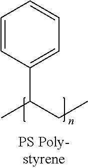 | 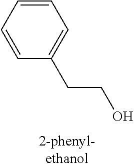 | — |
| | | 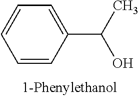 | |
| | | 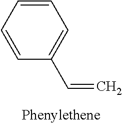 | |
| | 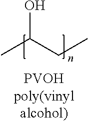 | 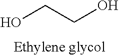 | — |
| | | 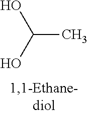 | |
| | | 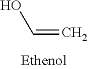 | |
| | 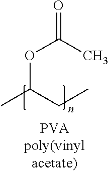 | 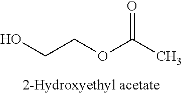 | — |
| | | 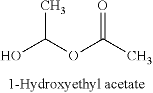 | |
| | | 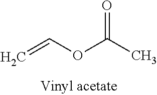 | |
| Nitrogen atom | 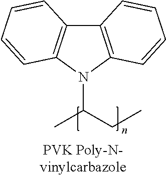 | 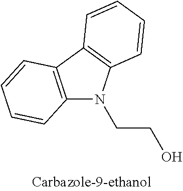 [SMILES: OCCn1c2ccccc2c2ccccc21] | — |
| | | 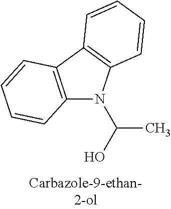 [SMILES: CC(O)n1c2ccccc2c2ccccc21] | |
| | | 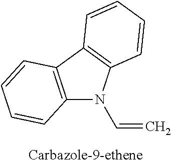 | |
| | 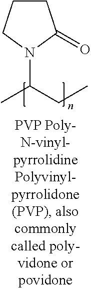 | 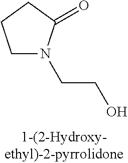 | — |
| | | 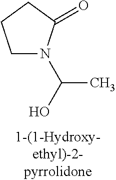 | |
| | | 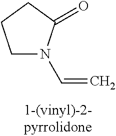 | |
| Halide | 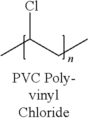 | 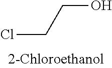 | — |
| | | 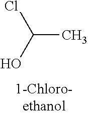 | |
| | | 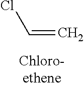 | |
| | 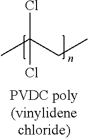 | 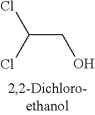 | — |
| | | 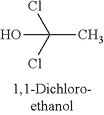 | |
| | | 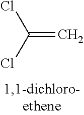 | |
| | 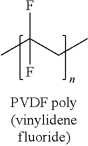 | 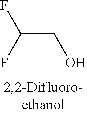 | — |
| | | 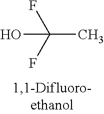 | |
| | | 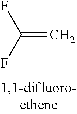 | |
| | 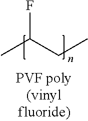 | 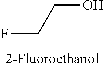 | — |
| | | 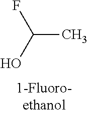 | |
| | | 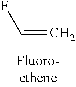 | |
| | 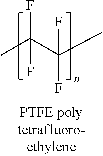 | 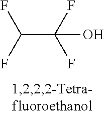 | — |
| | | 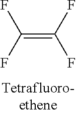 | |
| | 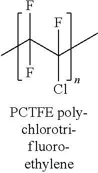 | 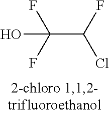 | — |
| | | 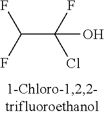 | |
| | | 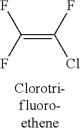 | |
| Acryloni- trile | 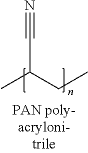 | 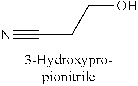 | — |
| | | 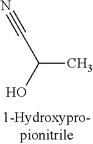 | |
| | | 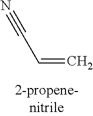 | |
| Acrylate | 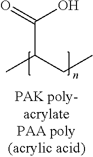 | 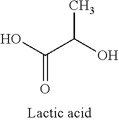 | — |
| | | 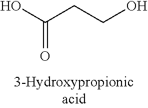 | |
| | | 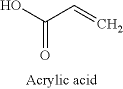 | |
| | 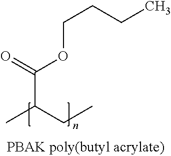 | 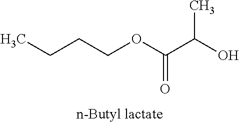 | — |
| | | 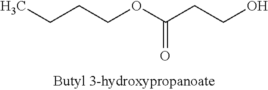 | |
| | | 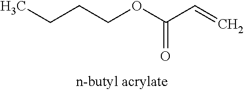 | |
| | 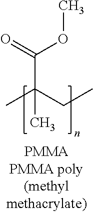 | 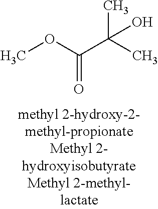 | — |
| | | 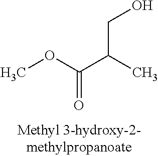 | |
| | | 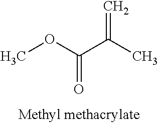 | |
| Addition (4 carbon backbone) | 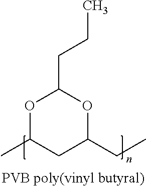 | 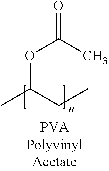 | 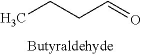 |
| | 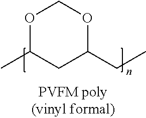 | 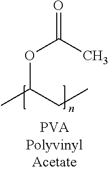 | Formaldehyde H₂C═O |
| Special | 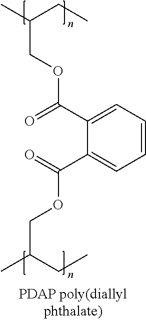 | 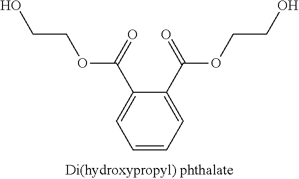 [SMILES: O=C(OCCO)c1ccccc1C(=O)OCCO] | — |
| | 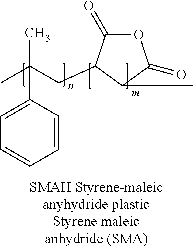 | 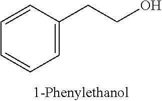 | |
| | | 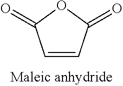 | |
| | | 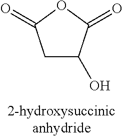 | |
| 33-13 Ring opening polymeri- zation (similar to addition) | 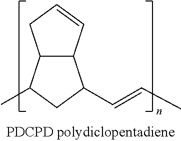 | 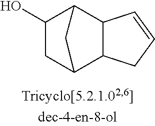 [SMILES: OC1CC2CC1C1C=CCC21] | |
| | | 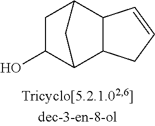 [SMILES: OC1CC2CC1C1CC=CC21] | |
| | | 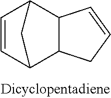 | |

Electrochemical Production of 7-4 Condensation Polymer

As outlined in FIG. 33, 7-4 Condensation Polymer is a class of 1-8 Polymer formed through condensation polymerization as the second part of 7-2 Chemistry. It includes but is not limited to:
33-2 Polyether (including cellulose, furan, phenolic and related resins)
33-5 Polysulfide
33-6 Polyamine
33-8 Polyester
33-9 Polyamide
6-7 Polycarbonates
33-10 Polyanhydride
33-11 Polyimide
33-12 Polyurethane
33-13 Ring opening
33-14 Heteroatoms: Polysiloxanes Polysulfone, Polyphosphate, polynitrate

The electrochemical production of 7-4 Condensation Polymer comprises 33-1 Condensation and transesterification. 33-1 Condensation involves intermolecular elimination of active groups to join molecules together, while transesterification involves more complex elimination often with carbonyl groups.

33-1 Condensation: 33-2 Polyether

The simplest reaction is the electrochemical 33-1 Condensation of diol to form 33-2 Polyether, with water formation as 1-15 By-product as shown in Equation 9:

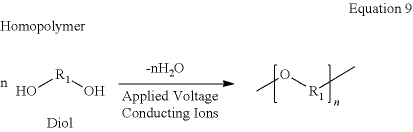

Similar to 7-3 Addition Polymer production, copolymerization between different types of diols are possible if present in same system as shown in Equation 10:

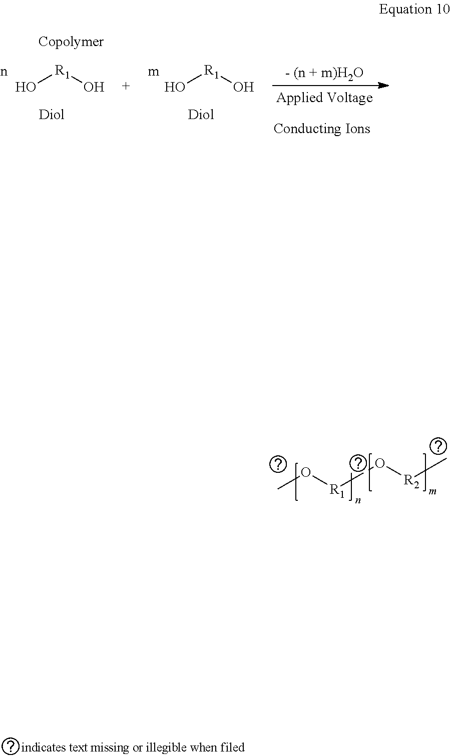

Note that the copolymer order of each unit can be arbitrary. The specific reactions of Interest is detailed in Table 14:

TABLE 14
Examples of 33-2 Polyethers

| Substituents of | | 1-6 Rectants | |
|---|---|---|---|
| branch | 1-8 Polymer P | 68-1 Material A | 68-2 Material 8 |
| 33-2 Polyether | Acetal (POM) | Methanol | |
| | 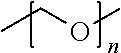 POM poloxymethylene; polyacetal; polyormaldehyde | 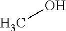 Formaldehyde 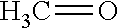 | |
| | | Methanedoil (Presence | |
| | | from Formaldehyde in | |
| | | water) | |
| | | Methylene glycol | |
| | | 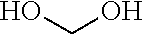 | |
| | PPOX poly(propylene oxide) | Propylene oxide | |
| | 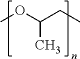 Polypropylene glycol | 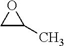 Propylene glycol 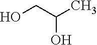 | |
| | PEOX poly(ethylene oxide) | Ethylene oxide | |
| | 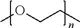 | 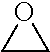 | |
| | Polyethylene glycol (PEG), polyethylene oxide (PEO) or polyoxyethylene (POE) | Ethylene glycol 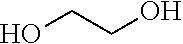 | |
| | PPE poly(phenylene ether) | Phenol | |
| | 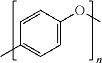 PPO | 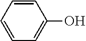 Hydroquinone Or copolymerization of | |
| | | hydroquinone with | |
| | | Resorcinol | |
| | | 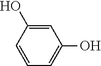 | |
| | PK polyketone | Cyclopropanone | |
| | 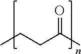 | 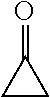 Reuterin | |
| | | 3-Hydroxypropanal | |
| | | 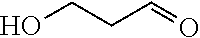 | |

33-1 Condensation: 33-3 Monoalcohol: Furan and Phenol Resins

When the carbon backbone is certain cyclic aromatic compounds, such as furan and phenol, 33-1 Condensation can still happen with single alcohol group as shown in Equation 11 and Equation 12. The end product is either 33-2 Polyether or polyalkane groups.

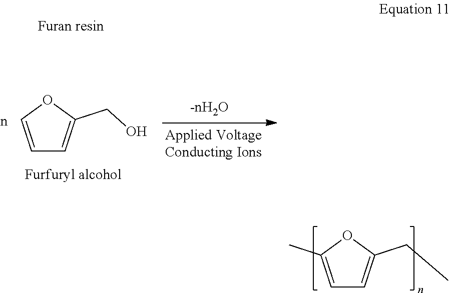

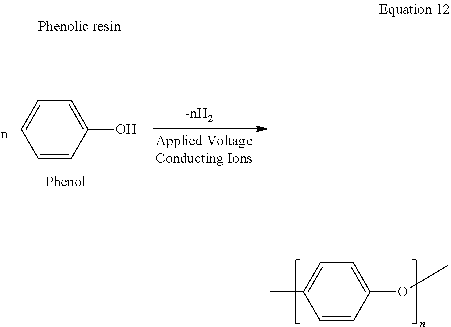

Note that for the above cases, there is no adjacent hydrogen atom for intramolecular dehydration/elimination, so the intermolecular reaction is the only reaction available. Table 15 describes the furan and phenolic resin reaction of commercial interest:

TABLE 15
Examples of Furan and phenolic resins

| | | 1-6 Reactants | |
|---|---|---|---|
| Substituents | | | 68-2 |
| of branch | 1-8 Polymer P | 68-1 Material A | Material B |
| Condensation (Furan) | FF Furan-formaldehyde resin Furfural resin 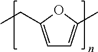 Polyfurfuryl | Furan 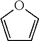 Formaldehyde 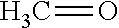 | |
| | | Furfural | |
| | | 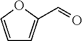 | |

33-1 Condensation: 33-4 Cellulose

Notably, the carbon backbone can comprise a sugar or its derivative, for which case the end product of 33-2 Polyether formation is actually a 33-4 Cellulose resin, often of useful application as biodegradable 1-8 Polymer. For instance, the starting material can be glucose as shown in Equation 13:

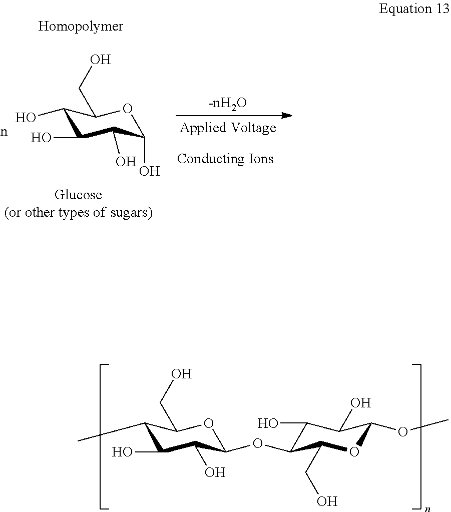

Similar reaction applies for derivatives of sugars such as glucose with some —OH group esterified with acetate group as shown in Equation 14:

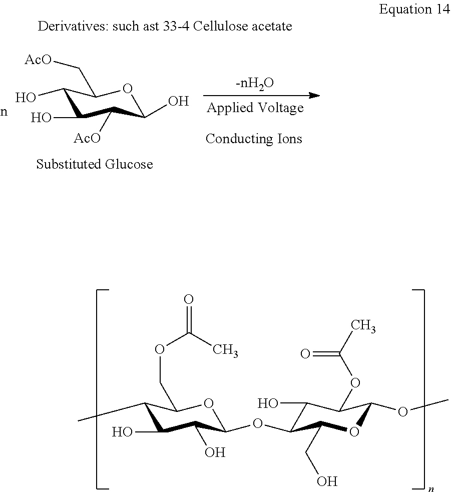

33-4 Cellulose copolymers are also possible if different sugars are mixed in the same system during the reaction.

33-1 Condensation: 33-5 Polysulfide

Similar to 33-2 Polyether, 33-5 Polysulfides can be produced electrochemically from disulfide as shown in Equation 15:

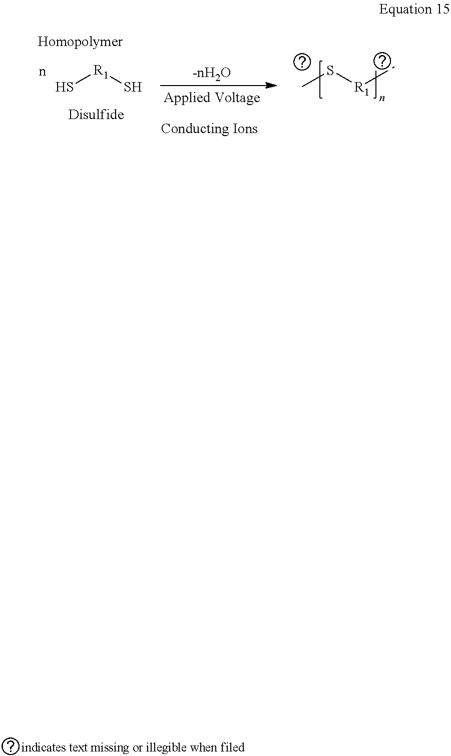

Copolymers are also possible when different disulfides are mixed together in the same system as shown in Equation 16:

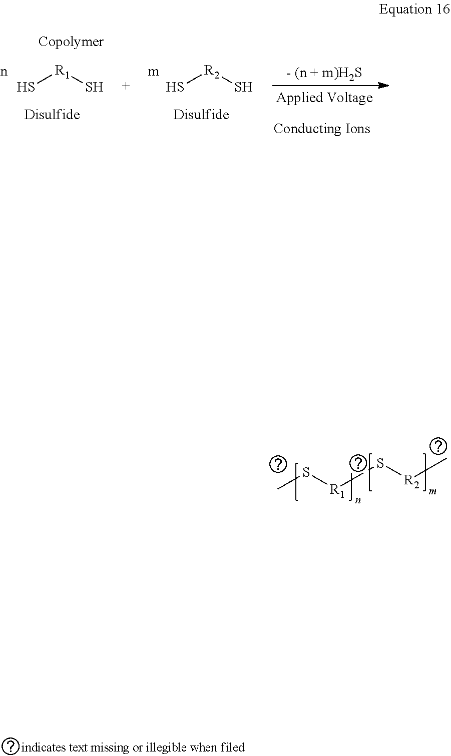

The notable polysulfide reaction is described in Table 16:

TABLE 16
Examples of 33-5 Polysulfides

| Substituents of | | 1-6 Reactants | |
|---|---|---|---|
| branch | 1-8 Polymer P | 68-1 Material A | 68-2 Material B |
| 33-5 Polysulfide | PPS poly(phenylene sulfide) | Thiophenol | — |
| | 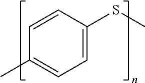 | 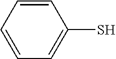 | — |
| | Polyphenylene sulfide | | |

33-1 Condensation: 33-6 Polyamines

Similar to 33-2 Polyether and 33-5 Polysulfides, 33-6 Polyamines can be produced electrochemically from diamine as shown in Equation 17:

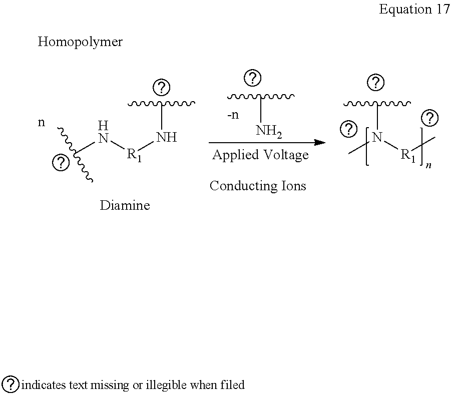

Copolymers can be produced when different types of diamines are mixed in the same system as shown in Equation 18.

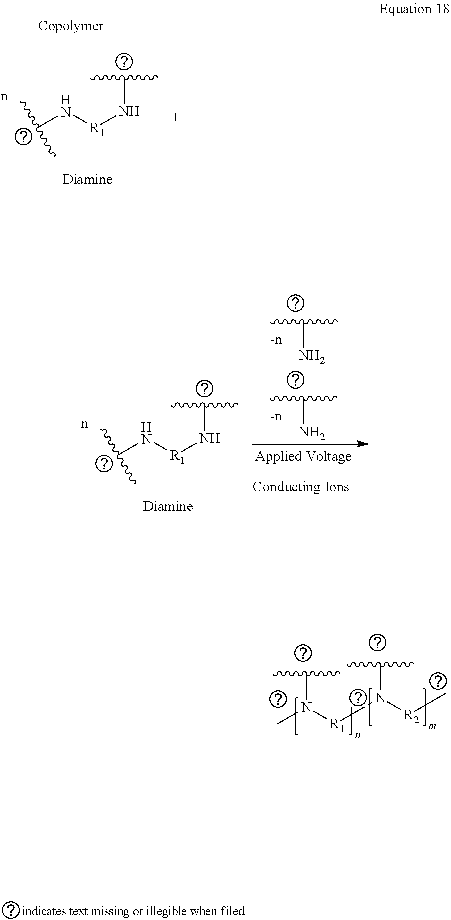

33-7 Transesterification: 33-8 Polyester

33-8 Polyester can be produced from 33-7 Transesterification, which is in some sense very similar to 33-1 Condensation. The simplest variant is the reaction between alcohol and carboxylic acid group in the same molecule of hydroxyl acid as shown in Equation 19:

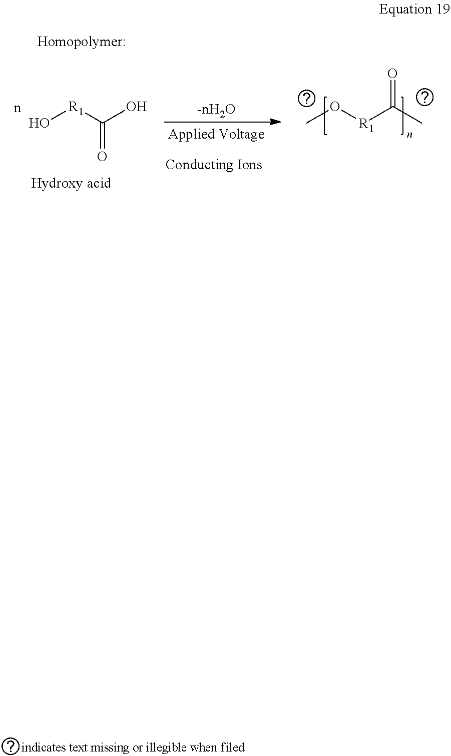

Note that the hydroxyl acid reaction to form 33-8 Polyester is very useful for many biodegradable 1-8 Polymer production such as polylactic acid from lactic acid, and polyacrylate from acrylic acid.

The next variant is the reaction between alcohol and carboxylic acid groups in different molecules, such as between diol and diacid as shown in Equation 20:

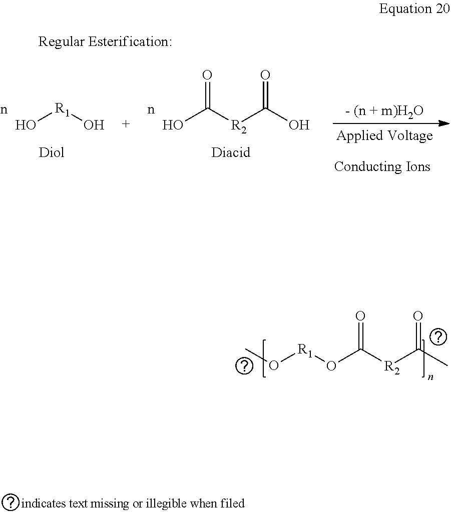

The specific reactions under the polyester class is detailed in Table 17:

TABLE 17
Examples of 33-8 Polyesters

| Substituents of | | 1-6 Reactants | |
|---|---|---|---|
| branch | 1-8 Polymer P | 68-1 Material A | 68-2 Material B |
| 33-8 Polyester | PHB polyhydroxybutyric | 3-hydroxybutyric acid | — |
| Homopolymer (Intramolecular condensation) Polyacid | acid or polyhydroxybutyrate 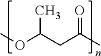 | β-Hydroxybutyric acid 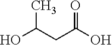 | |
| | A type of | | |
| | polyhydroxyalkanoates | | |
| | PLA polylactic acid or poly lactide 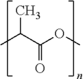 | Lactic acid 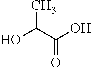 | — |
| | PGA poly(glycolic acid) | Glycolic acid | — |
| | 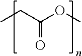 | 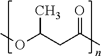 | |
| | PHA polyhydroxyalanoic or polyhydroxyalkanoates 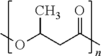 | 2-hydroxy propanoic acid 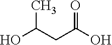 3-hydroxy propanoic acid | |
| | | 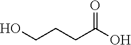 | |
| | PAR polyarylate Poly-4-hydroxybenzoate 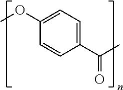 | 4-Hydroxybenzoic acid 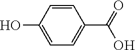 | — |
| Regular condensation | PET 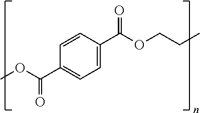 | Terephthalic acid 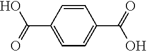 [SMILES: O=C(O)c1ccc(C(=O)O)cc1] | Ethylene glycol 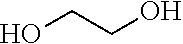 |
| | PBT (Polyburylene terephthalate) 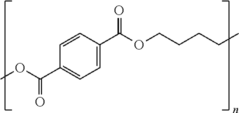 | Terephthalic acid 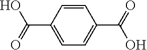 [SMILES: O=C(O)c1ccc(C(=O)O)cc1] | 1,4-Butanediol (BD) Tetramethylene glycol 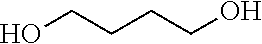 |
| | PBN poly(butylene napthalate) 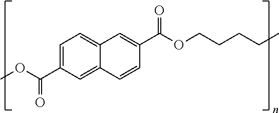 | Naphthalene-2,6- dicarboxylic acid 2,6- Naphthalenedicarboxylic acid 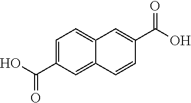 [SMILES: O=C(O)c1ccc2cc(C(=O)O)ccc2c1] | 1,4-Butanediol (BD) Tetramethylene glycol 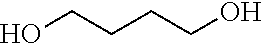 |
| | Polyethylene naphthalate PEN poly(ethylene naphthalate) 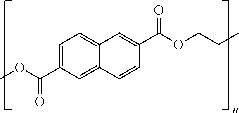 | Naphthalen-2,6- dicarboxylic acid 2,6- Naphthalenedicarboxylic acid 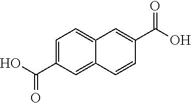 [SMILES: O=C(O)c1ccc2cc(C(=O)O)ccc2c1] | Ethylene glycol 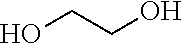 |
| | PCL polycaprolactone | ϵ-Caprolactone | |
| | 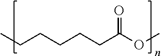 | 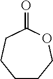 | |
| | | 6-Hydroxyhexanoic acid | |
| | | 6-Hydroxycaproic acid | |
| | | 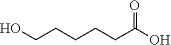 | |
| | PCT poly(cyclonhexylene dimethylene terephthalate) 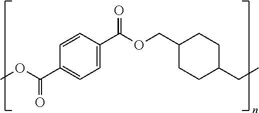 PCCE poly(cyclohexylene dimethylene cyclohexanedicarboxylate) | Terephthalic acid 1,4-Benzenedicarboxylic acid 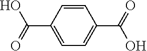 [SMILES: O=C(O)c1ccc(C(=O)O)cc1] 1,4- Cyclohexanedimethanol 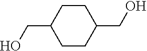 | |
| PEC polyester carbonate or poly(butylene succinate/carbonate) PEC Polyestercarbonate | PBS polybuthylenesuccinate 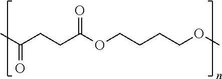 | Succinic acid 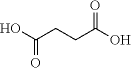 | 1,4 Butanediol Tetramethylene glycol 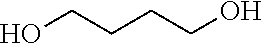 |
| | PES poly(ethylene succinate) 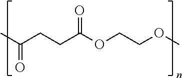 | Succinic acid 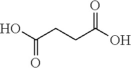 | Ethylene glycol 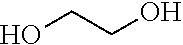 |
| | PTT poly(trimethylene terephthalene 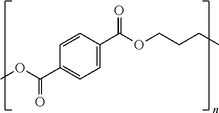 | Terephthalic acid 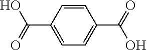 [SMILES: O=C(O)c1ccc(C(=O)O)cc1] | 1,3 Propanediol 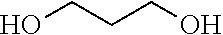 |
| Miscellaneous | LCP Liquid-crystal 1-8 Polymer 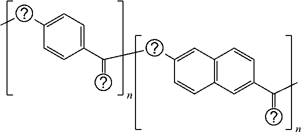 Example | 4-Hydroxybenzoic acid p-hydroxybenzoic acid (PHBA) 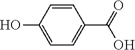 6-Hydroxy-2-naphthoic acid 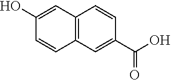 [SMILES: O=C(O)c1ccc2cc(O)ccc2c1] | |

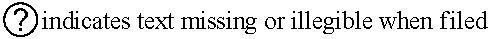

33-7 Transesterfication: 33-9 Polyamide

33-9 Polyamide is a class of useful 1-8 Polymer materials, it includes biological proteins and materials such as nylon and Kevlar. In very similar pattern as 33-8 Polyester, it involves reaction between amine and carboxylic acid groups to be produced. The simplest variant is the amino acid polymerization where amine and carboxylic acid groups are in the same molecule as shown in Equation 21:

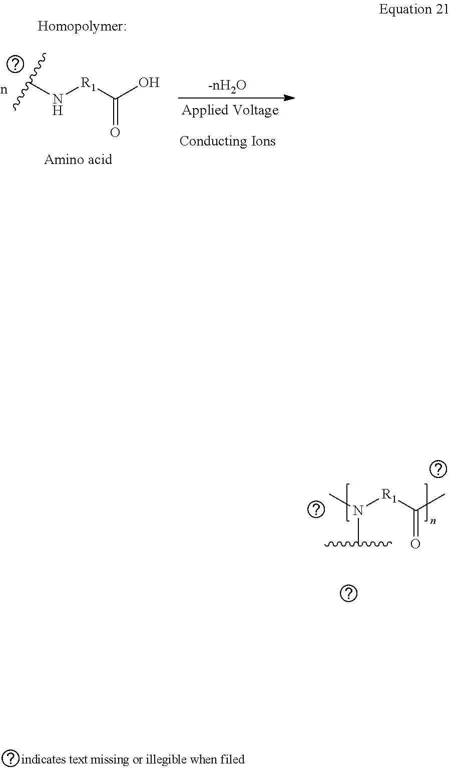

Another variant is the esterification of amine and carboxylic acid groups in different molecules, between diamine and diacid as shown in Equation 22:

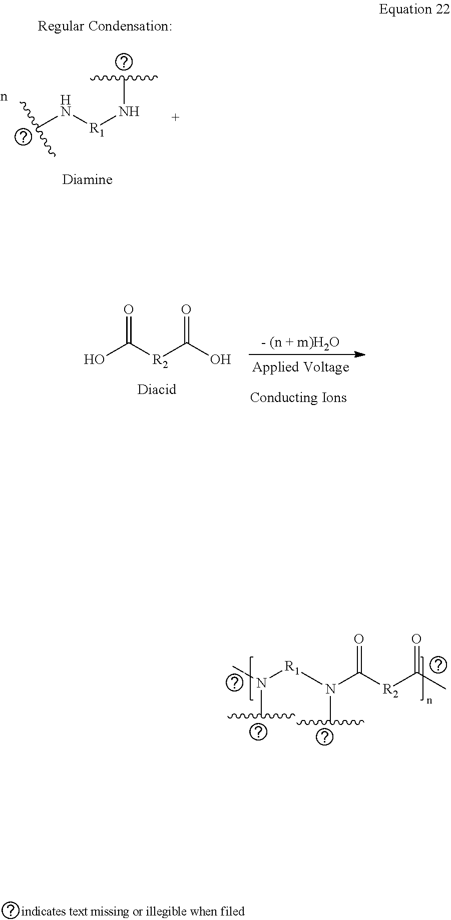

The polyamide reaction of interest is described in Table 18:

TABLE 18
Examples of 33-9 Polyamides

| Substituents | | 1-6 Reactants | |
|---|---|---|---|
| of branch | 1-8 Polymer P | 68-1 Material A | 68-2 Material B |
| 33-9 Polyamides (PA) | Nylon PARA poly(aryl amide) PAA 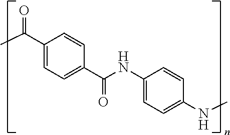 | Terephathalic acid 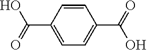 [SMILES: O=C(O)c1ccc(C(=O)O)cc1] | p-Phenylenediamine (PPD) 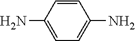 |

33-7 Transesterification: 6-7 Polycarbonates

6-7 Polycarbonates can also be produced electrochemically by reaction between diol and carbonyl compounds as shown in Equation 23. This is a very useful reaction because the carbonyl compounds can include (but not limited to) 6-1 Urea which is abundantly cheap, yet not super toxic, carbonic acid from carbon dioxide sequestration, and dimethyl carbonates from industry as 5-3 Commodity Chemicals. It also produces alcohols as 1-15 By-product which is often recovered as useful fuels or valuable 5-5 Feedstock Chemicals.

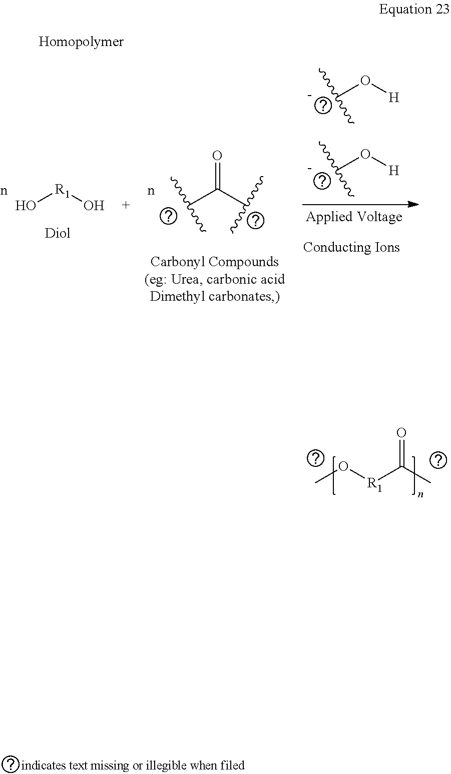

When different diols are present, copolymeric carbonates can be produced as shown in Equation 24:

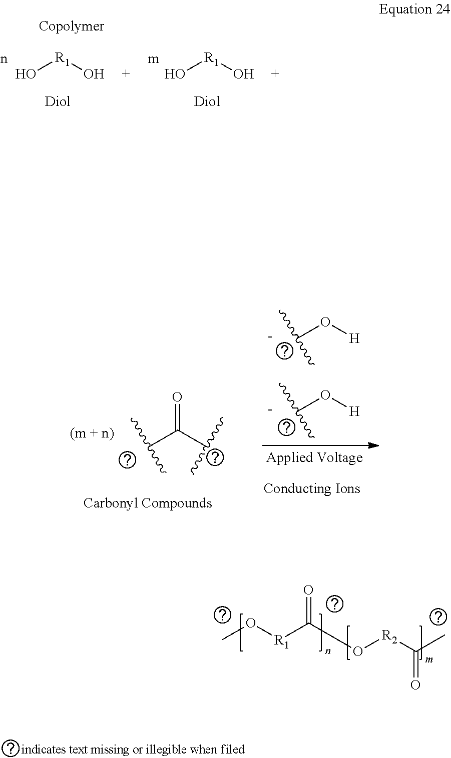

Polycarbonate reaction of interest is described in Table 19:

TABLE 19
Examples of 6-7 Polycarbonates

| Substituents of | | 1-6 Reactants | |
|---|---|---|---|
| branch | 1-8 Polymer P | 68-1 Material A | 68-2 Material B |
| 6-7 Polycarbonates | PC 6-7 Polycarbonates 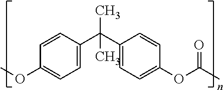 | Bis-phenol A (BPA) 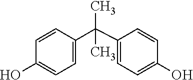 [SMILES: CC(C)(c1ccc(O)cc1)c1ccc(O)cc1] | 6-1 Urea 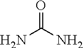 Carbonic acid 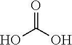 |
| | | | 6-3 Phosgene, or |
| | | | Carbonyl dihalides |
| | | | 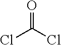 |

33-7 Transesterification: 33-10 Polyanhydride

33-10 Polyanhydride can be produced electrochemically from diacid and acid anhydride as shown in Equation 25. The by-products are carboxylic acid or its derivatives.

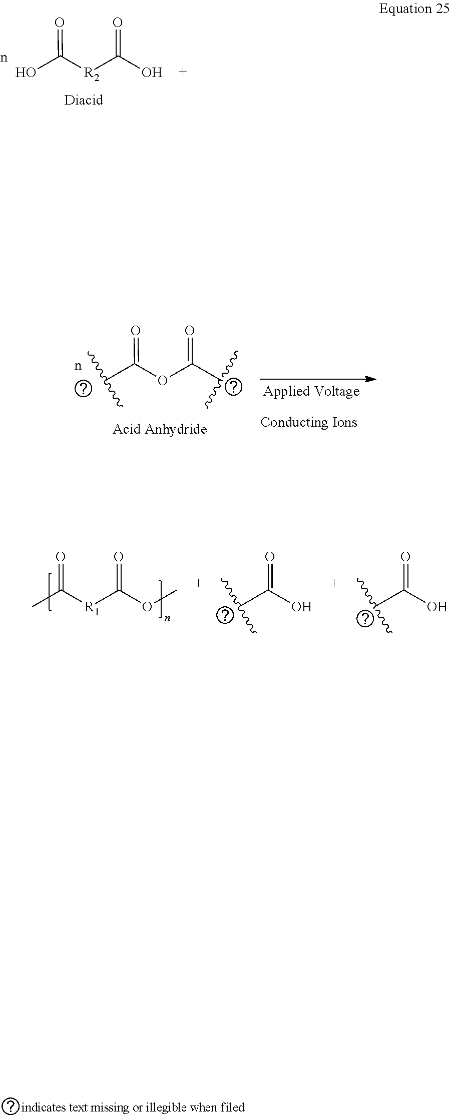

33-7 Transesterification: 33-12 Polyurethane

33-12 Polyurethane can be produced electrochemically from reaction between diol and diisocyanate and shown in Equation 26.

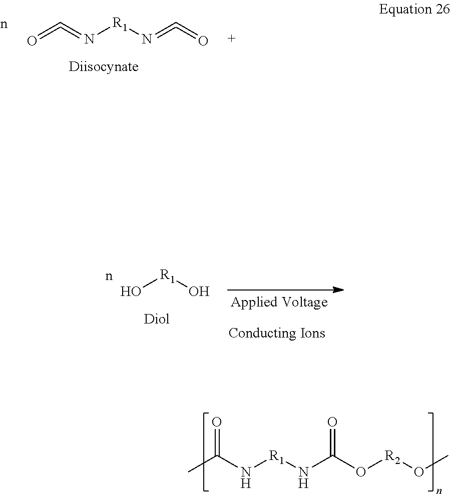

The specific polyurethane reaction of interest is described in Table 20:

TABLE 20
Examples of 33-12 Polyurethanes

| Substituents | | 1-6 Reactants | |
|---|---|---|---|
| of branch | 1-8 Polymer P | 68-1 Material A | 68-2 Material B |
| 33-12 Polyurethane | 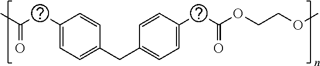 | 4,4′-Methylene diphenyl diisocyanate 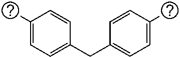 | Ethylene glycol 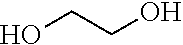 |

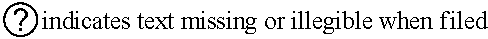

33-7 Transesterification: 33-11 Polyimide

33-11 Polyimide can be produced from reaction dianhydride and diamine, or dianhydride with diisocyanate. Dianhydride-diamine reaction is more common because diamine is more abundant as shown in Equation 27:

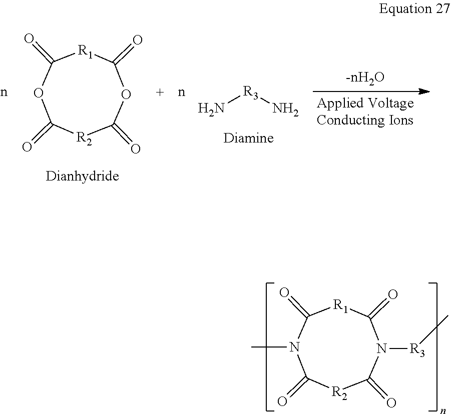

On the other hand, the dianhydride-diisocynate reaction produces carbon dioxide which can be readily separated as gas for 1-5 Recovery as shown in Equation 28.

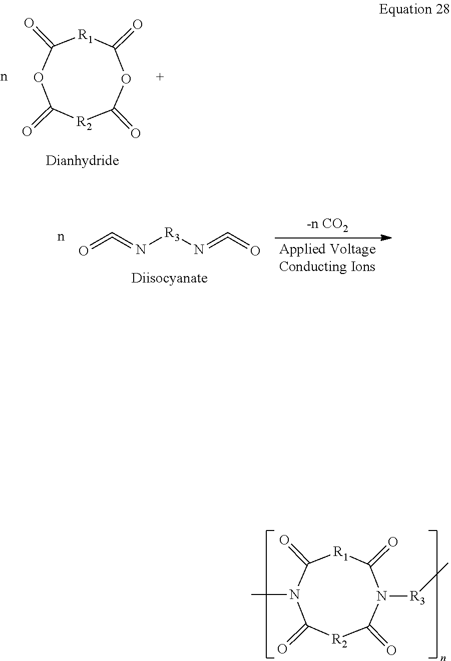

The polyimide reactions of interest is further detailed in Table 21:

TABLE 21
Examples of 33-11 Polyimides

| Substituents of | | 1-6 Reactants | |
|---|---|---|---|
| branch | 1-8 Polymer P | 68-1 Material A | 68-2 Material B |
| PI 33-11 | PMI | Methacrylic | Methacrylic |
| Polyimide | Polymethacrylimide | anhydride | anhydride |
| 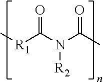 | 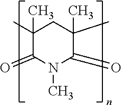 | 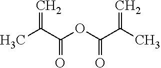 Methylamine | 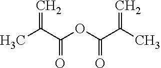 Isocyanic acid |
| | PMMI Poly-N-methylmethacrylimide | 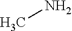 | 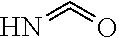 |
| | | Methacrylic | Methacrylic |
| | | anhydride | anhydride |
| | | 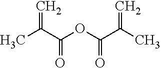 | 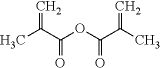 |
| | | Dimethylamine | Methyl isocyanate |
| | | 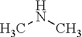 | 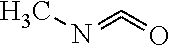 |

33-7 Transesterification: 33-13 Ring Opening

Ring-opening reaction is a useful way to produce 1-8 Polymer from cyclic compounds as illustrated in Equation 29. The cyclic compounds are often heteroatom rings, containing groups such as carbonyl (C═O), Carbonate, Ether, Ester, amine, amide, sulfide, or other groups with atoms other than Carbon atom.

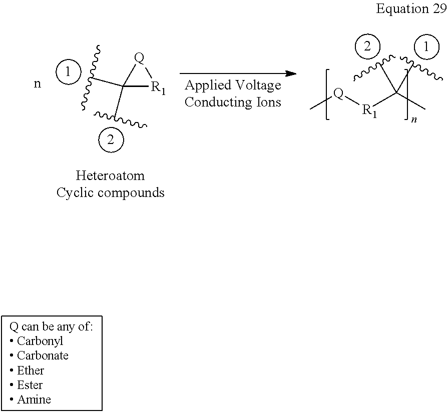

Note that while the equation began with the shortest ring possible which is a triangle ring, the ring can be larger by using larger ring. In some embodiments, the resulting 1-8 Polymer comprise carbon backbones. Some notable examples include 33-13 Ring opening of cyclic carbonates which are staple of 6-7 Polycarbonates production as shown in Equation 30 and Equation 31:

### Examples: Cyclic Carbonates

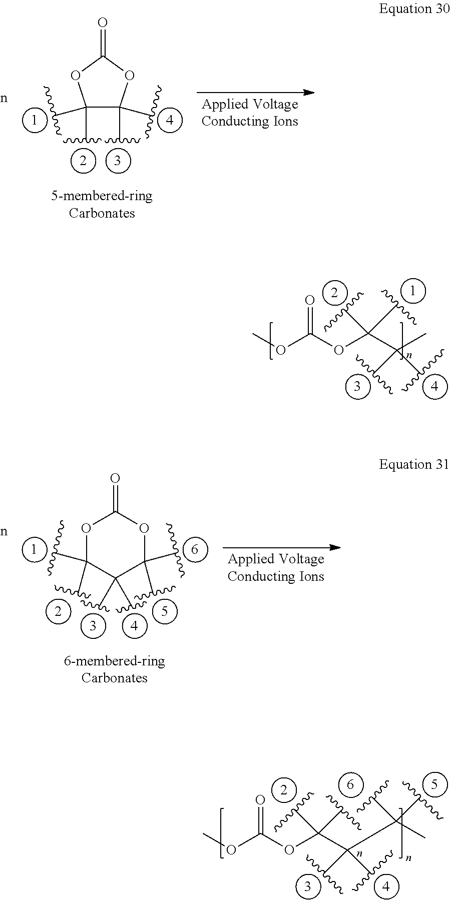

The ring-opening polymerization reaction of interest is detailed in Table 22:

TABLE 22
Examples of ring-opening polymerizations

| Substituents of | | 1-6 Reactants | |
|---|---|---|---|
| branch | 1-8 Polymer P | 68-1 Material A | 68-2 Material B |
| Ring-opening | PPC carbon dioxide and propylene copolymer 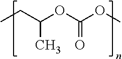 Polypropylene 1,2 carbonate | Propylene 1,2 carbonate 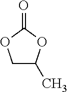 | — |
| | (PPC) | | |
| | Polypropylene 1,3 carbonate | Propylene 1 3 carbonate | |
| | 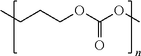 | 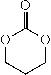 | |
| | Polyethylene carbonate (PEC) | Ethylene carbonate | |
| | 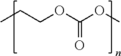 | 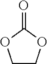 | |
| | Polyglycerol 1,2 carbonate | Glycerol 1,2 carbonate | — |
| | 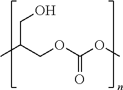 | 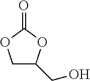 | |
| | Poly glycerol 1,3 carbonate | Glycerol 1, 3 carbonate | |
| | 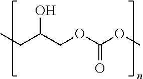 | 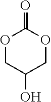 | |

33-7 Transesterification-33-14 Heteroatoms: Polysiloxanes Polysulfone, Polyphosphate, Polynitrate

The 33-1 Condensation and/or 33-7 Transesterification also works when the adjacent atom is 33-14 Heteroatoms: Polysiloxanes Polysulfone, Polyphosphate, polynitrate instead of carbon atom. For instance, siloxanes can undergo 33-1 Condensation (similar to 33-2 Polyether) to form 33-15 Polysiloxanes as shown in Equation 32:

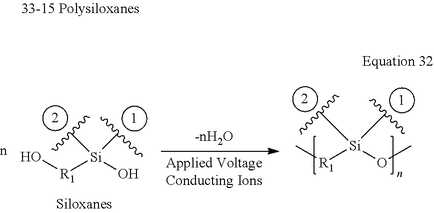

As another example, diol can undergo 33-7 Transesterification with sulfonyl compounds (similar to carbonyl compounds) to form 33-16 Polysulfones as shown in Equation 33.

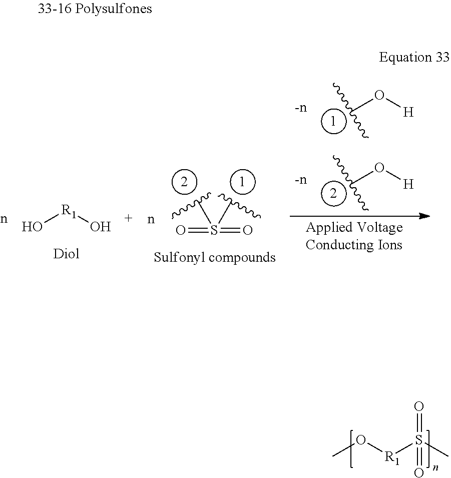

Polyphosphonates are also possible if the heteroatom is phosphorus, as shown in Equation 34:

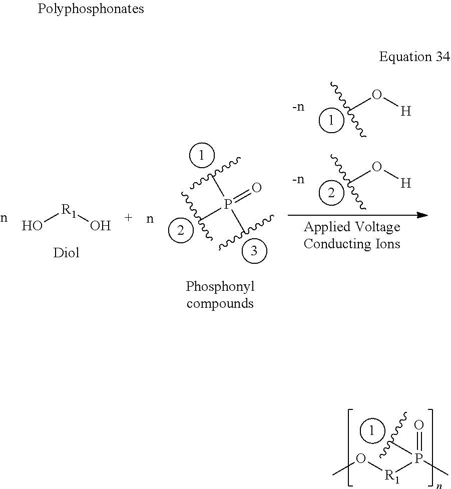

Other possibility include polynitrate, among others. The heteroatomic variants of interest are tabulated in Table 23:

TABLE 23
Examples of 33-14 Heteroatoms: Polysiloxanes Polysulfone, Polyphosphate, polynitrate
polymerizations

| Substituents | | 1-6 Reactants | |
|---|---|---|---|
| of branch | 1-8 Polymer P | 68-1 Material A | 68-2 Material B |
| 33-16 Polysulfone | PSU polysulfone 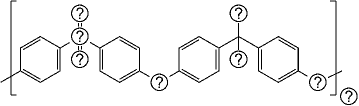 | Bisphenol S Bis(4-hydroxyphenyl) sulfone 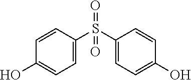 [SMILES: O=S(=O)(c1ccc(O)cc1)c1ccc(O)cc1] | 2,2-Bis(4- hydroxyphenyl) propane 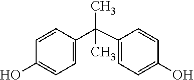 [SMILES: CC(C)(c1ccc(O)cc1)c1ccc(O)cc1] |
| Polyarylsulfone (PSU) | PPSU poly(phenylene sulfone) 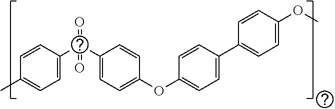 | Bis(4-hydroxyphenyl) sulfone 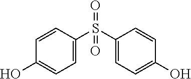 [SMILES: O=S(=O)(c1ccc(O)cc1)c1ccc(O)cc1] | 4,4′-Biphenol 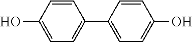 [SMILES: Oc1ccc(-c2ccc(O)cc2)cc1] |
| 33-15 Polysiloxanes | SI silicone plastic 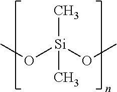 | dimethylsilanediol 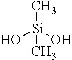 | — |
| Polyaryl phosphonate | BHDB-polyphosphonate 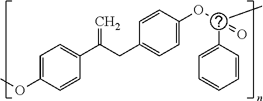 | 4,4′- bishydroxydeoxybenzoin (BHDB) 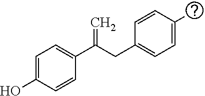 [SMILES: C=C(Cc1ccc(C)cc1)c1ccc(O)cc1] | Phenylphosphonic acid 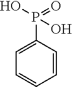 |

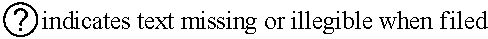

Chemical 7-5 Process

As outlined in FIG. 34, the 7-5 Process generally involves 34-1 Concept, 34-2 Recovery elimination, 34-3 Retrofitting, 34-4 Waste Management and finally 34-5 Block Flow Diagram.

34-1 Concept

The first variant of the electrochemical 1-8 Polymer production 5-1 elerGreen Process, illustrated by FIG. 35, is that very similar to the conventional 7-5 Process, but instead with the 1-2 Conventional Reactor requiring significant 1-11 Heat, 1-12 Pressure and 1-13 Catalyst, replaced by 35-1 Electrochemical Reactor that uses 3-1 Electricity and 6-6 Conducting ions. While 1-11 Heat and 1-12 Pressure is generally not needed, it can still be added to the 35-1 Electrochemical Reactor as necessary depending on the type of reaction, and even in that case often with substantially lower temperature and 1-12 Pressure than the conventional 7-5 Process.

The general variant, Variant 1, can be used when the 1-15 By-product is valuable but harmful when 36-1 Discharge to environment is involved, such as amines and alcohols. For this case, 1-5 Recovery unit is used to recover the valuable (though harmful if released to environment) 5-5 Feedstock Chemicals for sale instead of discharging/disposal, at the cost of more complex 7-5 Process.

34-2 Recovery Elimination

Another variant, Variant 2, illustrated by FIG. 36, is a simpler case than Variant 1, in that the 1-15 By-product is not recovered and simply discharged at 36-1 Discharge. This can be used when the 1-15 By-product are neither harmful nor valuable, such as water in many cases of reaction. This allows the cost to be even lower due to the elimination of 1-5 Recovery which incurs capital and operating costs.

34-3 Retrofitting

While many other greentech 7-5 Process involves rebuilding the entire different 7-5 Process, the novel electrochemical 1-8 Polymer production 5-1 elerGreen Process involves replacing the core 1-2 Conventional Reactor with 35-1 Electrochemical Reactor, while retaining (if not minimally adjust) the complementary operation units or existing industrial standards as illustrated by FIG. 37.

The compatibility with conventional system allows buying a regular plant and just renovate the 1-2 Conventional Reactor into 35-1 Electrochemical Reactor, in contrary to building a wholly different chemical plant from scratch. As a result, the pitfalls of over-budget as in many greentech can be avoided, while the acquisition of conventional plant itself also serves to allow the project to take much shorter time to implement, besides offering a stream of income to serve the bonds/loans used for acquisition, besides making use of the established market share since the products remains the same after renovation, just substantially lower cost.

The way to perform the 34-3 Retrofitting is to insert the 35-1 Electrochemical Reactor as 37-1 Bypass into a 1-2 Conventional Reactor system. This can be achieved by constructing the 35-1 Electrochemical Reactor on site, connecting parallel piping 37-1 Bypass system as alternative, troubleshooting the alternative system and finally decommissioning the conventional system.

For purpose of 34-3 Retrofitting, a novel setup for distillation column has also been involved, to switch between solvent a top of distillation column to solvent at bottom, via simple connection of 7-6 Piping and switch valves.

34-4 Waste Management

Another variant, involving add-on of 34-4 Waste Management unit, is illustrated in FIG. 38. For 34-4 Waste Management, 38-1 Waste Extraction equipment would be needed. A simple variant is installing the 38-1 Waste Extraction equipment upstream to extract the active ingredients (that are usually the substances that makes the 5-2 Chemical wastes toxic) from 5-2 Chemical wastes. Alternatively, the 38-1 Waste Extraction can be a separate chemical 7-5 Process, even in another plant, with the Isolated active ingredient shipped to the 1-8 Polymer production facility and stored in a regular material storage tank. The 38-1 Waste Extraction equipment consists of regular separation 7-5 Process equipment including but not limited to solvent extractor and distillation column, though the exact type and specification of 38-1 Waste Extraction equipment to be used depends on the 5-2 Chemical wastes and active ingredient of interest on a case-by-case basis of chemical engineering.

To illustrate the 34-1 Concept, an example is 38-1 Waste Extraction of ethylene glycol from paint sludge and spent antifreeze 34-4 Waste Management. Ethylene glycol would cause neurological damage, vomiting and death upon ingestion, and is hazardous to environment when it is discharged together with paint sludge and spent antifreeze. However, ethylene glycol itself, when concentrated in industrial grade, is a material to produce polyethylene glycol (of industrial and medical use), besides being a 5-5 Feedstock Chemicals of interest for chemical industry and could be easily sold for money. Ethylene glycol could be isolated from paint sludge using distillation column or other separation processes such as membrane filtration. For the purpose to integrate such 34-4 Waste Management into the 1-8 Polymer production 7-5 Process, the separation equipment together with 5-2 Chemical wastes storage tank, can be installed upstream, before the storage tank, to continuously isolate ethylene glycol to be stored in material storage tanks. Alternatively, the 34-4 Waste Management can be implemented in another plant site (can be same owner or just be owned by another entity including but not limited to supplier and 34-4 Waste Management client) designated for 34-4 Waste Management plant and have the isolated ethylene glycol shipped by chemical truck to the polymer 7-5 Process site.

34-5 Block Flow Diagram

As detailed in FIG. 39, the general 7-5 Process consists of multiple blocks: Materials, 1-1 Preparation, Synthesis, 1-3 Solid Separation, 1-4 Processing and 1-5 Recovery.

Materials:

Materials block consists of 1-6 Reactants tanks, Feed Tank A, while other 1-6 Reactants such as Feed Tank B or even Feed Tank C, D, E, F, are possible. 68-1 Material A is usually supplied by a chemical tank truck into an inlet, usually but not necessarily at the top of Feed Tank A. Feed Tank A has a drain, usually at the bottom, to drain the tank for purposes such as 59-3 Maintenance, cleaning and decommissioning. 68-1 Material A exits from Feed Tank A, by an outlet usually but not necessarily at the bottom, into Mixing Tank.

In some implementations, for polymerization reaction involving more than one monomer, other materials are needed, warranting the need for other feed tanks in parallel to Feed Tank A. For the case of 68-2 Material B, it is usually supplied by another chemical tank truck into an inlet, usually but not necessarily at the top of Feed Tank B. Feed Tank B, like Feed Tank A has a drain, usually at the bottom, to drain the tank for purposes such as 59-3 Maintenance, cleaning an decommissioning. 68-2 Material 8 exits from Feed Tank B, by an outlet usually but not necessarily at the bottom, into Mixing Tank. If other materials such as Materials C, D, E, F et cetera are needed, especially for copolymerization, then Feed Tank C, D, E, F et cetera would be added in parallel accordingly, similar to addition of Feed Tank B in parallel.

1-1 Preparation:

1-1 Preparation consists of a mixing tank, a heater and a pump. The mixing tank mixes the 1-6 Reactants, Materials A and B, as well as C, D, E, F, and so on if applicable, with the 1-7 Electrolyte, which consists of unreacted 68-1 Material A and B, as well as C, D, E, F, and so on if applicable, 6-6 Conducting ions (such as 68-3 Dissolved Salt), and if applicable, 32-1 Additives and 31-1 Cosolvent. The mixer consists of stirring, usually but not limited to mechanical means by stirring vane driven by motor or engine. In some implementations, the motor or engine need not be connected physical to the vane by shaft, instead can induce vane movement through indirect influence such as magnetic field similar to a 68-5 Magnetic stir bar, in some cases the magnetic field change can be induced by Inductor system such that not even motor/engine is needed. In some implementations, stirring can be done without mechanical method of motor or engine, such as using ultrasound to vibrate the molecules, or by multiple corners and barrier to create turbulence in a static mixer for the species to mixed uniformly, or by bubbling gas into the liquid phase to induce mixing.

The mixed 1-7 Electrolyte, comprised of 68-1 Material A and 68-2 Material B, C, D, E, F as applicable, solute/68-3 Dissolved Salt, as well as 32-1 Additives and 31-1 Cosolvent as applicable, then exits the mixer by an outlet, usually but not necessarily located at bottom of the mixing tank. It is then heated using the heater and fed into the 40-3 Pumps/Compressor. In some implementations, the heater can be replaced by other means of heating such as a heat exchanger that heats the stream up via conduction and convection with another fluid with higher temperature, usually but not limited to hot steam, hot water or heating oil. In some implementations when cooling is needed, the heater can be replaced by a cooling unit instead. In some implementations where neither heating nor cooling of 1-7 Electrolyte is necessary, heating and/or cooling unit can be eliminated.

The 1-7 Electrolyte then enters a 40-3 Pumps/Compressor to increase the fluid 1-12 Pressure up to the needed level for subsequent chemical reaction. While compressor is usually used, it can be replaced by a pump, such as a centrifugal pump for cost reduction purpose when the 1-12 Pressure needed is not high. In some implementations, the 40-3 Pumps/Compressor can exchange position with heating/cooling unit upstream, that is, the 40-3 Pumps/Compressor can be placed before heater, instead of the default setup of the heater before 40-3 Pumps/Compressor. In some implementations where 1-12 Pressure is not involved, the 40-3 Pumps/Compressor unit can be eliminated. The mixture with the appropriate temperature and 1-12 Pressure subsequently enters into the Synthesis block.

Synthesis:

The Synthesis block begins with a switch valve to direct the 1-7 Electrolyte to 2 possible paths:

a. Conventional Option

The 1-7 Electrolyte then enters a 1-2 Conventional Reactor with adjustable temperature and 1-12 Pressure, where the 1-6 Reactants in the mixture reacts to form 1-8 Polymer, usually as suspension in the mixture, and the 1-15 By-product chemical. Depending on specific 7-5 Process need, the 1-2 Conventional Reactor may come with a heating/cooling fluid jacket or thermal insulation for temperature 7-7 Control and safety, as well as reinforced/fortified 1-2 Conventional Reactor wall and/or 1-12 Pressure relief valve or rupture disk for 1-12 Pressure safety. The 1-2 Conventional Reactor can involve stirring with vanes driven by motor/engine. In some implementations, the mechanical transmission may not involve direct shaft contact, instead can be non-contact influence such as magnetic field for 68-5 Magnetic stir bar. In some implementations, the movement can be brought about via changing magnetic field by Inductor system rather than magnet fixed to motor/engine. In some implementations, mixing can be Induced non-mechanically such as ultrasound to vibrate molecules, or multiple corners/obstacles to create turbulence in stream flow. In some Implementations, absence of mixing may be beneficial to reaction efficiency by reducing dilution of 1-6 Reactants, for such purpose a plug flow 1-2 Conventional Reactor is used Instead.

The 1-14 Spent electrolyte, with the 1-8 Polymer and the 1-15 By-product is then enters a filter to separate the 1-8 Polymer from the mixture. In some implementation, the filter can be replaced by other means of solid-liquid separation such as a cyclone. The solid 1-8 Polymer exits the filter, or the solid-liquid separation unit, and passes through a switch valve that merges with the electrochemical path into the 1-3 Solid Separation block. The liquid phase of 1-14 Spent electrolyte, containing the 1-15 By-product chemical, exits the filter, or the solid-liquid separator unit, from another outlet, and passes through another switch valve that merges with the electrochemical path.

b. Electrochemical Option

The electrochemical path consists of the novel 35-1 Electrochemical Reactor, where the 1-6 Reactants in the mixture reacts to form 1-8 Polymer and 1-15 By-product. The 35-1 Electrochemical Reactor comes with adjustable operating current, 6-5 Applied Voltage, blade position, electrode speed, and if applicable temperature and 1-12 Pressure. Depending on specific 7-5 Process need, the 35-1 Electrochemical Reactor may come with a heating/cooling fluid jacket or thermal insulation for temperature 7-7 Control and safety, as well as reinforced/fortified 9-20 Vessel wall and/or 1-12 Pressure relief valve or rupture disk for 1-12 Pressure safety. While stirring is provided by default for 35-1 Electrochemical Reactor via the relatively movement of electrode against the 1-7 Electrolyte, the 35-1 Electrochemical Reactor can involve stirring with vanes driven by motor/engine. In some implementations, the mechanical transmission may not involve direct shaft contact, instead can be non-contact influence such as magnetic field for 68-5 Magnetic stir bar. In some implementations, the movement can be brought about via changing magnetic field by inductor system rather than magnet fixed to motor/engine. In some implementations, mixing can be induced non-mechanically such as ultrasound to vibrate molecules, or multiple corners/obstacles to create turbulence in stream flow. In some Implementations, absence of mixing may be beneficial to reaction efficiency by reducing dilution of 1-6 Reactants, for such purpose a plug flow 35-1 Electrochemical Reactor is used instead. Depending on specific 7-5 Process need, a 9-17 Gas Removal can be installed onto the 35-1 Electrochemical Reactor, especially the specialized 9-17 Gas Removal designed for this purpose previously described, can be used to remove gas evolved as further 1-15 By-product of electrochemical reaction, such as hydrogen and oxygen from water splitting when substantial water is present in the 1-7 Electrolyte.

The 3-5 Solid Deposit of 1-8 Polymer is removed from electrode continuously by the 9-8 Solid Removal of the 35-1 Electrochemical Reactor, and subsequently transported out of the 35-1 Electrochemical Reactor. While for the 9-9 Solid Transport is designed to be a stream of 21-2 Washing fluid in an open fluid 9-12 Channel to collect the 1-8 Polymer solid powder and carry it to subsequent 1-3 Solid Separation block, in some implementations such 9-9 Solid Transport is performed mechanically by a 9-11 Conveyor belt. The 1-8 Polymer soaked with some residual 1-14 Spent electrolyte, with or without the 21-2 Washing fluid, then converges with 1-2 Conventional Reactor path at a switch valve. The merged stream is then fed into the 1-3 Solid Separation block where it is washed with water, or a relevant 21-2 Washing fluid, and then further processed to 1-10 Polymer product.

1-3 Solid Separation:

The 1-3 Solid Separation block consist of a Washer, usually but not limited to a stirred mixing tank with stirrer driven by motor/engine. In some implementations, the motor and engine need not be connected physical to the vane by shaft, instead can induce vane movement through indirect influence such as magnetic field similar to a 68-5 Magnetic stir bar, in some cases the magnetic field change can be induced by inductor system such that not even motor/engine is needed. In some implementations, stirring can be done without mechanical method of motor or engine, such as using ultrasound to vibrate the molecules, or by multiple corners and barrier to create turbulence in a static mixer for the species to mixed uniformly, or by bubbling gas into the liquid phase to induce mixing. The 21-2 Washing fluid with 1-8 Polymer suspension and trace 1-14 Spent electrolyte, is fed into the washer where the 1-14 Spent electrolyte dissolves into the 21-2 Washing fluid, again from the 1-8 Polymer solid. The suspension diluted with 21-2 Washing fluid is then passed on a downstream Settler.

The Settler is a large vessel that allows the mixture of 21-2 Washing fluid with trace dissolved 1-14 Spent electrolyte and suspended 1-9 Clean polymer to stay stationary, to separate the 1-9 Clean polymer 1-8 Polymer suspension by gravity. In some implementations, such polymer separation can be performed by other means such as centrifugation, filtration or cyclones. The spent 21-2 Washing fluid exits the Settler via an outlet, usually but not necessarily at the top, while the 1-9 Clean polymer sediment exits the Settler via another outlet, usually but not necessarily at the bottom, considering the usual case of 1-9 Clean polymer being heavier than the 21-2 Washing fluid and settles at the bottom. In some implementations where 1-9 Clean polymer is lighter than the fluid, the 1-9 Clean polymer solid would be skimmed by an outlet at the top while the 21-2 Washing fluid would be drained at the bottom instead. The spent 21-2 Washing fluid is recirculated to the washing fluid tank while the 1-9 Clean polymer sediment is passed to the dryer to dry the remaining 21-2 Washing fluid from 1-9 Clean polymer.

The dryer is usually a spray dryer that dries by spraying the sediment to increases surface area and residence time in a heated chamber to allow vaporization of 21-2 Washing fluid. In some implementations, it can be other types of dryer such as centrifugal dryer or rotary dryer. They all work in a mechanism to provide high surface area and elevated temperature to allow the remaining fluid to vaporize away form the 1-9 Clean polymer solid. The 21-2 Washing fluid is collected as vapor stream at the outlet, usually but not necessarily at the top, while the 1-9 Clean polymer solid falls to the bottom of the drying chamber and is continuously fed to the next unit of molding machine to further process into 1-10 Polymer product. The gas outlet is subsequently condensed and recirculated to the washing fluid tank.

Note that the 1-3 Solid Separation block has a supporting washing fluid tank to enable recirculation and recycling of 21-2 Washing fluid to save cost and reduce environmental footprint. It serves as reservoir to supply both 35-1 Electrochemical Reactor and washer with the 21-2 Washing fluid, while collecting spent fluid from both Settler and Dryer.

1-4 Processing:

The 1-4 Processing block begins with the molding machine which works by melting the 1-9 Clean polymer powder, and then shape the 1-9 Clean polymer into desired shapes of 1-10 Polymer product. Depending on the type of 1-10 Polymer product, different molding techniques are employed. For long cylindrical shapes such as plastic straw and strings, extrusion molding is usually used. For closed hollow bodies such as bottles, blow molding is used. For some sophisticated shapes such as figurine and toys, injection molding is used. The 1-9 Clean polymer powder moved through the machine is usually but not limited to screw drive or 9-11 Conveyor belt.

The finished 1-10 Polymer product is subsequently passed onto the polymer packing unit to arrange into a package. For instance, plastic straws would be counted and assembled by machine into a defined package, such as a pack of 100, before the packaging such as a bag holding the assemble, is sealed by machine. The packages are subsequently arranged into a batch, either manually by workers or automatically by machine, and stored before each batch of truck arrival to truck the product away for delivery and sales.

1-5 Recovery:

The 1-5 Recovery block, begins with a switch valve to direct the 1-14 Spent electrolyte to 2 possible paths, depending on the type of 1-15 By-product:
a. Sorption Unit

If the 1-15 By-product is both low-value and benign, such as water, then a sorption unit can be used to strip off 1-15 By-product from 1-14 Spent electrolyte and dispose, while recycling the 1-7 Electrolyte. The sorption unit usually consists of a sorbent that isolates 1-15 By-product from the 1-14 Spent electrolyte, by either adsorption, absorption, or chemisorption. In the often case that the 1-15 By-product turns out to be water, which is both low-value and benign, the sorption unit can be a desiccator where water is absorbed by some drying agents such as calcium sulfate or magnesium sulfate. The desiccator can then be recovered afterwards, usually but not limited to heating, to release absorbed water as vapor to be discharged to environment with minimal impact.

In some implementations, the sorption unit can be replaced by other conventional device to strip 1-15 By-product of 1-14 Spent electrolyte, including blow/spray dryer where the stream Is sprayed against hot air such that the 1-15 By-product vaporizes away.

b. By-Product 1-5 Recovery

If the 1-15 By-product is some 5-5 Feedstock Chemicals to be recovered, such as 6-9 Ammonia or some alcohols, which has both resale value and adverse impact to environment, the by-product 1-5 Recovery, though usually being more costly than sorption unit is used to recover the 1-15 By-product for resale instead of 36-1 Discharge.

The by-product 1-5 Recovery path begins with a solvent extractor where the 1-14 Spent electrolyte, with the 1-15 By-product to be isolated, is fed into the solvent extractor, while a solvent with selective solubility to the 1-15 By-product flow into another inlet. While in many cases, the incoming solvent and incoming 1-14 Spent electrolyte are usually in countercurrent flow figuration for better isolation efficiency, in some other implementations a crossflow or parallel flow is used to suit the specific situation.

The solvent extractor usually also involves mixing between 1-14 Spent electrolyte and solvent phase via stirrer driven by motor/engine. In some implementations, the motor and engine need not be connected physical to the vane by shaft, instead can induce vane movement through indirect influence such as magnetic field similar to a 68-5 Magnetic stir bar, in some cases the magnetic field change can be induced by inductor system such that not even motor/engine is needed. In some implementations, stirring can be done without mechanical method of motor or engine, such as using ultrasound to vibrate the molecules, or by multiple corners and barrier to create turbulence in a static mixer for the species to mixed uniformly, or by bubbling gas into the liquid phase to induce mixing. In some other implementations, turbulence is created between 1-14 Spent electrolyte and solvent phase, by insertion of barriers or 7-6 Piping setup to collide 1-14 Spent electrolyte and solvent flow against each other, to enhance mixing.

The resulting solvent, enriched with the 1-15 By-product, then exits the solvent extractor into a distillation column to separate the 1-15 By-product from the solvent. The distillation column is usually a column, or a tower, with either distillation packing or distillation trays/plates. There is a reboiler at the bottom to provide the necessary 1-11 Heat for distillation, and a condenser at the top. While the reboiler is usually a heater, in some implementations the reboiler is other means of heating such as heat exchanger with hot steam, hot water or hot oil as heating fluid. While the condenser is usually a heat exchanger with a cooling fluid such as water, in some implementations it can also be a cooler instead.

However, where the solvent and 1-15 By-product come out of the distillation column depends on their boiling point relative to each other warranting a very unique distillation column setup at 5-1 elerGreen Process, where there is flexible 7-6 Piping of top and bottom. First of all, the top outlet of the column produces the enriched low key component, namely the species with the lower boiling point while the bottom outlet produces the enriched high key component, namely the species with the higher boiling point. While in many cases the solvent is the low key component exiting at the top and 1-15 By-product is the high key component exiting from the bottom, in some other cases it is the opposite, namely the solvent exiting from the bottom while the 1-15 By-product exiting at the top.

At the top outlet, there is a switch valve that directs the top to either of 2 paths:
a. If the top is 1-15 By-product, the top Is directed to a switch valve leading to the 1-15 By-product tank
b. If the top is solvent, it is directed to another switch valve leading to solvent extractor.

At the bottom outlet also, there is yet another switch valve that directs the bottom to either of 2 paths:
a. If the bottom is 1-15 By-product, the bottom is directed to a switch valve leading to the 1-15 By-product tank
b. If the bottom is solvent, it is directed to another switch valve leading to solvent extractor.

The 1-15 By-product is then stored in a container, usually a tank, for sale. The 1-15 By-product tank is regularly piped to a chemical tank truck to be delivered for sales. The solvent is then recycled to the solvent extractor for continuous 1-5 Recovery process.

Also depending on efficacy of separation of 1-15 By-product, the 1-15 By-product 1-5 Recovery can also be other separation unit operations, such as dialysis, filtration, precipitation, based on the properties and interactions of 1-15 By-product and 1-7 Electrolyte. The 1-7 Electrolyte stripped of 1-15 By-product, for either path of sorption unit or by-product 1-5 Recovery, then merges at another switch valve before being recycled back to the mixing tank.

Implementation and 7-6 Piping

As outlined in FIG. 40, the 7-6 Piping consists of 40-1 Process Flow Diagram and Auxiliary Units, 40-2 Piping Types, 40-3 Pumps/Compressor, 40-4 Heater/Cooler, 40-5 Utility and finally 40-6 Valves.

40-1 Process Flow Diagram and Auxillary Units

40-1 Process Flow Diagram and Auxiliary Units for the 7-5 Process implementation is detailed in FIG. 41. The following are the pieces of equipment for implementation of the chemical 7-5 Process:

The 7-5 Process begins with the Feed Tank A, T-01A. The Feed Tank A has a feed inlet, usually but not necessarily on the top of the tank, where supplier trucks can deliver 68-1 Material A by a 7-6 Piping. The tank also has a drain, usually but not necessarily at the bottom of the tank, to drain off 68-1 Material A for contingency purposes such as 59-3 Maintenance and troubleshooting, Stream 1A, containing mostly component A, exits T-01A to enter Mixing Tank, M-02, and its flowrate is controlled by an inline valve, V-01A.

In some implementations, another feedstock such as 68-2 Material B is needed. In this case, there is another Feed Tank 8, T-01B, in parallel to the Feed Tank A, T-01A. Similar to Feed Tank A, the Feed Tank B has a feed inlet, usually but not necessarily on the top of the tank, where supplier trucks can deliver 68-2 Material B by a 7-6 Piping. The tank also has a drain, usually but not necessarily at the bottom of the tank, to drain off 68-2 Material 8 for contingency purposes such as 59-3 Maintenance and troubleshooting. Stream 1.8, containing mostly component 8, exits T-01B to enter Mixing Tank, M-02, and its flowrate is controlled by an inline valve, V-01B.

In some Implementations, especially the complex copolymerization reactions, even more types of feedstock such as material C, D, E, and even F is needed. For these cases, the 7-5 Process simply involves addition of these feed tanks in parallel to Feed Tank A, T, 01A. The 7-6 Piping and connecting structure is similar to those in Feed Tank A and Feed Tank B, just by replacing the species and label with C, D, E, F, and so on.

The first auxiliary support unit is Cosolvent Drum, D-00A. The 31-1 Cosolvent, unlike the feedstocks, depletes in more gradual way, thus storage drum, which is smaller and cheaper than a tank, is used. While an inlet can be installed to deliver the 31-1 Cosolvent by supplier tank, it may not be required due to the smaller holdup. Like the tanks, the drum also has a drain, usually but not necessarily at the bottom of the drum, to drain off 31-1 Cosolvent for contingency purposes such as 59-3 Maintenance and troubleshooting. Stream 0A, containing mostly component Y, the 31-1 Cosolvent, exits D-00A to enter Mixing Tank, M-02, and its flowrate is controlled by an inline valve, V-00A.

Another auxiliary support unit is Additive Drum, D-00B. The 32-1 Additives, like the 31-1 Cosolvent and unlike the feedstocks, depletes in more gradual way, thus storage drum, which is smaller and cheaper than a tank, is used. While an inlet can be installed to deliver the 32-1 Additives by supplier tank, it may not be required due to the smaller holdup. Like the tanks, the drum also has a drain, usually but not necessarily at the bottom of the drum, to drain off 32-1 Additives for contingency purposes such as 59-3 Maintenance and troubleshooting. Stream 0B, containing mostly component 2, the 32-1 Additives, exits D-00B to enter Mixing Tank, M-02, and its flowrate is controlled by an inline valve, V-00B.

The mixing tank, M-02, has inlets from Stream 1A, 1B, 0A, and 0B as previously described. In addition, there is another inlet, Stream 2R as recycled 1-7 Electrolyte stream, where the details would be described in electrolyte 1-5 Recovery. There is mechanism to mix the Stream 1A, 1B, 0A, 0B and 2R, usually but not necessarily by mechanical means such as a stirrer driven by motor or engine. In some implementations, the mixing can be done non-mechanically and/or non-stirring such as by bubbling the vessel using air, or using ultrasound to induce liquid mixing by molecular vibration.

Mixed 1-7 Electrolyte exits the mixing tank, M-02, as Stream 2, containing components A, B, S, Y and 2, where component S is the 68-3 Dissolved Salt/solute. The temperature of Stream 2 is controlled by an inline heater, H-02. In some implementations, the heater can be replaced by other means to control temperature of a stream, such as heat exchanger, or even cooling unit if reduction in temperature is desired. On the other hand, the 1-12 Pressure of Stream 2 is controlled by an inline compressor, Q-02, with its flow rate controlled by an inlet valve, V-02. In some implementations, the compressor can be replaced by a pump to reduce cost. The flow direction of Stream 2, whether flowing to the 1-2 Conventional Reactor, CR-03A, or the 35-1 Electrochemical Reactor, ER-04, is then determined by an inline switch valve, S-03A, which is usually but not necessarily designed such the flow are mutually exclusive, meaning Stream 2 can only flow to either 1-2 Conventional Reactor, CR-03A, or 35-1 Electrochemical Reactor, ER-04, one at a time but not both at the same time. In some implementations, the switch valve can be replaced by a three-way valve to enable parallel operation of conventional and electrochemical units, especially when 34-3 Retrofitting is Involved, to minimize operation disruptions, which would lead to interruption of revenue generation, in 34-3 Retrofitting conventional polymer plants.

For 42-1 Conventional Reaction Stream as highlighted in FIG. 42, after passing through switch valve 5-03A, Stream 2 enters the 1-2 Conventional Reactor CR-03A, where polymerization reaction is induced under 1-11 Heat and 1-12 Pressure to form 1-8 Polymer P and 1-15 By-product H. Depending on the 7-5 Process conditions, 7-5 Process safety measures may be imposed on the 1-2 Conventional Reactor, such as pressure-resistant 1-2 Conventional Reactor wall, and cooling fluid (usually but not necessarily water) jacket to avoid overheating. There may also be a 1-12 Pressure relief valve that opens to release avoid bursting when the 1-12 Pressure becomes too high for any reason. While the 1-2 Conventional Reactor is a stirred tank 1-2 Conventional Reactor where mixing is induced mechanically by stirrer driven by motor/engine, mixing can be induced by other methods such as ultrasound to induce molecular vibration and bubbling gas into the liquid mixture.

The reacted mixture, Stream 3A, containing residual 68-1 Material A, B, 68-3 Dissolved Salt/solute S, 31-1 Cosolvent Y, 32-1 Additives 2, as well as formed 1-8 Polymer P and 1-15 By-product H, then exits 1-2 Conventional Reactor CR-03A. The 1-12 Pressure may drop substantially upon exiting the 1-2 Conventional Reactor, thus is bumped up again by a pump P-03A, while the flow of Stream 3A is controlled by a valve V-03A. The Stream 3A then enters a filter, CF-03B, via 42-2 Conventional Solid Stream, where the solid 1-8 Polymer P is filtered from the reacted mixture. The remaining of the mixture, Stream 3B, then exits the filter CF-03B as 42-3 Conventional Mixture Stream to pass through switch valve 5-03B.

For the alternative 43-1 Electrochemical Reaction Stream as highlighted in FIG. 43, after passing through switch valve S-03A, Stream 2 enters the 35-1 Electrochemical Reactor ER-04 instead, where polymerization reaction is induced under 6-5 Applied Voltage (under 1-11 Heat and 1-12 Pressure if necessary, though usually not needed) to form 1-8 Polymer P and 1-15 By-product H. Depending on the 7-5 Process conditions, 7-5 Process safety measures may be imposed on the 35-1 Electrochemical Reactor, such as cooling fluid (usually but not necessarily water) jacket to avoid overheating. There may also be a 9-17 Gas Removal to collect gas evolved from secondary reactions, such as hydrogen and oxygen gases from water splitting, usually when water is a significant component of the mixture. While mixing can be brought about by the relative movement of the electrode surface against the 1-7 Electrolyte fluid itself, additional mixing can be imposed by mechanical stirrer driven by motor/engine, or non-mechanically by ultrasound or bubbling gas.

For the 35-1 Electrochemical Reactor, the 9-17 Gas Removal setup begins with intake of ambient air in Stream 4L, comprised of mostly air U into the 35-1 Electrochemical Reactor volume, and gas outlet of the 35-1 Electrochemical Reactor as Stream 4H, comprises of mostly air U and some evolved gas G from the reaction. A blower B-04 is used to drive Stream 4H by blowing action to fumehood, while driving Stream 41 by suction action from ambient air.

The formed 1-8 Polymer P is recovered in the gas phase of the 35-1 Electrochemical Reactor, to be sent into washing stage via 43-2 Electrochemical Solid Stream. There is an 21-4 Washing fluid inlet from the Washing Fluid Tank T-58 to flow into the 35-1 Electrochemical Reactor ER-04, controlled by valve V-04, to flush the removed 3-5 Solid Deposit of 1-8 Polymer P as suspension in the 21-2 Washing fluid, which exits the 35-1 Electrochemical Reactor ER-04 via 21-5 Washing fluid outlet and passes through switch valve S-04 as Stream 4. Stream 4, comprised of mostly 21-2 Washing fluid (usually but not limited to water) and the solid 1-8 Polymer P suspension, then enters into Washer WP-05A. The conventional path on the other hand, would also pass through the switch valve S-04 to converged into the same washing stage as electrochemical path.

At the Washer WP-05A, other than the inlet Stream 4 previously mentioned, there is also an inlet of 21-2 Washing fluid Stream 5B, comprised of mostly 21-2 Washing fluid W, with flow rate controlled by an inline valve V-05B. While the washer is usually but not limited to a mixer with the stirrer driven by motor/engine, mixing can also be induced by other methods such as ultrasound to induce molecular vibration and bubbling gas into the liquid mixture. The washing action is induced by the mixing between solid suspension of 1-8 Polymer P and the 21-2 Washing fluid W, where the adsorbed or absorbed 1-14 Spent electrolyte dissolved from the 1-8 Polymer P particle into the 21-2 Washing fluid W. The outlet is Stream 5A, comprised of suspended 1-8 Polymer P but with only trace (acceptable level) adsorbed/absorbed 1-14 Spent electrolyte, and 21-2 Washing fluid with trace 1-14 Spent electrolyte dissolved, with the flow rate controlled by an inline valve V-05A.

Stream 5A subsequently enters the Settler SP-06 to further separate the solid 1-9 Clean polymer P from the 21-2 Washing fluid W. The settler is usually but not necessarily a vessel with large holdup to allow the 1-9 Clean polymer P suspension to settle to the bottom of the tank, thus separating the 1-9 Clean polymer P from 21-2 Washing fluid W by gravity. In a usual but not necessary setup, the 21-2 Washing fluid W outlet is at top of the tank while the 1-9 Clean polymer P outlet is at the bottom of the tank, corresponding to their region of enrichment by gravity. In some implementations, some 32-1 Additives as coagulation agents are used. The 21-2 Washing fluid W, as Stream 6B, is subsequently recirculated back into the Washing Fluid Tank T-05B. For Stream 6B, the flow rate is controlled by an inline valve V-06B, and a pump P-06B is usually needed to bump up the 1-12 Pressure because the 21-2 Washing fluid 1-12 Pressure is low for being at the top of the tank. The 1-9 Clean polymer P, thickened by the settling action, is then passed as Stream 6A into the Dryer DP-07, with flow rate controlled by an inline valve V-06A.

At Dryer DP-07, the Stream 6A, comprised of mostly 1-9 Clean polymer P suspension and some 21-2 Washing fluid, is heated and sprayed in the drying chamber. The heating can be performed before the spraying, or by blowing hot gas/air in the drying chamber, or both. The drying chamber simply refers to the volume of the dryer vessel where sufficient height is usually allocated for the 21-2 Washing fluid W to evaporated from the 1-9 Clean polymer particle P as the mixture falls through the drying chamber. The drying chamber has an outlet, usually but not necessarily at the top of the chamber, to collect vapours of evaporated 21-2 Washing fluid Stream 7B, with flow rate controlled by an inline valve V-07B. Stream 7B subsequently is condensed into liquid form at condenser X-07B, usually but not limited to a heat exchanger (can be a cooler instead in some implementations). The condensed Stream 7B, like Stream 6B, is subsequently recirculated back into the Washing Fluid Tank T-05B. The dried 1-9 Clean polymer P is collected at the bottom as 1-9 Clean polymer powder, to be delivered mechanically as Stream 7A to the molding machine.

At the molding machine MP-08, Stream 7A, comprised of mostly dry 1-9 Clean polymer P powder, is conveyed mechanically, usually but not limited to continuously fashion, into the die of the molding machine. The molding machine applies 1-11 Heat to melt the 1-9 Clean polymer powder P to form it in desired shape of 1-10 Polymer product. Depending of the desired shape, different molding techniques can be used. For instance, blow molding for bottle or closed container, extrusion molding for long cylindrical shapes such as plastic strings and straws, and injection molding for non-hollow shapes. Note that these are the general guideline but not totally restrictive, such as in some instances of short cylindrical shapes, both extrusion and injection molding ae applicable. The formed 1-10 Polymer product, made of 1-8 Polymer P, is then conveyed mechanically as Stream 8 into the Polymer Packing unit PP-09.

At Polymer Packing PP-09, the formed 1-10 Polymer product is arranged and packaged, usually but not limited to means of automated mechanical arms (cheaper options could be to hire workers to arrange and package manually). The pack of 1-10 Polymer product is then stored as a batch of inventory waiting to be trucked to be sold.

An auxiliary unit is the Washing Fluid Tank T-05B, serving as the reservoir for 21-2 Washing fluid recirculation. In case of water as 21-2 Washing fluid, it has an inlet, usually but not necessarily located at top of the tank, of 40-5 Utility water as Stream 5H, with the flow rate controlled by an inline valve V-05H. It also has a discharge outlet Stream 5L, usually but not necessarily located at the bottom of the tank, with flow rate controlled by an inline valve V-05L and backflow prevented by check valve C-05L. The 21-2 Washing fluid is supplied from the Washing Fluid Tank T-05B into the Washer WP-05A via Stream 5B as previously mentioned. Recirculation from Stream 6B and Stream 7B, is also involved to reduce cost and environmental impacts of the 7-5 Process.

There is also another auxiliary unit, which is the cooling fluid system from the centralized cooling fluid drum D-16. 40-5 Utility fluid is fed into the cooling fluid drum D-16 as Stream 16C, with flow rate controlled by an inline valve V-16C. Like the tanks, the drum also has a drain, usually but not necessarily at the bottom of the drum, to drain off cooling fluid for contingency purposes such as 59-3 Maintenance and troubleshooting. The first outlet is Stream 7C, with flow rate controlled by an inline valve V-07C into the condenser X-07B to provide cooling action for condenser. The second outlet is

Stream 13D, with flow rate controlled by an inline valve V-13D, into the condenser X-13C to provide cooling action for condenser. Both streams 7C and 13D then merged into one Stream 16A into the heat exchanger X-16A, before being recirculated back to the cooling fluid drum D-16. The heat exchanger X-16A serves to cool the fluid, usually by means of cooling with air. The ambient air is blown as Stream 16B, with flow rate controlled by an inline valve V-16B, and the heated air effluent is discharged back to the ambient air.

The 1-14 Spent electrolyte, Stream 3B, containing residual 68-1 Material A, B, 68-3 Dissolved Salt/solute 5, 31-1 Cosolvent Y, 32-1 Additives Z, and 1-15 By-product H, then exits 35-1 Electrochemical Reactor ER-04 to pass through switch valve 5-03B via 43-3 Electrochemical Mixture Stream.

From either conventional or electrochemical path, Stream 3B then enters a pump P-03B to have its 1-12 Pressure bumped up (because usually the 1-12 Pressure drops to very low after exiting either of 1-2 Conventional Reactor or 35-1 Electrochemical Reactor), with its flow controlled by valve V-03B. The flow direction of Stream 3B, whether flowing to the sorption unit SB-10A or the solvent extractor XB-11, is then determined by an inline switch valve, S-10A, which is usually but not necessarily designed such the flow are mutually exclusive, meaning Stream 3B can only flow to either the sorption unit SB-10A or the solvent extractor XB-11, one at a time but not both at the same time. In some implementations, the switch valve can be replaced by a three-way valve to enable parallel operation of sorption unit and solvent extractor, especially when 34-3 Retrofitting is involved, to minimize operation disruptions, which would lead to interruption of revenue generation, in 34-3 Retrofitting conventional polymer plants.

For 45-1 Sorption Stream as highlighted in FIG. 45, after passing through switch valve S-10A, Stream 38 enters the sorption unit SB-10A, where the 1-15 By-product H is isolated from the 1-14 Spent electrolyte, and onto the sorbent, usually via either absorption or adsorption. The sorbent is simply a solid of suitable material, including but not limited to silica or alumina to absorb/adsorb water. The sorbent can either be replaced in batches during 59-3 Maintenance, or be replaced in continuous operation. The recovered 1-7 Electrolyte exits sorbent unit SB-10A and then passes through the switch valve S-10B to Stream 11B.

For continuous operation, the sorbent is attached onto a 9-11 Conveyor belt unit in and out between the sorbent unit SB-10A and the sorbent regenerator SR-10B. Stream 10A, containing mostly the sorbent V and the absorbed/adsorbed 1-15 By-product H, is fed into the sorbent regenerator SR-10B. The sorbent regenerator SR-10B usually but not necessarily work by heating the sorbent material strongly to release the adsorbed 1-15 By-product H. The released 1-15 By-product H is then released into ambient air if it is benign, such as water vapour. In some implementation, the released 1-15 By-product H is first scrubbed, such as when it is 6-9 Ammonia, before being released to ambient air. Stream 10B, consisting of mostly recovered sorbent V, is then recycled into the sorption unit SB-10A.

For 44-1 Solvent Extraction Stream as highlighted in FIG. 44, after passing through switch valve S-10A, Stream 3B enters the solvent extractor XB-11, where the 1-15 By-product H is isolated from the 1-14 Spent electrolyte, and onto the solvent phase. The solvent phase enters as Stream 13B, that consists of mostly solvent X. There is an inline pump P-13B to bump up the 1-12 Pressure before entering solvent extractor XB-11, with the flow rate controlled by a valve V-13B. The solvent phase exits as Stream 11A, comprised of mostly the solvent X and the 1-15 By-product H, with the flow rate controlled by valve V-11A. The recovered 1-7 Electrolyte exits solvent extractor XB-11 and then passes through the switch valve S-10B to Stream 11B.

For solvent extractor, there is a n auxiliary support unit, the solvent drum D-12 to regulate the solvent holdup level. The solvent, unlike the feedstocks, depletes in more gradual way, thus storage drum, which is smaller and cheaper than a tank, is used. While an inlet can be installed to deliver the solvent by supplier tank, it may not be required due to the smaller holdup. Like the tanks, the drum also has a drain, usually but not necessarily at the bottom of the drum, to drain off solvent for contingency purposes such as 59-3 Maintenance and troubleshooting. Stream 12A from solvent drum D-12, comprised of mostly solvent X, enters the solvent extractor XB-11, with flow rate controlled by valve V-12A, while backflow is prevented by check valve C-12A. The excess solvent as Stream 12B, comprised of mostly solvent X, with flow rate controlled by valve V-12B and backflow prevented by check valve C-12B, exits the solvent extractor XB-11 and enters solvent drum D-12.

At the solvent extraction path, there is also a distillation column DB-13 downstream of the solvent extractor XB-11 to purify the 1-15 By-product H while recycling the solvent X. Stream 11A, comprised of mostly solvent X and 1-15 By-product H, enters distillation column DB-13 from solvent extractor XB-11. The distillation column consists of a tower of material, usually but not limited to either distillation packing or distillation trays.

At the bottom of the distillation column DB-13, there is a reboiler H-13L, usually a heater (but not necessarily, can be a heat exchanger instead) to heat up the column with the fluid inside. The bottom stream is split into 2 streams, one enters the reboiler H-13L while another passes through a switch valve S-13L Stream 13L is heated by the reboiler H-13L so it could subsequently pass the 1-11 Heat into distillation column DB-13, with the flow rate controlled by valve V-13L. Another stream passes through the switch valve S-13L subsequently is directed into either of the 2 paths, to switch valve 5-13B or to switch valve S-13A. When it is directed to switch valve S-13B, it would be recycled to the solvent extractor XB-11, as Stream 13B, where the 1-12 Pressure would be bumped up by pump P-13B and flow rate controlled by valve V-13B as previously mentioned and illustrated by 46-2 Bottom-to-solvent Stream in FIG. 46. When it is directed to switch valve S-13A, it would enter the by-product tank TB-14 as Stream 13A to be stored, with flow rate controlled by valve V-13A, illustrated by 47-2 Bottom-to-tank Stream in FIG. 47.

At the top of the distillation column DB-13, there is a condenser X-13C, usually a heat exchanger (but not necessarily, can be a cooler instead) to cool down the column with the fluid inside. The top stream, Stream 13C, comprised of mostly 1-15 By-product, after passing through the condenser X-13C, is split into 2 streams, one re-enters the distillation column DB-13 while another passes through a switch valve S-13H. Stream 13H has its flow rate controlled by valve V-13H before being recycled to the distillation column DB-13. Another stream passes through the switch valve S-13H subsequently is directed into either of the 2 paths, to switch valve S-13B or to switch valve S-13A. When it is directed to switch valve S-13B, it would be recycled to the solvent extractor XB-11, as Stream 13B, where the 1-12 Pressure would be bumped up by pump P-13B and flow rate controlled by valve V-13B as previously mentioned and illustrated by 47-1 Top-to-solvent Stream in FIG. 47. When it is directed to switch valve S-13A, it would enter the by-product tank TB-14 as Stream 13A to be stored, with flow rate controlled by valve V-13A, illustrated by 46-1 Top-to-tank Stream in FIG. 46.

The by-product path ends with the By-Product Tank, TB-14. The By-Product Tank TB-14 has an outlet, usually but not necessarily on the bottom of the tank, where the 1-15 By-product H can be loaded via 7-6 Piping onto a truck for sale. The outlet also serves as a drain to drain off 1-15 By-product for contingency purposes such as 59-3 Maintenance and troubleshooting.

The recovered 1-7 Electrolyte, after passing through switch valve S-10B, then combines with Stream 15B from Reservoir Tank T-15 to merge into Stream 11B. The Reservoir Tank T-15 serves to regulate the level of the mixer M-02. The tank also has a drain, usually but not necessarily at the bottom of the tank, to drain off 68-1 Material A for contingency purposes such as 59-3 Maintenance and troubleshooting. Stream 15B exits the Reservoir Tank T-15, usually (but not necessarily) from bottom of the tank, with flow rate controlled by an inline valve V-15B and backflow prevented by check valve C-15B. The inlet of the tank is Stream 15A, usually (but not necessarily) from the top of the tank, with flow rate controlled by V-15A and backflow prevented by check valve C-15A.

The Stream 11B, after being merged to form, has the 1-12 Pressure bumped up (because 1-12 Pressure would likely drop to very low after consecutive unit operations) by a pump P-11B, with its flow rate controlled by valve V-11B. After that, Stream 11B would split into Stream 15A to be recycled into Reservoir Tank T-15, and Stream 2R to be recycled into the mixing tank M-02. Stream 2R would have its flow rate controlled by valve V-02R, with backflow prevented by check valve C-02R. This closes the recycle loop of 1-7 Electrolyte to ensure cost efficiency and low environmental footprint of the 7-5 Process.

40-2 Piping Types

in streams where the temperature is high or low, thermal insulation is implemented. It is usually a layer of material with low thermal conductivity, wrapped around the outer wall of the relevant pipe section. For the process of interest, insulation is used for Stream 2 between H-02 to 35-1 Electrochemical Reactor ER-04 and CR-03A, Stream 13C between DB-13 to S-13H, Stream 13H between X-13C to DB-13, Stream 13L between DB-13, H-13L and S-13L.

On the other hand, the equipment can also be insulated. CR-03A, DP-07, DB-13, MP-08, SB-10A, SR-10B may need to be insulated. In some implementation, 35-1 Electrochemical Reactor ER-04 can be insulated. Note that the above is an embodiment of the process, while the rest of the equipment can also be insulated as necessary when it involves higher temperature operation.

Mechanical line is used when there is transfer of solids involved, in powder or well-defined shapes. In some implementations, the mechanical line is a 9-11 Conveyor belt setup to transfer powder or solid continuously. In some implementations, the mechanical line can comprise of a worm drive or robotics. The rate of such transfer largely depends on the rate of which the mechanical line is driven, such as the rate of rotation of the wheels of the 9-11 Conveyor belt. For the process of interest, mechanical line is used for Stream 7A and Stream 8, respectively consist of 1-9 Clean polymer powder and 1-10 Polymer product. On the other hand, Stream 10A and Stream 10B also consists of mechanical lines.

40-3 Pumps/Compressor

For the electrochemical production 5-1 elerGreen Process, 40-3 Pumps/Compressor are generally deployed when high 1-12 Pressure or flow rate at a stream is desired.

For 7-5 Process safety in many 40-3 Pumps/Compressor, 2 of 40.6 Valves are placed to a pump; one valve upstream before the 40-3 Pumps/Compressor and another one downstream after the 40-3 Pumps/Compressor. The valve is usually the valve being controlled, while the valve before is usually in full-open form. The controlled valve has to be at after the pump because controlling the valve before the pump could lead to insufficient fluid while pumping, resulting in cavitation that would damage the pump. In some implementation, the said upstream valve can be omitted to save process cost without significantly jeopardizing the process safety.

In some implementations, compressor is used in place of a pump, especially when the 1-12 Pressure needs to be high. For instance, the 1-12 Pressure of Stream 2 is controlled by an inline compressor, Q-02. In some other implementations, the compressor can be replaced by a pump to reduce cost.

Pump is used as P-03A, P-03B, P-06B, P-11B, P-13B. P-03A is used to bump up pressure of stream 3A, which may have dropped substantially upon exiting the either of Conventional Reactor or 35-1 Electrochemical Reactor. P-03B is used to bump up pressure of stream 3B, because usually the 1-12 Pressure drops to very low after exiting either of 1-2 Conventional Reactor or 35-1 Electrochemical Reactor). P-06B is used to bump up the 1-12 Pressure of stream 6B because the 21-2 Washing fluid 1-12 Pressure is usually low for being at the top of the tank. P-11B is used to bump up pressure of Stream 11B, because 1-12 Pressure would likely drop to very low after consecutive unit operations). P-13B is used to bump up the 1-12 Pressure before entering solvent extractor XB-11, to provide the necessary pressure to pass through the many stages solvent extractor that would incur huge pressure drop.

In some implementation, additional pumps can be added to streams where increasing pressure or flow rate is needed. This is due to process safety consideration that when the pressure of a liquid is below its boiling point at any part of the streams, the part would undergo cavitiation, where the liquid vaporizes. Cavitation is undesirable because the vaporization and condensation of liquids in the streams would lead to pressure fluctuation that damages the system, such as pipes and 40-6 Valves being deformed or ruptured after being commissioned for long period of time.

Blower is the type of pump used to drive stream consisting of gas. Blower is used in B-04 and B-16B, to respectively suck air together with evolved gas to the 9-17 Gas Removal, and to blow the air to air-cool the cooling fluid stream for recycling.

40-4 Heater/Cooler

1-11 Heat can come in different forms: heater, steam, heat exchanger. Heater can come in various form, including but not limited to electric heater and combustion heater. In some Implementations, alternative can include solar or geothermal heater.

For the process of interest, heater is used as H-02, and H-13L, to respectively pre-heat Stream 2 for 1-2 Conventional Reactor CR-03A and heat up Stream 13L to facilitate distillation. H-13L is also commonly known as a reboiler, because it is located at the bottom of the distillation column DB-13, to heat up the mixture for distillation. In some implementation, any of H-02 and H-13L can be replaced by heat exchanger with heating fluid to perform similar heating function.

There is also a built-in heater for DP-07 to heat up Stream 6B to facilitate drying of the 1-9 Clean polymer and SR-10B to heat the sorbent to remove by-product from the sorbent. In some implementations, the heater can be replaced by other means to control temperature of a stream, such as heat exchanger. In some implementation, any of 1-2 Conventional Reactor CR-03A or 35-1 Electrochemical Reactor ER-04 can come in built-in heating unit.

Steam is also commonly employed as heating means, especially in some regions of cold climate where steam heating is supplied as household 40-5 Utility. While conventional steam heating 40-5 Utility is possible, in some implementations the steam heating is used in process-specific heat exchanger.

Heat exchanger, on the other hand, can be used for either heating or cooling, depending respectively on whether the heat exchange fluid is hotter or cooler than the stream. The cooling fluid is usually but not limited to 40-5 Utility water due to its low cost and low environmental footprint. In some implementation, the cooling fluid can be other fluid such as ammonia or heating oil, depending on process requirements. For the process of interest, heat exchangers X-07B, X-13C, and X-16A are used as cooler to condense respectively Stream 7B, Stream 13C, and Stream 16A. For X-07B, the cooling fluid, usually but not limited to 40-5 Utility water, is used to cool and condense the 21-2 Washing fluid vapor Stream 7B from the Dryer DP-07. For X-13C, the cooling fluid, usually but not limited to 40-5 Utility water, is used to cool and condense the distillation vapor at the top of distillation column DB-13, Stream 13C as reflux condenser. For X-16A, the cooling fluid, usually but not limited to 40-5 Utility water, is used to cool the cooling fluid Stream 16A before being recirculated to cooling fluid drum D-16.

If low temperature is needed, cooler cay be used instead of heater. Cooler can come in various form, including but not limited to cooling tower, refrigerator or heat exchanger. For cost consideration, the process of interest used heat exchanger as the means of cooling for its lower energy cost than refrigerator. Cooler can also be used for process safety purpose to prevent overheating of equipment. In some implementations, the 1-2 Conventional Reactor CR-03A has a built-in cooling jacket to prevent overheating. In some Implementation, 35-1 Electrochemical Reactor ER-04 can similarly have cooling jacket installed to the vessel wall.

40-5 Utility

40-5 Utility consists of 40-5 Utility power, 40-5 Utility water and other 40-5 Utility.

40-5 Utility power, usually in the form of electricity, is essential to power the entire process. It is needed to power many pieces of equipment in the process, including CR-03A, 35-1 Electrochemical Reactor ER-04, CF-03B, M-02, WP-05A, DP-07, MP-08, PP-09, SR-10B, XB-11, DB-13. For instance, 35-1 Electrochemical Reactor not only requires electricity to drive the electrochemical polymerization reaction, but also mechanical parts such as 4-1 Moving electrode, fumehood blower 8-04, and 9-14 Movable support if applicable. 40-5 Utility power is also needed to power the 40-3 Pumps/Compressor, the 40-4 Heater/Cooler and the process control system.

40-5 Utility water on the other hand has many usages, including as heat transfer fluid and as 21-2 Washing fluid. For the process of interest, 40-5 Utility water can be used as 21-2 Washing fluid to wash 1-8 Polymer into 1-9 Clean polymer, or as cooling fluid T in heat exchangers, due to its availability, low cost, and low environmental impact for either purpose. In some implementations, 21-2 Washing fluid and cooling fluid does not necessarily have to be water. For example, organic 21-2 Washing fluid can be used such as ethanol, while alternative cooling fluid can include 6-9 Ammonia which also has high specific heat capacity.

Other utilities include the said non-water heat transfer fluid and non-water 21-2 Washing fluid, but also include any other form of 40-5 Utility. Heating steam, which is available in region of cold climate for domestic heating, is considered as other utilities. Another type of common other 40-5 Utility include fuels supplied from a 40-5 Utility pipeline, such as methane gas for combustion heating. In some implementations, some miscellaneous fluids such as nitrogen gas or other chemicals, either liquid or gas, is supplied via 40-5 Utility pipeline for process specific purpose such as purging a pipe of a stream.

40-6 Valves

There are different types of 40-6 Valves used. For the process of interest, the 40-6 Valves used include on/off valve, control valve, switch valve and check valve.

On/off valve is used instead of control valve for cost-saving consideration, at streams where the flow rate does not need to be controlled. For the process of interest the on/off valves are used at bottom drainage of containers such as in bottom drain of D-00A, D-00B, T-01A, T-01B, T-15, D-12, TB-14, D-16. This is when draining a container, precise control of flow rate is usually not a consideration, while the goal is more commonly to empty the liquid content of the container. Considering the relatively huge volume of container compared to the draining flow rate, it is also possible for operator to drain continuously without flow rate control, then turn off the on/off valve at desired container level, in situations where partial draining of the container is desired. On the other hand, PP-09 has no drain because it is solid 1-10 Polymer product, and rather it is loaded mechanically (manual or robotic to a vehicle.

In some implementations, the on/off valve at the said positions can be replaced with control valves when more precise control of flow rate of the stream is involved. Control valves are 40-6 Valves designed to have more precise control of partial closures, to control the flow rates via such partial closures to achieve desired flow. The degree of partial closure can be controlled manually by operator on site, or remotely by a centralized control system. Due to the need to control the flow rate precisely in many streams of the process, control valves are used extensively, namely, V-00A, V-00B, V-01A, V-01B, V-02R, V-02, V-03A, V-03B, V-05B, V-04, V-05A, V-06A, V-06B, V-05H, V-05L, V-07B, V-07C, V-11A, V-11B, V-13B, V-13H, V-13L, V-13A, V-15A, V-15B, V-13D, V-16B, V-16C, where the numbering corresponds to the stream number to have its flow rate controlled.

In some streams, check valves are installed to prevent backflow that could lead to contamination. Check valves is used for streams where backflow is possible and with consequence to the process, especially C-02R, C-05L, C-12A, C-12B, C-13A, C-13B, C-15A, C-15B. These check valves are used to respectively prevent backflow of the corresponding stream number, namely recycling stream 2R, washing fluid tank discharge Stream 5L, Solvent Drum D-12 outlet Stream 12A, Solvent Drum D-12 inlet Stream 12B, By-product tank TB-14 inlet Stream 13A, Solvent extractor XB-11 solvent inlet Stream 13B, and electrolyte reservoir T-15 inlet Stream 15A, and electrolyte reservoir T-15 outlet Stream 15B. In some implementations, additional check valves can be added to other streams for extra process safety, albeit at additional cost of such extra check valves.

Switch valves are generally used to control a three-way flow in certain direction. It can be used to direct a flow, especially in a mutually exclusive way, such that it can only flow to 1 path at a time, but not both at the same time. The switch valves used include S-03A, S-03B, S-10A, S-10B, 5-13H, S-13L, S-13A, 5-13B. Switch valves are used for diverging a stream to 2 different options, or for converging 2 alternative paths into the same stream. For purpose of 34-3 Retrofitting, such switch valves often occur in pair, 1 diverging and 1 converging, to complete the 34-3 Retrofitting interlock, including S-03A S-03B pair to retrofit 35-1 Electrochemical Reactor, S-10A S-10B pair to retrofit 1-5 Recovery unit, S-13H S-13L pair to reverse distillation column piping and finally S-13A S-13B pair to reverse streams between by-product and solvent.

In some embodiments, additional switch valves can be added to streams where switching between alternative stream flow is needed. In some implementations, the switch valve can be replaced by a three-way valve to enable parallel operation of 2 paths, especially when 34-3 Retrofitting is involved, to minimize operation disruptions, which would lead to interruption of revenue generation, in 34-3 Retrofitting conventional polymer plants.

Pressure relief valve is used for process safety consideration to discharge container content when the container pressure exceeds certain limit, in order to prevent container burst. For the process of interest, pressure relief valve is used for 1-2 Conventional Reactor CR-03A. In some implementations, extra pressure relief valves can be used at other containers where high pressure is involved.

Process 7-7 Control

The process 7-7 Control is outlined in FIG. 48. The process 7-7 Control is also detailed as P&ID in FIG. 49, with further explaining legend as FIG. 50. It consists of a combination of 48-1 Cascade, 48-2 Feedforward, 48-3 Feedback, 48-4 Ratio, 48-5 Split Range, 48-6 Override Select, to transfer any process disturbance to 48-7 Indicator/Alarm where the operator would respond accordingly.

48-1 Cascade

48-1 Cascade control is a method of 7-7 Control combining 2 or more feedback loops, with the output of one controller (primary controller) adjusting the set-point of a second controller. 48-1 Cascade control provides a means to coordinate between different pieces of equipment in the 7-5 Process with 48-8 Prompt Response.

FIG. 51 outlines the general 48-1 Cascade for the 7-5 Process. The overall goal of the process 7-7 Control system, for this novel 5-1 elerGreen Process, was to ensure production at desired rate, especially for the 1-8 Polymer stream. The implementation involves transferring the disturbance to other parts in consecutive manner, until the eventual place where disturbance is acceptable as the “48-14 Reservoir for Disturbance”. The “48-14 Reservoir for Disturbance” is usually the tank level and energy consumption, which translates to consumption rate of materials and 40-5 Utility (water and 3-1 Electricity) cost.

The set point of SIC 07A is then used as a reference to control remotely FIC 02 (via 48-6 Override Select), Flow Rate Indicator Controller of Stream 2, IIC 04 (Electric) Current Indicator Controller of 35-1 Electrochemical Reactor ER-04, FIC 13A, Flow Rate Indicator Controller of Stream 13A, FIC 01A, Flow Rate Indicator Controller of Stream 1A upstream and SIC 08 (Operating) Speed Indicator Controller of Molding Machine MP-08 downstream.

SIC 10B (Operating) Speed Indicator Controller is controlled by FIC 03B Flow Rate Indicator Controller of Stream 3B. FIC 03B, Flow Rate Indicator Controller of Stream 3B sends signals to FIC 11B, Flow Rate Indicator Controller downstream.

Other than the multiple cascade that span far upstream and downstream, 48-1 Cascade control is also used for smaller pieces of equipment:

FIC 03A, Flow Rate Indicator Controller of stream 3A controls PIC 03B Pressure Indicator Controller of Stream 3A which keeps PIT 03B Pressure Indicator Transmitter of Stream 3A at set point. PIC 03B Pressure Indicator Controller of Stream 3A is also dependent on downstream 1-12 Pressure PIT 04 Pressure Indicator Transmitter of Stream 3B, which is kept at set point by PIC 04 Pressure Indicator Controller of Stream 3B.

LIC 05A Level Indicator Controller of Washer WP-05A controls FIC 05B Flow Rate Indicator Controller of Stream 5B.

LIC 06 Level Indicator Controller of Settler SP-06 controls both FIC 05A, Flow Rate Indicator Controller of stream 5A and FIC 06B, Flow Rate Indicator Controller of stream 6B.

FIC 06A, Flow Rate Indicator Controller of stream 6A is also controlled by LIC 07 Level Indicator Controller of Dryer DP-07.

FIC 06B, Flow Rate Indicator Controller of Stream 6B also controls PIC 06B Pressure Indicator Controller of stream 6B which in turn controls the pump P-06B to keep PIT 06B Pressure Indicator Transmitter of stream 6B at set point.

FIC 11B, Flow Rate Indicator Controller of Stream 11B also controls PIC 11B Pressure Indicator Controller of stream 11B, which keeps PIT 11B Pressure Indicator Transmitter of Stream 11B at set point by controlling P-11B.

FIC 13B, Flow Rate Indicator Controller of stream 13B also controls PIC 13B Pressure Indicator Controller of stream 13B that keeps PIT 13B Pressure Indicator Transmitter of stream 13B at set point by controlling P-13B.

48-2 Feedforward

48-2 Feedforward is a method to control the 7-5 Process parameter by measuring input and making adjustment accordingly, with advantage of 48-9 Precision. 48-2 Feedforward is suitable when the parameter is a parameter that responds quickly to a change, and that the disturbance is not affected by complex factors.

FIG. 52 illustrates a simple 48-2 Feedforward control for valves. The FIC 01A controller receives signal from FIT 01A upstream, then sends signal to control V-01A downstream. The characteristic of feedforward control is that the signal received from upstream, and send to downstream unit for response.

For the purpose of the electrochemical production 7-5 Process, 48-2 Feedforward is used for relatively predictable subsystem, such as flow rates, position, speed, current and 6-5 Applied Voltage. Because there are many such subsystems in the said 7-5 Process, 48-2 Feedforward is used extensively:

For the 31-1 Cosolvent Stream 0A, FIC 00A, Flow Rate Indicator Controller of Stream 0A, keeps FIT 00A, Flow Rate Indicator Transmitter of Stream 0A at set point, by controlling valve V-00A.

For the 32-1 Additives Stream 0B, FIC 00B, Flow Rate Indicator Controller of Stream 0B, keeps FIT 00B, Flow Rate Indicator Transmitter of Stream 0B at set point, by controlling valve V-00B.

For the 68-1 Material A Stream 1A, FIC 01A, Flow Rate Indicator Controller of Stream 1A, keeps FIT 01A, Flow Rate Indicator Transmitter of Stream 1A at set point, by controlling valve V-01A.

For the 68-2 Material B Stream 1B, FIC 01B, Flow Rate Indicator Controller of Stream 1B, keeps FIT 01B, Flow Rate Indicator Transmitter of Stream 1B at set point, by controlling valve V-01B.

For the prepared 1-7 Electrolyte Stream 2, FIT 02, Flow Rate Indicator Transmitter of Stream 2 is kept at set point by FIC 02, Flow Rate Indicator Controller of Stream 2, which controls the valve V-02.

AIC 02, (Composition) Analysis Indicator Controller of prepared 1-7 Electrolyte Stream 2, is used to keep AIT 02, (Composition) Analysis Indicator Transmitter of prepared 1-7 Electrolyte Stream 2, at set point.

The recycle inlet Stream 2R is measured by FIT 02R, Flow Rate Indicator Transmitter of Stream 2R, kept at set point by FIC 02R, Flow Rate Indicator Controller of stream 2R, by controlling valve V-02R.

For the 1-2 Conventional Reactor outlet Stream 3A, FIT 03A, Flow Rate Indicator Transmitter of Stream 3A is kept at set point by FIC 03A, Flow rate Indicator Controller of stream 3A, which controls V-03A.

For the stirring speed of 1-2 Conventional Reactor CR-03A, SIC 03A (Stirring) Speed Indicator Controller of 1-2 Conventional Reactor CR-03A, controlling the stirrer, which keeps SIT 03A, Speed Indicator Transmitter of 1-2 Conventional Reactor CR-03A, at set point.

The level of 1-2 Conventional Reactor LIT 03A, Level Indicator Transmitter of 1-2 Conventional Reactor CR-03A, is kept at set point by LIC 03A, Level Indicator Controller of 1-2 Conventional Reactor CR-03A.

For 1-15 By-product-1-7 Electrolyte mixture Stream 3B, FIC 03B, Flow Rate Indicator Controller of Stream 3B, keeps FIT 03B, Flow Rate Indicator Transmitter of Stream 3B at set point by controlling valve V-03B.

For the 21-2 Washing fluid into and out of the 35-1 Electrochemical Reactor Stream 4, FIT 04, Flow Rate Indicator Transmitter of Stream 4 measures the inlet flow rate, which is kept at set point by FIC 04, Flow Rate Indicator Controller of Stream 4 that controls V-04.

On the other hand, the level of ER 04, LIT 04, Level Indicator Transmitter of 35-1 Electrochemical Reactor ER-04, is controlled by LIC 04, Level Indicator Controller of 35-1 Electrochemical Reactor ER-04.

For the 35-1 Electrochemical Reactor ER-04, EIC04, Voltage Indicator Controller of 35-1 Electrochemical Reactor ER-04, SIC 04, Speed Indicator Controller of 35-1 Electrochemical Reactor ER-04, and ZIC 04, (Blade) Position Indicator Controller of 35-1 Electrochemical Reactor ER-04, respectively control EIT 04, Voltage Indicator Transmitter of 35-1 Electrochemical Reactor ER-04, SIT 04, Speed Indicator Transmitter of 35-1 Electrochemical Reactor ER-04, and ZIT 04, (Blade) Position Indicator Transmitter of 35-1 Electrochemical Reactor ER-04.

For the washed 1-9 Clean polymer suspension Stream 5A, FIC 05A, Flow Rate Indicator Controller of Stream 5A is used to keep FIT 05A, Flow Rate Indicator Transmitter of Stream 5A at set point, by controlling valve V-05A.

The stirring rate of Washer WP-05A is measured by SIT 05A, Speed Indicator Transmitter of Washer WP-05A, which is kept at set point by SIC 05A, Speed Indicator Controller of Washer WP-05A, that controls the stirrer.

The holdup level of WP-05A is measured by LIT 05A, Level Indicator Transmitter of Washer WP-05A and controlled by LIC 05A, Level Indicator Controller of Washer WP-05A.

For the fresh 21-2 Washing fluid to Washer, Stream 5B, FIC 05B, Flow Rate Indicator Controller of Stream 5B, is used to keep FIT 05B, Flow Rate Indicator Transmitter of Stream 5B, at set point, by controlling valve V-05B.

For the 21-2 Washing fluid feed Stream 5B, AIT 05B, (Composition) Analysis Indicator Transmitter of Stream 5B, measures the 1-14 Spent electrolyte concentration in Stream 5B, and the kept in check to a set point by AIC 05B, (Composition) Analysis Indicator Controller of Stream 5B.

For the fresh 21-2 Washing fluid into the washing fluid tank Stream 5H, FIC 05H, Flow Rate Indicator Controller of Stream 5H in turn keeps FIT 05H, Flow Rate Indicator Transmitter of Stream 5H at set point by controlling valve V-05H.

For the discharge flow for washing fluid tank Stream 5L, FIC 05L Flow Rate Indicator Controller of Stream 5L keeps FIT 05L, Flow Rate Indicator Transmitter of Stream 51 at set point by controlling V-05L

The holdup level of 1-9 Clean polymer P sediment is measured by LIT 06, Level Indicator Transmitter of Settler SP-06, and controlled by LIC 06, Level Indicator Controller of Settler SP-06.

For the 1-9 Clean polymer sediment Stream 6A, FIC 06A, Flow Rate Indicator Controller of Stream 6A, keeps FIT 06A, Flow Rate Indicator Transmitter of Stream 6A at a set point, by controlling valve V-06A.

For the upper 21-2 Washing fluid Stream 6B, FIC 06B, Flow Rate Indicator Controller of Stream 6B is used to keep FIT 06B, Flow Rate Indicator Transmitter of Stream 6B at set point, by controlling valve V-06B.

For the 1-9 Clean polymer powder Stream 7A, SIC 07A, (Conveying) Speed Indicator Controller of Stream 7A keeps SIT 07A, (Conveying) Speed Indicator Transmitter of Stream 7A at set point. In fact, this is a crucial part of the process 7-7 Control.

For vapour Stream 7B, FIC 07B, Flow Rate Indicator Controller of Stream 7B keeps FIT 07B, Flow Rate Indicator Transmitter of Stream 7B at a set point by controlling the valve V-07B.

For the cooling Stream 7C of condenser X-07B, FIC 07C, Flow rate Indicator Controller of Stream 7C, keeps FIT 07C, Flow Rate Indicator Transmitter of Stream 7C at a set point, by controlling the valve V-07C.

For the operating speed of molding machine MP-08, SIC 08, Speed Indicator Controller of molding machine MP-08 is used to control SIT 08, Speed Indicator Transmitter of molding machine MP-08 directly.

For the operating speed of polymer packing unit PP-09, SIC 09, Speed Indicator Controller of polymer packing unit PP-09 controls the packaging rate SIT 09, Speed Indicator Transmitter of polymer packaging unit PP-09.

For Sorbent Regenerator SR-10B, SIC 10B, (Conveying) Speed Indicator Controller of Sorbent Regenerator SR-10B, keeps SIT 10B, (Conveying) Speed Indicator Transmitter of Sorbent Regenerator SR-10B, at set point by controlling the motor/engine of Sorbent Regenerator SR-10B.

For stirring speed of Solvent Extractor XB-11, SIC 11, (Stirring) Speed Indicator Controller of Solvent Extractor XB-11 keeps SIT 11, (Stirring) Speed Indicator Transmitter of Solvent Extractor XB-11, at set point by controlling motor/engine of Solvent Extractor XB-11.

LIT 11, Level Indicator Transmitter of Solvent Extractor XB-11 measures the solvent extractor level, kept at set point by LIC 11, Level Indicator Controller of Solvent Extractor XB-11.

For solvent extract Stream 11A, FIC 11A, Flow Indicator Controller of Stream 11A, keeps FIT 11A, Flow Indicator Transmitter of Stream 11A at set point, by controlling valve V-11A.

For raffinate 1-7 Electrolyte stream 11B, FIC 11B, Flow Rate Indicator Controller of Stream 11B, keeps FIT 11B, Flow Rate indicator Transmitter of Stream 11B, at set point by controlling valve V-11B.

AIT 11B, (Composition) Analysis Indicator Transmitter of Stream 11B, is kept at set point by AIC 11B, (Composition) Analysis Indicator Controller of Stream 11B.

For Solvent Feed Stream 12A, FIC 12A, Flow Rate Indicator Controller of Stream 12A, keeps FIT 12A, Flow Rate Indicator Transmitter of Stream 12A, at set point, by controlling valve V-12A.

For Solvent Overflow Stream 12B, FIC 12B, Flow Rate Indicator Controller of Stream 12B, keeps FIT 12B, Flow Rate Indicator Transmitter of Stream 12B at set point, by controlling valve V-12B.

The tank level is measured by LIT 13, Level Indicator Transmitter of Distillation Column DB-13, kept at set point by LIC 13, Level Indicator Controller of Distillation Column DB-13.

For the feed stage is measured by ZIT 13, Position Indicator Transmitter of Feed at XB-13, which is kept at set point by ZIC 13, Position Indicator Controller of Feed at XB-13, by controlling the input feed position of Distillation Column XB-13.

For the 1-15 By-product H Stream 13A, FIC 13A, Flow Rate Indicator Controller of Stream 13A, keeps FIT 13A, Flow Rate Indicator Transmitter of Stream 13A, at set point, by controlling valve V-13A.

The 1-15 By-product assay is measured by AIT 13A, (Composition) Analysis Indicator Transmitter of Stream 13A, kept at set point by AIC 13A, (Composition) Analysis Indicator Controller of Stream 13A.

For solvent recycling stream 13B, FIC 13B, Flow Rate Indicator Controller of Stream 13B, controls FIT 13B, Flow Rate Indicator Transmitter of Stream 13B at set point by controlling valve V-13B.

AIT 13B, (Composition) Analysis Indicator Transmitter of Stream 13B, is kept at set point by AIC 13B, (Composition) Analysis Indicator Controller of Stream 13B.

For cooling fluid Stream 13D of condenser X-13C, FIC 13D, Flow Rate Indicator Controller of Stream 13D, keeps FIT 13D, Flow Rate Indicator Transmitter of Stream 13D at set point, by controlling valve V-13D.

For distillation reflux Stream 13H, FIC 13H, Flow Rate Indicator Controller of Stream 13H, keeps FIT 13H, Flow Rate Indicator Transmitter of Stream 13H, at set point, by controlling valve V-13H.

For the bottom product of distillation column Stream 13L, FIC 13L, Flow Rate Indicator Controller of Stream 13L, keeps FIT 13L, Flow Rate Indicator Transmitter of Stream 13L, at set point by controlling valve V-13L

For the inflow into Reservoir Tank Stream 15A, FIC 15A, Flow Rate Indicator Controller of Stream 15A keeps FIT 15A, Flow Rate indicator Transmitter of stream 15A at set point by controlling the valve V-15A while for the outflow of Reservoir Tank Stream 15B, FIC 15B, Flow Rate Indicator Controller of Stream 15B keeps FIT 15B, Flow Rate Indicator Transmitter of Stream 15B at set point by controlling the valve V-15B.

LIT 16, Level Indicator Transmitter of Cooling Fluid Drum D-16, is kept at set point by LIC 16, Level Indicator Controller of Cooling Fluid Drum D-16.

For cooling air feed Stream 16B, FIT 16B, Flow Rate Indicator Transmitter of Stream 16B, is kept at set point by FIC 16B, Flow Rate Indicator Controller of Stream 16B, by controlling valve V-16B.

For cooling fluid feed Stream 16C, FIT 16C, Flow Rate Indicator Transmitter of Stream 16C, is kept at set point by FIC 16C, Flow Rate Indicator Controller of Stream 16C by controlling valve V-16C.

Other than the above simple 48-2 Feedforward control, 48-2 Feedforward has also been employed in a 48-1 Cascade fashion, to control another controller downstream:

LIT 03A, Level Indicator Transmitter of 1-2 Conventional Reactor CR-03A, also affects SIC03A, (Stirring) Speed Indicator Controller of 1-2 Conventional Reactor CR-03A.

IIC 04, (Electric) Current Indicator Controller of 35-1 Electrochemical Reactor ER-04, is a representation of the set point extent of reaction in the 35-1 Electrochemical Reactor ER-04, as such is used to control almost everything related to 35-1 Electrochemical Reactor ER 04. First of all, it provides a set point for IIT 04, (Electric) Current Indicator Transmitter of 35-1 Electrochemical Reactor ER-04. It also controls EIC 04, Voltage Indicator Controller of 35-1 Electrochemical Reactor ER-04, SIC 04, (Electrode) Speed Indicator Controller of 35-1 Electrochemical Reactor ER-04, and ZIC 04, (Blade) Position Indicator Controller of 35-1 Electrochemical Reactor ER-04.

IIC 04, (Electric) Current Indicator Controller of 35-1 Electrochemical Reactor ER-04, also controls FIC 03B, Flow Rate Indicator Controller of Stream 3B downstream.

The set point of SIC 05A, (Stirring) Speed Indicator Controller of Washer WP-05A also depends on LIT 05A, Level Indicator Transmitter of Washer WP-05A.

FIC 06A, Flow Rate Indicator Controller of Stream 6A, controls FIC 06B, Flow Rate Indicator Controller of Stream 6B.

TIC 07, Temperature Indicator Controller of Dryer DP-07, is controlled by the inlet flow rate FIC 06A, Flow Rate Indicator Controller of Stream 6A.

FIC 07C, Flow Rate Indicator Controller of Stream 7C, is controlled by TIC 07, Temperature Indicator Controller of Dryer DP-07, and FIC 07B, Flow Rate Indicator Controller of Stream 7B.

SIC 08, (Operating) Speed Indicator Controller of Molding Machine MP-08 also controls SIC 09, (Operating) Speed Indicator Controller of Polymer Packing unit PP-09 further downstream.

FIC 11A, Flow Rate Indicator Controller of Stream 11A, controls FIC 13B, Flow Rate Indicator Controller of Stream 13B.

LIT 11, Level Indictor Transmitter of Solvent Extractor XB-11, also sends signal to SIC 11, Speed Indicator Controller of Solvent Extractor XB-11.

AIT 11A, (Composition) Analysis Indicator Controller of Stream 11A, send signals to AIC 13A, (Composition) Analysis Indicator Controller of Stream 13A.

TIT 13C, Temperature Indicator Transmitter of Stream 13C, measures the inlet temperature for condenser while FIT 13C, Flow Rate Indicator Transmitter of Stream 13C measures the flow rate, both then sends signals to FIC 13D, Flow Rate Indicator Controller of Stream 13D.

FIT 16A, Flow Rate Indicator Transmitter of Stream 16A, sends signal to FIC 16B, Flow Rate Indicator Controller of Stream 16B.

LIC 16, Level Indicator Controller of Cooling Fluid Drum D-16, controls FIC 16C, Flow Rate Indicator Controller of Stream 16C.

TIT 16A, Temperature Indicator Transmitter of Stream 16A, is kept at set point by TIC 16A, Temperature Indicator Controller of Stream 16A, by controlling both Blower B-16B and FIC 16B, Flow Rate Indicator Controller of Stream 16B.

48-3 Feedback

48-3 Feedback is used when 48-10 Reliability is needed, such as when the parameter responds slowly, and that the disturbance involved complex factors. For the electrochemical 7-5 Process, 48-3 Feedback is used for 7-5 Process parameters that depends on more complex phenomena difficult to control by 48-2 Feedforward, and where deviation would affect production rate and quality. FIG. 53 illustrates a sample 48-3 Feedback control. AIC 05B receives signal from AIT 05B downstream, then sends signals to upstream FIC 051 for further response. The characteristic of the feedback is that the signal is sent from downstream to unit upstream for response.

Because of the purpose of coordination between units, 48-3 Feedback for the electrochemical 7-5 Process is largely used in 48-1 Cascade style:

FIC 00A, Flow Rate Indicator Controller of stream 0A is controlled by FIC 02, Flow Rate Indicator Controller of stream 2 downstream.

FIC 00B, Flow Rate Indicator Controller of Stream 0B is controlled by FIC 02, Flow Rate Indicator Controller of Stream 2 downstream.

FIC 01A, Flow Rate Indicator Controller of stream 1A, as the limiting reagent, is controlled by FIC 02, Flow Rate Indicator Controller of stream 2 downstream

FIC 01B, Flow Rate Indicator Controller of stream 1B is controlled by FIC 02, Flow Rate Indicator Controller of stream 2 downstream.

Upstream, FIC 02, Flow Rate Indicator Controller of Stream 2 controls FIC 00A, Flow Rate Indicator Controller of Stream 0A, FIC 00B, Flow Rate Indicator Controller of Stream 0B, FIC 01A, Flow Rate Indicator Controller of Stream 1A, FIC 01B, Flow Rate Indicator Controller of Stream 16 and FIC 02R, Flow Rate Indicator Controller of Stream 2R.

Together with FIC 02 Flow Rate Indicator Controller of Stream 2, AIC 02 (Composition) Analysis Indicator Controller of Stream 2 controls FIC 00A, Flow Rate Indicator Controller of stream 0A, FIC 00B, Flow Rate Indicator Controller of Stream 0B, FIC 01A, Flow Rate Indicator Controller of Stream 1A, FIC 01B, Flow Rate Indicator Controller of Stream 11 and FIC 02R, Flow Rate Indicator Controller of Stream 2R.

FIC 02R, Flow Rate Indicator Controller of stream 2R also controls FIC 11B, Flow Rate Indicator Controller of stream 11B.

The temperature is measured by TIT 03A, Temperature Indicator Transmitter of 1-2 Conventional Reactor CR-03A, which is kept at set point by TIC 03A, Temperature Indicator Controller of 1-2 Conventional Reactor CR-03A that controls the upstream heater H-02.

TIC 03A, Temperature Indicator Controller of 1-2 Conventional Reactor CR-03A is also dependent on the downstream outlet temperature TIT 03B, Temperature Indicator Transmitter of Stream 3B.

The PIT 03A, Pressure Indicator Transmitter of 1-2 Conventional Reactor CR-03A, is kept at set point by PIC 03A, Pressure Indicator Controller of 1-2 Conventional Reactor CR-03A which controls the upstream 40-3 Pumps/Compressor Q-02.

Upstream, FIC 05A Flow Rate Indicator Controller of Stream 5A controls both FIC 05B, Flow Rate Indicator Controller of Stream 5B and FIC 04, Flow Rate Indicator Controller of Stream 4.

AIC 05B (Composition) Analysis Indicator Controller of Stream 5B works by controlling FIC 05L, Flow Rate Indicator Controller of Stream 5L

FIC 05L, Flow Rate Indicator Controller of Stream 5L subsequently controls FIC 05H, Flow Rate Indicator Controller of Stream 5H.

FIC 06A, Flow Rate Indicator Controller of Stream 6A is controlled by SIC 07A, (Conveying) Speed Indicator Controller of Stream 7A.

To the upstream, FIC 06A, Flow Rate Indicator Controller of Stream 6A controls FIC 05A, Flow Rate Indicator Controller of Stream 5A.

The holdup level LIT 07, Level Indicator Transmitter of Dryer DP-07, is also affected by SIC 07A, (Conveying) Speed Indicator Controller of Dryer DP-07 and controlled by LIC 07, Level Indicator Controller of Dryer DP-07.

The temperature TIT 07, Temperature Indicator Transmitter of Dryer DP-07, is fixed at a set point by TIC 07, Temperature Indicator Controller of Dryer DP-07, by controlling the heating system of the dryer.

TIT 10A, Temperature Indicator Transmitter of Sorption Unit SB-10A measures the temperature, kept at set point by TIC 10A, Temperature Indicator Controller of Sorption Unit SB-10A by controlling SIC 10B (Conveying) Speed Indicator Controller of Sorbent Regenerator SR-10B.

FIC 11A, Flow Rate Indicator Controller of stream 11A is dependent on FIC 13A, Flow Rate Indicator Controller of Stream 13A.

LIC 11 Level Indicator Controller of Solvent Extractor XB-11 works by controlling FIC 03B, Flow Rate Indicator Controller of Stream 3B.

The temperature is measured by TIT 13, Temperature Indicator Transmitter of Distillation Column DB-13 and kept at set point by TIC 13, Temperature Indicator Controller of Distillation Column DB-13, by controlling the reboiler H-13L.

Upstream, FIC 13A, Flow Rate Indicator Controller of stream 13 controls FIC 11A, Flow Rate Indicator Controller of stream 11A.

AIC 13A (Composition) Analysis Indicator Controller of stream 13A controls AIC 13B (Composition) Analysis Indicator Controller of Stream 13B and ZIC 13 Position Indicator Controller of Feed at XB-13 upstream.

48-4 Ratio

48-4 Ratio Control involves monitoring and controlling the ratio of 48-11 Multiples between of 7-5 Process parameters. It is usually but not limited to specified stoichiometric ratio of flow rates in different streams. For the electrochemical 1-8 Polymer production 5-1 elerGreen Process, 48-4 Ratio control has been used mainly in monitoring and controlling the 1-7 Electrolyte composition.

FIG. 54 highlights the 48-4 Ratio control for the distillation column. FIC 13A, FIC 13B and AIT 11A send signal to RIY 13A to control FIC 13H based on ratio of flow rates, while FIC 13B, AIC 13B and AIC 13A, sends signal to evaluate RIY 13B to control FIC 13L.

RIY11, Ratio Indicator Relay for Electrolyte 1-5 Recovery is used to monitor and control the 1-7 Electrolyte composition by controlling either the 45-1 Sorption Stream or the 44-1 Solvent Extraction Stream. RIY 11 Ratio Indicator Relay for Electrolyte 1-5 Recovery is controlled by FIC 03B Flow Rate Indicator Controller of Stream 3B, AIT 03B (Composition) Analysis Indicator Transmitter of Stream 3B, FIC 11B Flow Rate Indicator Controller of Stream 11B, AIC 11B (Composition) Analysis Indicator Controller of Stream 11B and AIC 13B (Composition) Analysis Indicator Controller of Stream 13B.

For Sorption path, RIY 11 Ratio Indicator Relay of Recovered 1-7 Electrolyte controls SIC 10B, (Conveying) Speed Indicator Controller of Sorbent Regenerator. For Solvent Extraction path, RIY 11 Ratio Indicator Relay of Recovered 1-7 Electrolyte controls FIC 13B Flow Rate Indicator Controller.

In the Solvent Extraction path, further 48-4 Ratio Control is employed for Distillation Column DB-13 as RIY 13A and RIY 13B to respectively controls both Distillation Reflux and Distillation Bottom. FIC 13A Flow Rate Indicator Controller of 1-15 By-product Stream 13A controls RIY 13A Ratio Indicator Relay of Distillation Reflux and RIY 13B Ratio Indicator Relay of Distillation Bottom.

For Distillation Reflux, RIY 13A Ratio Indicator Relay of Distillation Reflux is controlled by FIC 13B Flow Rate Indicator Controller of Solvent Stream 13B. AIT 11A (Composition) Analysis Indicator Transmitter of Extract Stream 11A also sends signals to RIY 13A Ratio Indicator Relay of Distillation Reflux. RIY 13A Ratio Indicator Relay of Distillation Reflux then controls FIC 13H Flow Rate Indicator Controller of Reflux Stream 13H.

For RIY 13B Ratio Indicator Relay of Distillation Bottom, it controls FIC 13L Flow Rate Indicator Controller of Bottom Stream 13L AIC 13A (Composition) Analysis Indicator Controller of 1-15 By-product stream 13A also controls RIY 13B Ratio Indicator Relay of Distillation Bottom.

48-5 Split Range

48-5 Split Range control is used for 48-12 Different Response Needed when a controller is employed to control 2 final control elements such as 2 of 40-6 Valves as illustrated by FIG. 56. In some implementation, 48-5 Split Range control is found in 7-7 Control of level, temperature and 1-12 Pressure. In some implementations, the split range involved a dead band near the set point, which is a range for the controller to not respond when the deviation from set point is below certain limit as shown in FIG. 56, to save cost against switching between different operating range A and B.

FIG. 55 outlines the 48-5 Split Range control. LIC 05B sends signal to either of FIC 05L or FIC 05H, depending on the level of liquid holdup in T-05B under different range. When the level is in the higher range (range B), FIC 05L (control B) would be controlled to discharge the liquid. When the level is in the lower range (range A), FIC 05H (control A) is controlled to add some fluid from 40-5 Utility to T-058.

For the electrochemical 1-8 Polymer production 5-1 elerGreen Process, 48-5 Split Range Control is used for tank level 7-7 Control coupled with a reservoir, including Mixing Tank M-02 with Reservoir Tank T-15, Washing Fluid Tank T-05B with 40-5 Utility, and Solvent Extractor XB-11 with Solvent Drum D-12.

The tank level is measured by UT 02 Level Indicator Transmitter of Mixing Tank M-02 and regulated by LIC 02 Level Indicator Controller of Mixing Tank M-02. LIC 02 Level Indicator Controller of Mixing Tank M-02 in turn controls, by 48-5 Split Range, both FIC 15A, Flow Rate Indicator Controller of stream 15A and FIC 15B, Flow Rate Indicator Controller of Stream 15B.

The tank level is measured by LIT 05B Level Indicator Transmitter of Washing Fluid Tank T-05B and controlled by LIC 05B Level Indicator Controller of Washing Fluid Tank T-05B, which also works to control FIC 05H, Flow Rate Indicator Controller of stream 5H and FIC 05L, Flow Rate Indicator Controller of stream 5L.

LIC 11 Level Indicator Controller of Solvent Extractor XB-11 also works by controlling by 48-5 Split Range for both FIC 12A, Flow Rate Indicator Controller of stream 12A and FIC 12B, Flow Rate Indicator Controller of Stream 12B.

48-6 Override Select

48-6 Override Select control is generally used to balance between 48-13 Flexibility and Safety of process system during the surge in 7-5 Process, when a secondary 7-7 Control is needed occasionally. It is usually not but limited to 7-5 Process safety purposes such as maintaining 1-12 Pressure, tank level, and temperature.

FIG. 57 illustrates an 48-6 Override Select control. During usual operation when level LIT 13 is at acceptable level, FIC 13B takes over to control FIC 11A. When LIT 13 is beyond the threshold, LIC 13 takes over instead of FIC 13B on the control of FIC 11A.

For the electrochemical 1-8 Polymer production 7-5 Process, 48-6 Override Select control is used to maintain tank level when complicated upstream and downstream setup makes 48-5 Split Range control difficult. When the tank level is within operating range, the 40-6 Valves are controlled by flow controller. However, when the tank level drops below a threshold, the 40-6 Valves are controlled instead by level 7-7 Control.

For 1-2 Conventional Reactor CR-03A, when tank level is at desired range, the set point of SIC 07A is used as a reference to control remotely FIC 02 Flow Rate Indicator Controller of Stream 2. When Tank Levels are not at desired range, LIC 03A Level Indicator Controller of 1-2 Conventional Reactor CR-03A controls FIC 02 Flow Rate Indicator Controller of Stream 2.

For 35-1 Electrochemical Reactor ER-04, when tank level is at desire range, the set point of SIC 07A is combined with IIC 04 (Electric) Current Indicator Controller of 35-1 Electrochemical Reactor ER-04 to control FIC 02, Flow Rate Indicator Controller of Stream 2 upstream. When Tank Levels are not at desired range, LIC 04, Level Indicator Controller of 35-1 Electrochemical Reactor ER-04, controls FIC 02, Flow Rate Indicator Controller of Stream 2.

For Distillation Column DB-13, when the tank level is in desired range, FIC 11A, Flow Rate Indicator Controller of Stream 11A is controlled by FIC 13A, Flow Rate Indicator Controller of Stream 13A and FIC 13B, Flow Rate Indicator Controller of stream 13B. When the tank level is not in range, LIC 13 Level Indicator Controller of Distillation Column DB-13 controls FIC 11A Flow Rate Indicator Controller of Stream 11A.

48-7 Indicator/Alarm

By the first principle of process 7-7 Control, whenever there is a change in the 7-5 Process parameter causing disturbance, this change cannot be eliminated, instead it is simply transferred via process 7-7 Control. For the 5-1 elerGreen Process of interest, the process 7-7 Control strategy aims to transfer all disturbances away from the chemical 7-5 Process such as the 1-8 Polymer production rate, into some “48-14 Reservoir for Disturbance” variable that has huge tolerance of disturbances, such as the materials tank level.

FIG. 58 illustrates the 48-7 Indicator/Alarm control method. This is the simplest variant where LI 00A is used to measure and report the tank level. There are 2 limits, at the first limit, it just indicates the level value and reminds the operator to control inventory manually, at the second limit, alarm sounds as stronger reminder while the process may be shutdown for process safety consideration.

The 48-7 Indicator/Alarm is used for the “48-14 Reservoir for Disturbance”, such as storage tank level because the tank level is designed to has huge tolerance and long timespan. For instance, a surge of temperature of either 1-2 Conventional Reactor or 35-1 Electrochemical Reactor would produce disturbance into the production rate in minutes, but if a cooling 7-7 Control system is in place, it could transfer such disturbance into a surge in cooling fluid flow rate that would result in increase in 40-5 Utility bill, a less undesirable outcome.

The storage tanks are generally sized to have enough 1-6 Reactants for operation of more than 1 day. As a result, the process 7-7 Control seeks to use these as “48-14 Reservoir for Disturbance”. In many cases, a disturbance in 7-5 Process would ultimately be transferred as a faster rate of consumption of tanks, which offers a number of advantages:
Longer response time available
More tolerable outcomes
7-5 Process safety

Other “48-14 Reservoir for Disturbance” that are not regulated, but simply just monitored by operator are the holdup levels:
WI09, Weight Indicator of Polymer Packing PP-09
LI 00A, Level Indicator of Cosolvent Drum D-00A
LI 00B, Level Indicator of Additive Drum D-00B
LI 01A, Level Indicator of Feed Tank A T-01A
LI 01B, Level Indicator of Feed Tank B T-01B
LI 12 Level Indicator of Solvent Drum D-12
LI 14 Level Indicator of By-Product Tank TB-14
LI 15, Level indicator of Reservoir Tank T-15

Operating 7-8 Procedure

The 7-8 Procedure is broken down in FIG. 59 involving 59-1 Stacking, 59-2 Deployment, 34-3 Retrofitting, 59-3 Maintenance and finally 34-4 Waste Management.

59-1 Stacking

In industrial Implementations, the 35-1 Electrochemical Reactors are stacked in matrices or arrays to minimize space requirements. Due to the rectangular shapes of the 9-20 Vessel in the horizontal plane, the 59-1 Stacking in arrays is very efficient in terms of usage of space.

FIG. 60 demonstrates a very efficient way to arrange electrodes. First, the electrodes can be placed in alternating way or aggregate manner. While aggregate manner is easier to fabricate alternating arrangement Is more energy efficient because the distance between 3-2 Anode and 3-3 Cathode is lower, thus less energy is dissipated as resistance. To achieve this figuration, a rigid 60-3 insulator can be used as support to fixate both 3-2 Anode and 3-3 Cathode on the same support without short-circuiting, which is a strategy employed for 9-3 Rotating Disk Electrode and 9-4 Spiral/Screw Electrode.

In some implementation, the 35-1 Electrochemical Reactors are stacked in a 2×1 matrix as illustrated by FIG. 61, that means the 35-1 Electrochemical Reactors appear as a couple with 1 of 61-4 Stacking side. It provides 3 of 61-3 Maintenance side for the 61-1 Personnel to maintain the equipment. 2 sides of the 9-20 Vessel that can be made transparent allows 2 pieces of 61-2 Monitoring side the 61-1 Personnel to look into the 9-20 Vessel to observe the 9-20 Vessel.

In some implementation, the 35-1 Electrochemical Reactors are stacked in a 2×2 matrix as illustrated by FIG. 62 with 2 of 61-4 Stacking side, this is a common setup because it is usually a compromise between compactness and usability, because it at least provides 2 of 61-3 Maintenance side for 61-1 Personnel to deploy, troubleshoot and maintain the 35-1 Electrochemical Reactors.

In some Implementations, the 35-1 Electrochemical Reactors are stacked in 2×n matrix as illustrated by FIG. 63 with 3 of 61-4 Stacking side. Other than the end 35-1 Electrochemical Reactors that have 2 of 61-3 Maintenance side, it provides only 1 of 61-3 Maintenance side for 61-1 Personnel. However, this 1 of 61-3 Maintenance side would usually suffice for 61-1 Personnel to maintain the 35-1 Electrochemical Reactors, especially to remove the 9-13 Support.

FIG. 64 demonstrates the actual implementation of 2×n matrix array of 35-1 Electrochemical Reactors, for the 9-2 Conveyor Belt Electrode variant. Due to the design consideration to save cost and space, the 9-9 Solid Transport can be pooled together, while the components such as 9-20 Vessel, 9-13 Support and 9-17 Gas Removal can be placed in modular manner for ease of Deployment and 59-3 Maintenance.

In some implementations, 59-1 Stacking of the 35-1 Electrochemical Reactors facing outward as illustrated by FIG. 65 would mitigate the 59-3 Maintenance problem but at the expense of less compact space.

In some implementations, the 35-1 Electrochemical Reactors are stacked in n×n matrices as illustrated by FIG. 66. This maximizes the compactness but at the cost of usability. Depending on the situation, this might be employed, especially when a larger scale plant makes the installation of a system of 9-13 Support hanging from the ceiling economically feasible to for such n×n matrices where 61-1 Personnels cannot go directly to the equipment on any 66-1 Surrounded unit.

59-2 Deployment

Due to the modular nature and the assembly design, there is a convenient way to deploy the 35-1 Electrochemical Reactor. The 59-2 Deployment is illustrated by FIG. 67.

As shown by FIG. 67, the first step is 67-1 Deploy Reactor, where 9-20 Vessel is first placed at designated place on site and 7-6 Piping connected into and out of the tank. When there are multiple 35-1 Electrochemical Reactors, they are stacked into arrays as necessary per 59-1 Stacking.

The second step is 67-2 Deploy Electrode Support, where the electrode 9-13 Support are then deployed onto the tanks. Note that the electrode 9-13 Support need to be in jack up position so that the electrode does not collide with the tank during 59-2 Deployment.

The third step is 67-3 Adjust Electrode Position, where for 9-14 Movable 9-13 Support such as the 23-4 Frame Body on 23-3 Wheels, the 9-13 Support can be pushed manually to the tank and adjusted to fit. When the position is fixed, the electrode is then lowered down using the jack, to suitable vertical position in the Vessel to potentially allow the electrode to dip into the 1-7 Electrolyte later on. For 9-15 Built-in variant of support, both 67-2 Deploy Electrode Support and 67-3 Adjust Electrode Position can be skipped.

The fourth step is 67-4 Deploy Solid Transport, where 9-12 Channel is then installed to the 35-1 Electrochemical Reactor, with the 7-6 Piping connected to and from the washer.

The final step is 67-5 Install Gas Removal, where the 9-17 Gas Removal is installed if applicable for the electrochemical polymerization reaction. First, the 9-17 Gas Removal with 24-2 Cap is placed on top of the electrode, and then its position, together with 24-3 Cover and 24-4 Weight subsequently adjusted to fit. Gas 7-6 Piping connection is then made from 24-1 Ventilation outlet of 9-17 Gas Removal to the fumehood system on top, usually by 7-6 Piping hooked onto the ceiling.

The 7-6 Piping connection to other unit operations are then performed.

34-3 Retrofitting

The 34-3 Retrofitting of a regular 1-8 Polymer 7-5 Process involves the following general 7-8 Procedure:

The 35-1 Electrochemical Reactor, ER-04, is first installed, in parallel to the 1-2 Conventional Reactor, CR-03A, by following the 59-2 Deployment procedure, including C-04, Stream 4 with V-04, fumehood units and 7-6 Piping. If 59-1 Stacking is needed, the 35-1 Electrochemical Reactors are stacked in arrays according to the 59-1 Stacking methods.

The conventional 1-8 Polymer 7-5 Process is temporarily shut down. The fluids in the 7-5 Process is then drained and the following sections are disconnected as necessary:
Valve V-02 and 1-2 Conventional Reactor CR-03A
Filter CF-03B and Pump P-03B
Filter CF-03B and Washer WP-05A

For the above sections, each switch valve is installed, and the following connections are made:
S-03A to liquid inlet of 35-1 Electrochemical Reactor ER-04
S-3B to C-04 of 35-1 Electrochemical Reactor ER-04 liquid outlet
S-04 to washing outlet of 35-1 Electrochemical Reactor ER-04

If the conventional 7-5 Process involves the same 1-5 Recovery (both 45-1 Sorption Stream before and after 34-3 Retrofitting, or both 44-1 Solvent Extraction Stream before and after 34-3 Retrofitting), troubleshooting can be performed right after installation. If the conventional 7-5 Process involves a different 1-5 Recovery method, the 34-3 Retrofitting the 1-5 Recovery units is necessary. For 34-3 Retrofitting the 1-5 Recovery units, the fluids of the following sections are drained and the sections disconnected:
V-03B and SB-10A/XB-11
P-11B and SB-10A/XB-11

For the above sections, each switch valve is installed in between and the following connections are made:
S-10A to SB-10A/XB-11
S-10B to SB-10A/XB-11

If the new 7-5 Process involves distillation column DB-13 and change of key is involved, 34-3 Retrofitting the distillation column is also needed. The fluids of the following sections are drained and the sections disconnected:
The reflux of distillation column to V-13A
The bottom of distillation column to P-13B

For the above sections, each switch valve is installed an the following connections are made:
S-13H and S-13A to V-13A
S-131 and S-13B to P-13B

Additional connections are made between:
S-13H to C-13B to S-13B
5-13L to C-13A to S-13A

If different 21-2 Washing fluid is necessary, T-5B, WP-05A, SP-06, and DP-07 may be drained to replace the 21-2 Washing fluid.

The electrochemical 37-1 Bypass is ran and tested, in comparison of 1-2 Conventional Reactor.

The rest of the 7-5 Process is troubleshooted to fit the 35-1 Electrochemical Reactor. The troubleshooting involve either minor 7-5 Process parameter changes, or more major changes such as mixture composition change, or even replacement of equipment parts.

59-3 Maintenance

By virtue of the 7-1 Device design, the 59-3 Maintenance is more convenient than 1-2 Conventional Reactors and conventional electrolyzers.

Compared to 1-2 Conventional Reactor, the feature of removing the electrode from the top for the novel 35-1 Electrochemical Reactor offers advantage especially for 59-3 Maintenance because such feature avoids the time and complexity of draining and refilling the liquid tank which allows lower downtime and lower cost for 59-3 Maintenance.

To perform the 59-3 Maintenance, the 59-2 Deployment procedure is operated in reverse as per FIG. 67. First, the power supply for electrochemical reaction and 4-1 Moving electrode are shutdown to make sure both reactions and 9-5 Mechanical movements are halted. While it is also recommended the fluid inflows and outflows of the 9-20 Vessel be stopped for more stringent 7-5 Process safety consideration, it can be remained on especially if the flow is not turbulent. The fumehood is then turned off and the 9-17 Gas Removal be lifted from the electrode and placed elsewhere, a reverse of 67-5 Install Gas Removal. A minor difference from 59-2 Deployment procedure is that the 9-9 Solid Transport system can remain at the position (instead of being removed) while the electrode can be jacked up, after performing the 67-3 Adjust Electrode Position in reverse to remove it from the tank, such that operating the 67-4 Deploy Solid Transport step in reverse may be skipped. The 9-13 Support with the jacked up electrode can be pushed away as a reverse step of 67-2 Deploy Electrode Support from the tank to a suitable area for 59-3 Maintenance, including but not limited to cleaning the electrode surface and replacing spent parts

such as blunt blade. The 9-20 Vessel however is usually stationary such that operating 67-1 Deploy Reactor in reverse to remove the 9-20 Vessel can be skipped. To facilitate operator, reach for 59-3 Maintenance, the electrode can be released downwards as necessary for ergonomic consideration.

After 59-3 Maintenance, the electrode is pushed to the 9-20 Vessel and set to jack up position as per 67-2 Deploy Electrode Support. Subsequent procedure to prepare the 35-1 Electrochemical Reactors for operation is similar to the 59-2 Deployment procedure.

34-4 Waste Management

For 34-4 Waste Management, the extractor is needed to be installed before the feed tanks. In some implementation, it is done by an upstream equipment installed in the electrochemical 1-8 Polymer 7-5 Process upstream to extract active Ingredient. For some other implementations, it is done by another 34-4 Waste Management treatment plant, that can be owned by elerGreen, or simply subcontracted to other plants) and simply trucked to the electrochemical 1-8 Polymer production plant.

For many cases, a purification equipment is needed at upstream to isolate the active ingredient in 5-2 Chemical wastes. For Instance, the paint sludge 5-2 Chemical wastes treatment would require an isolation of ethylene glycol.

### EXAMPLES AND EXPERIMENTATION

General Experimentation

The protocols involve 3 major components: 1-1 Preparation, 35-1 Electrochemical Reactor Operation, and Sampling:

1-1 Preparation:

The 1-1 Preparation of 1-7 Electrolyte involved mixing the materials, namely the liquid 1-6 Reactants and the solid solutes to produce the 1-7 Electrolyte of desired composition. If there is 68-2 Material B involved, the mixing (in a container such as 69-1 Beaker) of 68-2 Material B with 68-1 Material A is the very first step of 1-1 Preparation, especially because if 68-2 Material 8 is mixed first, the stoichiometric ratio between 68-1 Material A and 68-2 Material B is very easily controllable. The liquid of mixture (68-1 Material A and 8), or liquid 68-1 Material A (if 68-2 Material B is not relevant), is then mixed (according to calculated composition) with 31-1 Cosolvent such as water if dilution is desired, especially when the presence of diluent serves as 31-1 Cosolvent to solid solute. After each mixing, mechanical agitation is applied to the mixture to ensure mixing is done homogeneously throughout the liquid phase.

The liquid of 68-1 Material A, 68-2 Material B (if applicable) and 31-1 Cosolvent (if applicable) is then mixed with weighted amount of solute, in many cases ionic salt compounds. In many cases, the solute is in solid form, such as powder or pellets, such that the homogeneity distribution of solid does not happen readily. For this scenario, the mixture is either stirred continuously for a period of time until all the solid dissolves. For this reason, it takes longer time to achieve uniform mixing due to the slower dissolving process. The mixture may also be heated modestly to accelerate the dissolving of the solid, after which the mixture is cooled back to the ambient temperature.

In some cases, the solute is in liquid form, such as ionic liquid where no dissolving is involved, then the solute is mixed with simple mechanical agitation in a similar fashion as 68-1 Material A and B, or the mixture with diluent.

The composition is quantified by means of volume, weightage or moles. For quantification, liquid is either measured by weight (using balance) or volume (using measuring cylinder or volumetric flask, or a combination), while solid is measured by weight.

35-1 Electrochemical Reactor Operation:

For convenience of measurement, the reaction setup was performed in batch operation manner in a batch reaction setup. The experiment consists of a simple batch electrolysis cell. The experimental setup consists of a reaction 9-20 Vessel (usually a 68-6 Conical flask as shown in FIG. 68, or a 69-1 Beaker as shown in FIG. 69) containing conductive materials (3-3 Cathode and 3-2 Anode) as 70-1 Working Electrode and 10-1 Counter Electrode, connected to 3-1 Electricity DC Power Supply and dipped into a liquid mixture (1-7 Electrolyte), with the 1-7 Electrolyte continuously stirred and if applicable, heated. The 9-20 Vessel also has a 68-9 Tubing connected to 68-7 Bubble flowmeter to measure flow rate of any gas evolved from the electrochemical reaction. Both the reaction 9-20 Vessel and the 68-7 Bubble flowmeter are fastened in position, by clamping to a retort stand.

The electrodes consist of 2 conducting plates, made of copper, nickel, zinc and stainless steel, dipped into the 1-7 Electrolyte on one end and connected to the 3-1 Electricity DC Power Supply on the other end. The electrode connected to the Positive (+) terminal of the 3-1 Electricity DC Power Supply is known as 3-2 Anode, while the electrode connected to the Negative (−) terminal of the 3-1 Electricity DC Power supply is known as 3-3 Cathode. The 1-7 Electrolyte is stirred and heated by usually by 68-5 Magnetic stir bar and 68-4 Hot plate with stirrer respectively.

The electrochemical reaction happens when the electrical current is passed through the 1-7 Electrolyte. The 1-8 Polymer product P if it is solid, would deposit onto the electrode surface as 3-5 Solid Deposit. In addition, a 1-IS By-product H is formed as liquid and diffuses into the 1-7 Electrolyte. Depending on the 1-7 Electrolyte used, 1-15 By-product H may be further broken down electrochemically into gases and ended up evolved from the electrodes, such as splitting of water into hydrogen and oxygen. While the gas evolution would be too minor for flammability and the gases are non-toxic, the apparatus would be setup and ran in a fumehood as extra safety precaution.

The 1-7 Electrolyte consists of at least 68-1 Material A as 1-6 Reactants and 68-3 Dissolved Salt to provide electrical conductivity to facilitate electrochemical reaction. Depending on the specific case, 68-2 Material 8 may be needed as another 1-6 Reactants, or 32-1 Additives such as 31-1 Cosolvent may be used. The specific 1-6 Reactants involved for each case is detailed in the following Table 24:

TABLE 24
Summary of Examples

| | | | | 68-3 | |
|---|---|---|---|---|---|
| | | | 1-15 By- | Dissolved | 31-1 |
| 68-1 Material A | 68-2 Material B | 1-8 Polymer P | product H | Salt | Cosolvent |
| Ethene 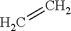 | — | Polyethylene 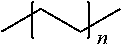 | — | Lithium Chloride LiCl | Acetone 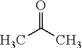 |
| Ethylamine 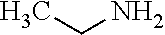 | — | Polyethylene 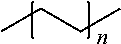 | 6-9 Ammonia NH₃ | Lithium Chloride LiCl | Water H₂O |
| Glycolic Acid 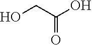 | — | Polyglycolic Acid 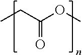 | Water H₂O | Sodium Chloride NaCl | Water H₂O |
| Ethylene glycol 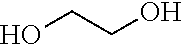 | Succinic acid 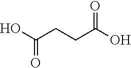 | Polyethylene succinate 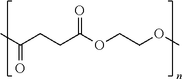 | Water H₂O | Sodium Chloride | Water H₂O |
| Terephthalic Acid 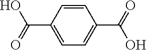 [SMILES: O=C(O)c1ccc(C(=O)O)cc1] | p-phenylene diamine 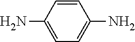 | Polyaryl amide 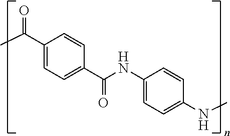 | Water H₂O | Sodium Chloride | Water H₂O |
| 6-1 Urea 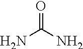 | 6-2 Bisphenol A 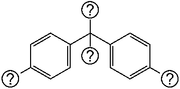 | 6-7 Polycarbonates 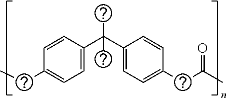 | 6-9 Ammonia NH₃ | Sodium Chloride | Water H₂O |
| Ethylene carbonate 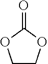 | — | Polyethylene carbonate 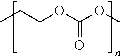 | — | Lithium Chloride LiCl | Acetone 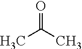 |
| Dimethylsilanediol 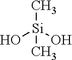 | — | Polysilane/Silicone 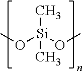 | Water H₂O | Sodium Chloride | Water H₂O |

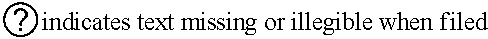

a. Startup:

The startup of the 35-1 Electrochemical Reactor involved pouring prepared 1-7 Electrolyte into the reaction 9-20 Vessel, gradually using filter funnel. The electrodes with 68-8 Stopper are then assembled to the reaction 9-20 Vessel, with the other end of electrode wire connected to 3-1 Electricity DC power supply. 3-1 Electricity DC power supply plug is then turned on, with set point current (constant current operation) and/or 6-5 Applied Voltage (constant 6-5 Applied Voltage operation) adjusted to desired value. Another “on” button (usually present for timing precision and 7-5 Process safety) on 3-1 Electricity DC power supply is then turned on and timer (including a stopwatch or even a phone timer) is started to record the time spent for reactor.

b. Shutdown:

To shutdown the reactor after experiment, 3-1 Electricity DC power supply is first switched off and the timer is stopped, in no particular order. The heating of 68-4 Hot plate with stirrer is then turned off. After which the stirrer of 68-4 Hot plate with stirrer is turned off. The 3-1 Electricity DC power supply plug is then turned off, and the reactor is left to cool gradually to room temperature. When the reactor cools to a safe temperature, the electrode with 68-8 Stopper is disassembled from the reactor. The 1-14 Spent electrolyte is then poured into a labelled closed container and stored. Finally, both the electrodes with 68-8 Stopper and reaction 9-20 Vessel are washed, dried and stored.

iii) Sampling and Measurement:

a. Sampling:

For sampling, 3-1 Electricity DC power supply operation is first paused by turning off the “on” button, at the same time the timer is paused. The exact time reacted at which the timer is paused is recorded. The 68-8 Stopper is then lifted open from the 9-20 Vessel and placed on a clean container temporarily.

For sampling of liquid, a small amount of 1-14 Spent electrolyte is drawn from the 9-20 Vessel using dropper. The dropper is then used to discharge the sampled 1-14 Spent electrolyte into a sample vial. The vial is sealed carefully and labelled accordingly. If necessary, the vial is refrigerated to preserve the composition.

For sampling of 3-5 Solid Deposit especially 1-8 Polymer, the 3-5 Solid Deposit is scrapped off from the electrode using a utility knife. The 3-5 Solid Deposit is then collected onto a filter paper placed on filter funnel with a container at bottom (to collect filtrate) and rinsed carefully with distilled/deionized water. The 3-5 Solid Deposit is left to dry, after which they are collected into sample vial.

After the said sampling, the 68-8 Stopper is retightened to the reaction 9-20 Vessel. The 3-1 Electricity DC power supply button is turned on again, and timer is resumed at the same time.

b. Measurement:

68-7 Bubble Flowmeter Setup:

Before gas flow rate can be measured, the 68-7 Bubble flowmeter needs to be set up to be ready. First, bubbling fluid (can be soap or detergent diluted with water) is added into the bulb of 68-7 Bubble flowmeter to the level that there is enough fluid in the bulb but not too much to flood the gas outlet from reactor. The bulb is then squeezed to flood the reactor gas outlet temporarily and released to original on-flooding level. The bubble layer is then observed to rise to 68-10 First mark (0 ml), the 68-11 Subsequent mark (usually 5 ml) and then another 68-11 Subsequent mark (usually 10 ml). When the bubble rises to the top for the first time and burst, the inner wall of 68-7 Bubble flowmeter would be wet with the fluid (soap water) and be ready for gas flow rate measurement.

Gas Flow Rate Measurement:

To perform gas flow rate measurement, after the 68-7 Bubble flowmeter is prepared as described, the bulb is squeezed to flood the reactor gas outlet temporarily, and then released to original non-flooding position. The bubble layer would rise slowly, and the timer is started once the bubble layer rises to the 68-10 First mark (0 ml). The timer is stopped with time recorded with the bubble rises to either of second (5 ml) or third (10 ml) 68-11 Subsequent mark. The gas flow rate can then be evaluated from the 68-7 Bubble flowmeter data following Equation 35:

$$F = \frac{{V}_{1}}{{t}_{1}} = \frac{{V}_{2}}{{t}_{2}} \qquad Equation 35$$

Where for this case V₁=5 ml and V₂=10 ml.

Either 68-11 Subsequent mark works as long as the volume is consistent, although the final 68-11 Subsequent mark would usually lead to more accurate measurement for lower relative uncertainty because human reaction time error in timing and parallax error in reading the mark would both be relatively lower over larger measurements.

### Example 1: Ethylene

The first example is the simplest variant of 7-3 Addition Polymer illustrated by Equation 36, the electrochemical polymerization of ethene to form polyethylene. For this case, the 68-1 Material A is ethene and 68-2 Material B is not needed while the 1-8 Polymer P is polyethylene and there is no 1-15 By-product. Note, however, that there is no 1-15 By-product from polymerization reaction route, but not other side reactions. The conducting 68-3 Dissolved Salt is chosen as Lithium Chloride, UCI, for its solubility in organic phase. The 31-1 Cosolvent is chosen as Acetone for its miscibility with ethene:

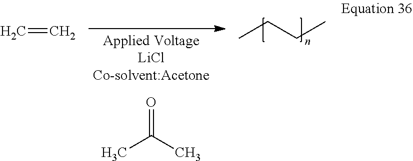

### Example 2: Ethylamine

The second example is a more complex variant 7-3 Addition Polymer illustrated in Equation 37, involving 1-15 By-product, the electrochemical polymerization of ethylamine to form polyethylene. For this case, the 68-1 Material A is ethylamine and 68-2 Material B is not needed while the 1-8 Polymer P is polyethylene, but this time the 1-15 By-product is 6-9 Ammonia. The conducting 68-3 Dissolved Salt is chosen as Lithium Chloride, LiCl, for its solubility in organic phase. The 31-1 Cosolvent is chosen as Acetone for its miscibility with ethylamine and ethene:

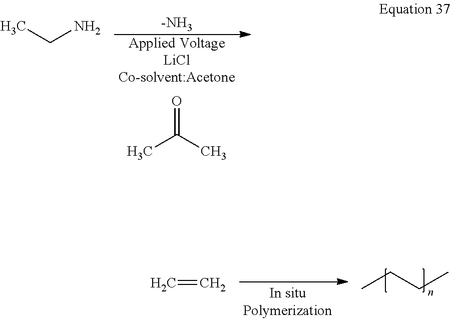

### Example 3: Glycolic Acid

The third example is the simplest variant of 7-4 Condensation Polymer illustrated in Equation 38, involving the same monomer species, the electrochemical polymerization of glycolic acid to form polyglycolic acid. For this case, the 68-1 Material A is glycolic acid and 68-2 Material B is not needed while the 1-8 Polymer P is polyglycolic acid and the 1-15 By-product formed Is water. The conducting 68-3 Dissolved Salt is chosen as Sodium Chloride, NaCl, for its solubility in polar phase from the abundance of hydrogen bonding from —OH groups of glycolic acid. The 31-1 Cosolvent is chosen as water for its miscibility with glycolic acid:

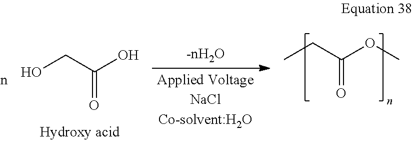

### Example 4: Ethylene Glycol and Succinic Acid

The fourth example is a slightly more complex variant of 7-4 Condensation Polymer illustrated in Equation 39, between 2 different monomer species, the electrochemical polymerization of ethylene glycol and succinic acid to form polyethylene succinate. For this case, the 68-1 Material A is ethylene glycol and 68-2 Material B is succinic acid while the 1-8 Polymer P is polyethylene succinate and the 1-15 By-product formed is water. The conducting 68-3 Dissolved Salt is chosen as Sodium Chloride, NaCl, for its solubility in polar phase from the abundance of hydrogen bonding from —OH groups of both ethylene glycol and succinic acid. The 31-1 Cosolvent is chosen as water for its miscibility with the polar phase of ethylene glycol and succinic acid:

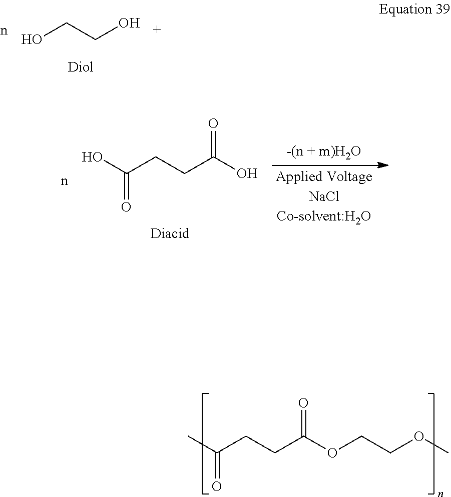

### Example 5: p-Phenylene Diamine and Terephthalic Acid

The fifth example is a more complex variant of 7-4 Condensation Polymer illustrated by Equation 40, between 2 different monomer species and involving functional groups other than —OH group, the electrochemical polymerization of p-phenylene diamine and terephthalic acid to form polyaryl amide. For this case, the 68-1 Material A is p-phenylene diamine and 68-2 Material 8 is terephthalic acid while the 1-8 Polymer P is polyaryl amide and the 1-15 By-product formed is water. The conducting 68-3 Dissolved Salt is chosen as Sodium Chloride, NaCl, for its solubility in polar phase from the abundance of hydrogen bonding from —OH groups of terephthalic acid and —NH groups of p-phenylene diamine. The 31-1 Cosolvent is chosen as water for its miscibility with the polar phase of p-phenylene diamine and terephthalic acid:

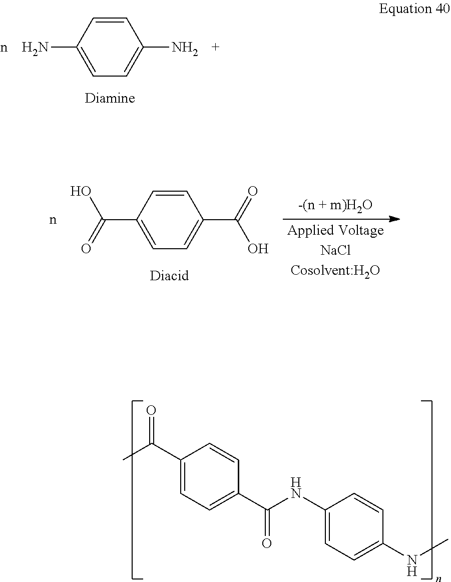

### Example 6: 6-2 Bisphenol A and 6-1 Urea

The sixth example is an even more complex variant of 7-4 Condensation Polymer described by Equation 41, between 2 different monomer species, functional groups other than —OH group and non-water 1-15 By-product, the electrochemical polymerization of 6-2 Bisphenol A and 6-1 Urea to form 6-7 Polycarbonates. For this case, the 68-1 Material A is 6-2 Bisphenol A and 68-2 Material B is 6-1 Urea while the 1-8 Polymer P is 6-7 Polycarbonates and the 1-15 By-product formed is 6-9 Ammonia. The conducting 68-3 Dissolved Salt is chosen as Sodium Chloride, NaCl, for its solubility in polar phase from the abundance of hydrogen bonding from —OH groups of 6-2 Bisphenol A and —NH groups of 6-1 Urea. The 31-1 Cosolvent is chosen as 6-9 Ammonia for its miscibility with the polar phase of 6-2 Bisphenol A and 6-1 Urea:

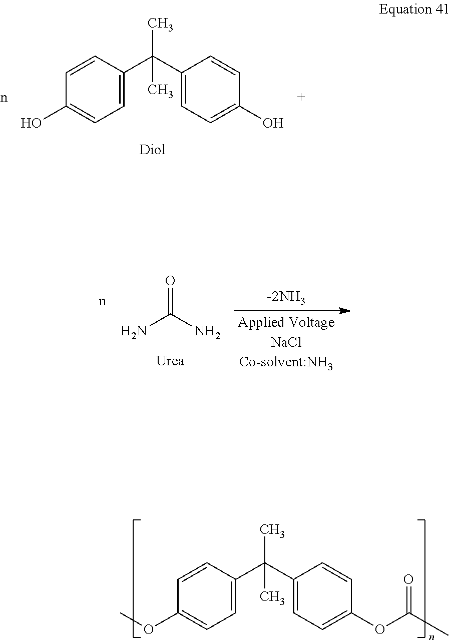

### Example 7: Ethylene Carbonate

The seventh example is an exotic, though simple variant of 7-4 Condensation Polymer described by Equation 42, involving ring-opening of the same monomer species, the electrochemical polymerization of ethylene carbonate to form polyethylene carbonate. For this case, the 68-1 Material A is ethylene carbonate and 68-2 Material B is not needed while the 1-8 Polymer P is polyethylene carbonate and there is no 1-15 By-product. Note, however, that there is no 1-15 By-product from polymerization reaction route, but not other side reactions. The conducting 68-3 Dissolved Salt is chosen as Lithium Chloride, LiCl, for its solubility in the predominantly organic phase of ethylene carbonate. The 31-1 Cosolvent is chosen as Acetone for its miscibility with ethylene carbonate:

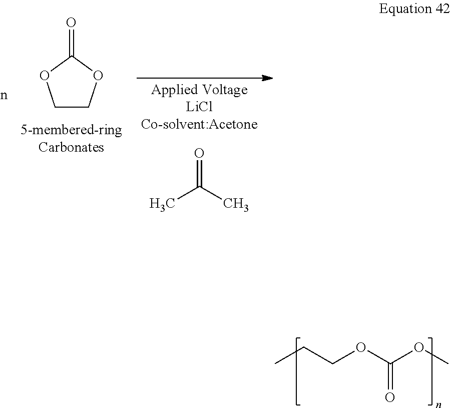

### Example 8: Dimethylsilanediol

The eighth example is an exotic but in different way, though simple, variant of 7-4 Condensation Polymer described by Equation 43, involving 33-14 Heteroatoms. Polysiloxanes Polysulfone, Polyphosphate, polynitrate, 33-15 Polysiloxanes 7-4 Condensation Polymer where the adjacent atom of the monomer backbone is not a carbon atom, the electrochemical polymerization of dimethylsilanediol to form 33-15 Polysiloxanes. For this case, the 68-1 Material A is dimethylsilanediol and 68-2 Material B is not needed while the 1-8 Polymer P Is 33-15 Polysiloxanes and the 1-15 By-product Is water. The conducting 68-3 Dissolved Salt is chosen as Sodium Chloride, NaCl, for its solubility in polar phase from the abundance of hydrogen bonding from —OH groups of dimethylsiloxanes. The 31-1 Cosolvent is chosen as water for its miscibility with dimethylsiloxanes.

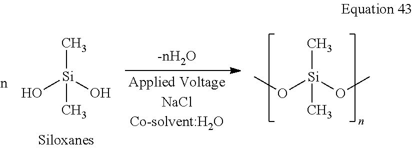

Summary of Observations

FIG. 70 summarizes the observations of the reactions performed using the example reactions. During the reaction, 1-8 Polymer is on the 70-1 Working Electrode usually as 3-5 Solid Deposit on the left that can be removed. However, if the 1-8 Polymer is either in liquid form or is soluble in 1-7 Electrolyte phase as 70-2 Liquid polymer, the 70-2 Liquid polymer would simply diffuse into the 1-7 Electrolyte. Depending on the type of 1-8 Polymer, strength of adhesion onto the electrode surface differs. For some, the 3-5 Solid Deposit drops upon slight shaking, while for some, a hard material such as a forcep or a knife is needed to scratch the 3-5 Solid Deposit off the surface.

Some 70-3 Gas bubbles also form on the surface of 3-2 Anode and 3-3 Cathode. For most cases, the 3-3 Cathode had smaller but more intense 70-3 Gas bubbles than the 3-2 Anode. This is because the 3-3 Cathode releases more mole of gas than 3-2 Anode, by the stoichiometric nature of the many gas evolution reactions. For instance, the water splitting in Equation 44 often happens when there Is water present in 1-7 Electrolyte, either as 1-15 By-product H or as co-solvent:

2H₂O→2H₂(3-3 Cathode)+O₂(3-2 Anode) Equation 44

1-15 By-product H are usually colorless and can only be seen as a stream of transparent liquid (visible due to the different refractive index from 1-7 Electrolyte), that diffuses into the 1-7 Electrolyte. As can be seen, under such reaction, the 3-3 Cathode would result in more gas evolution than the 3-2 Anode.

Results and Analysis

The products can be identified by chemical analysis methods such as GC-MS (Gas Chromatography-Mass Spectrometry), FTIR (Fourier Transform Infrared Spectroscopy) and UV-Vis (Ultraviolet-visible light Spectroscopy).

As shown in FIG. 71, the identification works by comparing the spectrums, which is a signal against scanning parameter, between 1-7 Electrolyte, 1-14 Spent electrolyte and Known Product. There is signal arising from reactions that corresponds to known species. Such comparison can be further quantified into concentration C, which can then be used to evaluate conversion can be evaluated by Equation 45:

$$X = \frac{CV - {C}_{0} {V}_{0}}{{C}_{0} {V}_{0}} \times 100 \% \qquad Equation 45$$

Where V is the final volume of 1-7 Electrolyte, V₀ is the initial volume of the 1-7 Electrolyte and C₀ is the concentration of Material A in the initially prepared 1-7 Electrolyte. In fact, due to the liquid phase nature of the system, the final volume of the 1-7 Electrolyte did not change significantly from initial volume.

The conversion X can then be compared against as shown in FIG. 72 against cumulative charge Q. The cumulative charge is simply the total electric charges passed through the 35-1 Electrochemical Reactor. Assuming a constant current operation of experimentation, the cumulative charge would simply be current multiplies time as per Equation 46:

Q=It Equation 46

It can be noted that the conversion is linear at low cumulative charge but subsequently plateau at high cumulative charge. This is because the conversion is also limited by the concentration of 1-6 Reactants in the 9-20 Vessel. At low cumulative charge, such effect of concentration is not significant, so the line appears to be linear. At high cumulative charge, significant 1-6 Reactants have been depleted by reaction such that the concentration decrease is significant enough to lower the reactivity of the 1-6 Reactants.

The mol reacted is simply be evaluated as per Equation 47:

N=CV−C₀V₀=C₀V₀X Equation 47

The number of electrons can be evaluated from cumulative charge as per Equation 48:

$${n}_{e} = \frac{Q}{F} = \frac{It}{F} \qquad Equation 48$$

Where F≈96485 C/mol is the Faraday's constant, representing number of charges per mol of electrons. The number of electrons per reaction can be obtained from the gradient of FIG. 73,

On the other hand, the graph of applied voltage follows a generally linear relation against current in FIG. 74. Below threshold voltage, no reaction would happen because the energy barrier to reaction has not been overcome. Above the threshold voltage, the 6-5 Applied Voltage against current follows a linear relation under the operating range as shown in FIG. 74. The gradient of the graph represents the resistance of the 35-1 Electrochemical Reactor. The higher the gradient, the higher the increase in 6-5 Applied Voltage for the required current, the higher the electrical energy dissipated to resistive heating of the 35-1 Electrochemical Reactor (especially the 1-7 Electrolyte) by heating. Thus a design consideration for this kind of 35-1 Electrochemical Reactors would involve lowering the electrical resistance of the 1-7 Electrolyte to reduce energy dissipation as heat.

Finally, the gas flow rate with respect to current follows a generally linear relationship as shown in FIG. 75. This is reasonable considering the gas evolution rate, by stoichiometry, is directly proportional to the current passing through the electrodes.

### CITATION LIST

[1] P. R. Gruber, E. S. Hall, J. J. Kolstad, M. L. Iwen, R. D. Benson and R. L. Borchardt, “Continuous process for manufacture of lactide polymers with purification by distillation”. U.S. Pat. No. 5,357,035, 16 Sep. 1993.
[2] R. M. Manyik, W. E. Walker and T. P. Wilson, “Continuous processes for the production of ethylene polymers and catalysts suitable therefor”. U.S. Pat. No. 3,300,458, 19 Aug. 1963.
[3] T. Maruyama and K. Ueno, “Process for the production of aromatic polyesters from hydroxybenzoic acid and products thereof”. U.S. Pat. No. 4,075,173, 28 Jan. 1977.
[4] H. Salamanca, “Robot system and method for cathode stripping in electrometallurgical and Industrial processes”. U.S. patent Ser. No. 11/598,145, 13 Nov. 2006.
[5] P. M. Jasberg, “Process for stripping metal from a cathode”. U.S. Pat. No. 3,501,385, 8 May 1967.
[6] H. Naarmann, “Electrochemical polymerization of pyrroles, an anode for carrying this out, and products obtained by this procedure”. U.S. Pat. No. 4,547,270, 23 Jul. 1984.
[7] Y. Wei, G.-W. Jang and C.-C. Chan, “Polymerization of thiophene and its derivatives”. U.S. Pat. No. 4,986,886, 30 May 1990.

1: A reactor for an electrochemical reaction, the reactor comprising:
a vessel for containing an electrolyte solution;
at least one electrode and at least one counter electrode, wherein the electrodes are disposed in the vessel such that
a first portion of the electrode and the counter electrode are immersed in the electrolyte solution,
a second portion of the electrode is not immersed in the electrolyte solution, and
the electrode moves in such a manner that its position remains, and the size of the surface area of the first portion that is immersed in the electrolyte solution and the second portion that is not immersed in the electrolyte solution remains while the surface area of the electrode is deposited with products formed from the electrochemical reaction; and
a removal device disposed in contact with the electrode for removing the deposited products from the electrode.

2: The reactor of claim 1, wherein the counter electrode further comprises a first portion that is immersed in the electrolyte solution, and a second portion that is not immersed in the electrolyte solution.

3: The reactor of claim 1, wherein the movement of the electrode stirs the electrolyte solution for maintaining a substantially homogeneous concentration.

4: The reactor of claim 1, further comprised of a conducting brush in contact with the electrode to supplement electrical contact during electrode movement.

5-6. (canceled)

7: The reactor of claim 1, wherein the electrode comprises a cylinder in rotation.

8: The reactor of claim 1, wherein the electrode comprises a conveyor belt.

9: The reactor of claim 8, wherein the conveyor belt electrode further comprises pulleys, chain drives, or a combination of two or more thereof.

10: The reactor of claim 9, wherein parts of the pulleys or chain drives immersed in the electrolyte solution is not conductive.

11: The reactor of claim 1, further comprises a primary transmission system to transfer the mechanical motion from a motor, an engine, or any mechanical power system.

12: The reactor of claim 11, wherein the primary transmission system comprises of at least one gear fixated onto a shaft, at least one pulley fixated onto a shaft, at least one chain drive fixated onto a shaft, or a combination of two or more thereof.

13: The reactor of claim 1, further comprises a secondary transmission system to transfer the mechanical motion onto the electrode.

14: The reactor of claim 11, wherein the secondary transmission system comprises of at least one gear fixated onto a shaft, at least one pulley fixated onto a shaft, at least one chain drive fixated onto a shaft, or a combination of two or more thereof.

15: The reactor of claim 1, wherein the removal device is in contact with the second portion of the electrode.

16: The reactor of claim 15, wherein the removal device comprises a rigid plate for scraping the deposited products off the second portion of the electrode.

17: The reactor of claim 16, wherein the degrees of tilt of the rigid plate is adjustable.

18. (canceled)

19: The reactor of claim 1, wherein the reactor further comprises a conveyor belt system positioned at the other end of the removal device that is not in contact with the electrode for removing the deposited products off the electrode by friction.

20: The reactor of claim 19, wherein the conveyor belt system comprises an abrasive surface.

21: The reactor of claim 19, wherein the conveyor belt system transports the removed deposited products away from the second portion of the electrode.

22: The reactor of claim 1, wherein the removal device is in contact with the first portion of the electrode.

23: The reactor of claim 1, wherein the reactor further comprises a drainage system positioned at the other end of the removal device that is not in contact with the electrode for collecting, transporting and washing the removed deposited products.

24: The reactor of claim 23, wherein the drainage system comprises a flap for preventing spilling of the deposited products during collection from the removal device.

25-26. (canceled)

27: The reactor of claim 1, wherein the electrode comprises a disk in rotation.

28: The reactor of claim 1, wherein the electrode comprises a worm screw in rotation.

29: The reactor of claim 28, wherein the rotation of the spiral worm screw electrode moves the electrolyte solution in a specific direction.

30: The reactor of claim 28, wherein the removal device comprises a second worm screw with relative surface motion against the electrode surface.

31-32. (canceled)

33: The reactor of claim 1, wherein the counter electrode comprises conducting materials fixed onto the walls of the vessel.

34: The reactor of claim 1 further comprises a gas removal system.

35-40. (canceled)

41: The reactor of claim 1, wherein the electrode and the counter electrode are separated by a separator, a diaphragm, or a conducting membrane.

42: The reactor of claim 1, wherein the electrode and the counter electrode are arranged in an alternating order.

43: The reactor of claim 1, wherein the electrode and the counter electrode are arranged in a corresponding cluster manner, segregated from each other.

44: The reactor of claim 1, further comprises a reference electrode for measuring standard electrode potential.

45: The reactor of claim 1, further comprises a mechanical support that holds and supports the electrode and the counter electrode.

46: The reactor of claim 45, wherein the mechanical support comprises a retraction mean to retract the electrode and the counter electrode from the vessel containing the electrolyte solution.

47: The reactor of claim 45, wherein the mechanical support is independent of and can be isolated from the vessel containing the electrolyte solution.

48-49. (canceled)

50: A process for an electrochemical reaction for producing polymers, the process comprises:
partially immersing a reaction electrode in an electrolyte solution;
immersing a counter electrode in the electrolyte solution;
establishing a voltage differential between the electrode and the counter electrode;
mixing at least one reactant in the electrolyte solution;
polymerizing the reactant, the resulting polymer depositing on the reaction electrode;
removing the deposited products from the reaction electrode; and
separating impurities from the deposited products to obtain the polymers.

51: The process of claim 50, further comprises collecting spent electrolyte solution and recovering electrolyte solution from the spent electrolyte solution.

52: The process of claim 51, wherein the recovered electrolyte solution is re-introduced and reused in the process.

53: The process of claim 50, wherein the reactant comprises ethylene glycol, propylene glycol, halohydrin, urea, glycerol, ethanol, unsaturated compounds, or a mixture of two or more thereof.

54: The process of claim 53, wherein the unsaturated compounds are unsaturated hydrocarbons.

55: The process of claim 50, wherein the reactant comprises alcohols.

56: The process of claim 50, wherein the reactant comprises amines.

57: The process of claim 50, wherein the reactant comprises sulfides.

58-62. (canceled)

63: The process of claim 55, wherein the alcohol contains 2 alcohol groups in the same reactant molecule.

64: The process of claim 50, wherein the polymer comprises polyether.

65: The process of claim 50, wherein the polymer comprises polyacetal, poly(propylene oxide), poly(ethylene oxide), poly(phenylene ether), or a mixture of two or more thereof.

66: The process of claim 55, wherein the alcohol contains a carbonyl (C═O) group.

67: The process of claim 50, wherein the polymer comprises polyketone.

68: The process of claim 55, wherein the adjacent carbon atom of the alcohol has no hydrogen atom.

69: The process of claim 55, wherein the carbon backbone of the alcohol comprises cyclic aromatic compounds.

70-71. (canceled)

72: The process of claim 50, wherein the reactant comprises sugar.

73: The process of claim 50, wherein the reactant comprises derivative of sugar.

74: The process of claim 50, wherein the polymer comprises cellulose, or any derivative of cellulose thereof.

75. (canceled)

76: The process of claim 50, wherein the reactant comprises carboxylic acid with an alcohol group.

77. (canceled)

78: The process of claim 50, wherein the polymer comprises polyhydroxyalkanoates.

79. (canceled)

80: The process of claim 50, wherein the reactant comprises carboxylic acid and alcohols.

81-84. (canceled)

85: The process of claim 50, wherein the reactant comprises amino acid.

86: The process of claim 50, wherein the reactant comprises carboxylic acid and amines.

87: The process of claim 50, wherein the polymer comprises poly(aryl amide), Nylon, protein, or a mixture of two or more thereof.

88: The process of claim 50, wherein the reactant comprises carboxylic acid and carbonyl group.

89: The process of claim 88, wherein the carbonyl group comprises urea.

90: The process of claim 88, wherein the carbonyl group comprises carbonic acid.

91: The process of claim 88, wherein the carbonyl group comprises hydrogen carbonates salts.

92: The process of claim 88, wherein the carbonyl group comprises carbonyl halides.

93: The process of claim 50, wherein the polymer comprises polycarbonates

94: The process of claim 50, wherein the reactant comprises carboxylic acid and acid anhydride.

95: The process of claim 50, wherein the reactant comprises alcohols and isocyanates.

96: The process of claim 50, wherein the polymer comprises polyurethane.

97. (canceled)

98: The process of claim 50, wherein the reactant comprises acid anhydrides and amines.

99: The process of claim 50, wherein the reactant comprises acid anhydrides and isocyanates.

100: The process of claim 50, wherein the polymer comprises polyimides.

101. (canceled)

102: The process of claim 50, wherein the reactant comprises cyclic compounds.

103: The process of claim 102, wherein the cyclic compound is cyclic ketone.

104: The process of claim 102, wherein the cyclic compound is a cyclic carbonate.

105-106. (canceled)

107: The process of claim 50, wherein the reactant comprises heteroatomic compounds.

108. The process of claim 50, wherein the polymer comprises polysiloxanes, polysulfones, polyphosphonates, polynitrates, or a mixture of two or more thereof.

109. (canceled)

110: The process of claim 50, wherein the reactant comprises alcohol, sulphide, amine, or a mixture of two or more thereof.

111: The process of claim 50, wherein a membrane is disposed in the electrolyte solution.

112: The process of claim 50, wherein conducting ions is are disposed in the electrolyte solution.

113-118. (canceled)

119: The process of claim 50, wherein a cosolvent is disposed in the electrolyte solution.

120-123. (canceled)

124: The process of claim 50, wherein additives is are disposed in the electrolyte solution.

125-126. (canceled)

127: The process of claim 50, wherein the polymerization comprises condensation polymerization, addition polymerization, or transesterification polymerization.

128: The process of claim 50, wherein the polymerization comprises internal elimination followed by addition polymerization.

129. (canceled)

130: A system for conducting an electrochemical reaction to produce polymers, the system comprises:
at least one electrochemical reactor;
at least one reactant tank for storing reactant;
at least one mixing tank for receiving and mixing reactants with electrolyte solution; and
at least one solid separator for receiving the polymers that are to be further processed to remove impurities from the polymers;
wherein the reactant is polymerized in the reactor, producing the polymers.

131: A system of claim 130, wherein the at least one electrochemical reactor comprises the reactor of claim 1.

132-156. (canceled)

157: The system of claim 130, further comprises a cascade control.

158-161. (canceled)

162: The system of claim 130, further comprises a feedforward control.

163-164. (canceled)

165: The system of claim 130, further comprises a feedback control.

166-167. (canceled)

168: The system of claim 130, further comprises a ratio control.

169-171. (canceled)

172: The system of claim 130, further comprises a split range control.

173-174. (canceled)

175: The system of claim 130, further comprises an override select control.

176-178. (canceled)

179: The system of claim 130, further comprises an indicator/alarm.

180-182. (canceled)

183: A process control method, comprises, Feedforward control, Feedback control, Cascade control, ratio control, split range control, override select control, indicator/alarm control, or a combination of two or more thereof.

184: A process control method of claim 183, wherein the cascade control comprises at least one layer of communication between upstream and downstream equipment.

185: A process control method of claim 183, wherein the cascade control comprises at least one layer of communication between parallel stream equipment.

186: An electrochemical reaction system, comprising
a mixing unit for mixing reactants;
the reactor of claim 1; and
a separating unit for further separating the solid deposit.

187: The electrochemical reaction system of claim 186, further comprises an electrolyte recovery unit for controlling electrolyte composition.

188: The electrochemical reaction system of claim 187, wherein the reactor, if more than one, are stacked in arrays.

189: The electrochemical reaction system of claim 188, wherein the arrays formation of reactors comprises rectangular matrices with arbitrary dimensions of n rows×m columns.

190: The electrochemical reaction system of claim 189, wherein the rectangular matrices comprise clusters with dimensions of 2×1, 2×2, 2×n, n×n, or a combination of two or more thereof.

191: A method to deploy an electrochemical reactor, comprises in any sequence:
deploying a reactor vessel to contain an electrolyte solution;
deploying an electrode support that supports at least one electrode or at least one counter electrode to immerse into the electrolyte solution;
adjusting a position of the at least one electrode or one counter electrode to allow spacing for the electrolyte solution;
deploying a solid transport system to move solid products out of the reactor; and
installing a gas removal device to move gaseous products out of the reactor.

192: A method to retrofit the system of claim 130 to an existing polymer production system, comprises in any sequence:
disconnecting the piping of existing polymer production system;
installing three-way valves or switch valves at the disconnected piping; and
connecting the three-way valves or switch valves to the at least one electrochemical reactor as a bypass.

193: A method to retrofit the system of claim 130 to an existing recovery unit, comprises in any sequence:
disconnecting the piping of an existing recovery unit;
installing three-way valves or switch valves at the disconnected piping;
connecting the three-way valves or switch valves to an alternative recovery unit.

194: A method to retrofit the system of claim 130 to an existing distillation column, comprises in any sequence:
disconnecting the piping of both top and bottom of the distillation column;
installing three-way valves or switch valves at the disconnected piping; and
connecting the three-way valves or switch valves to reverse top and bottom output of the distillation column.

195: A method of maintenance for an electrochemical reactor, comprises in any sequence:
removing a gas removal device that moves gaseous products out of the electrochemical reactor;
removing a solid transport system that moves solid products out of the electrochemical reactor;
adjusting a position of at least one electrode or one counter electrode to allow spacing for an electrolyte solution;
retracting an electrode support that supports the at least one electrode or the at least one counter electrode to move the at least one electrode or the at least one counter electrode out of the electrolyte solution;
performing cleanup, repair or maintenance onto the electrochemical reactor or a part of the electrochemical reactor thereof;
redeploying the retracted electrode support that supports at least one electrode or at least one counter electrode to immerse back into the electrolyte solution;
readjusting a position of the at least one electrode or the one counter electrode to allow spacing for the electrolyte solution;
redeploying the removed solid transport system that moves solid products out of the electrochemical reactor;
reinstalling the removed gas removal device that moves gaseous products out of the reactor.

196: A method of waste management using the system of claim 130, comprises in any sequence:
deploying a waste container to store chemical waste;
installing an extraction unit to isolate active reactant from the chemical waste; and
connecting the extraction unit to the at least one reactant tank.
